(19) United States
(12) Patent Application Publication
(10) Pub. No.: US 2017/0214708 A1
(43) Pub. Date: Jul. 27, 2017

(54) DETECTING SECURITY THREATS BY COMBINING DECEPTION MECHANISMS AND DATA SCIENCE

(71) Applicant: Acalvio Technologies, Inc., Cupertino, CA (US)

(72) Inventors: Sreenivas Gukal, Santa Clara, CA (US); Rammohan Varadarajan, Cupertino, CA (US)

(73) Assignee: Acalvio Technologies, Inc., Cupertino, CA (US)

(21) Appl. No.: 15/405,639

(22) Filed: Jan. 13, 2017

Related U.S. Application Data
(60) Provisional application No. 62/286,564, filed on Jan. 25, 2016.
(60) Provisional application No. 62/344,267, filed on Jun. 1, 2016.

(51) Int. Cl. H04L 29/06; G06F 17/30

(52) U.S. Cl. CPC H04L 63/1433; H04L 63/1491; G06F 17/30598

(57) ABSTRACT

Provided are systems, methods, and computer-program products for a network device, configured to use data science techniques to manage the deployment of deception mechanisms in a network, where the deception mechanisms can attract and detect threats to the network. In various implementations, the network device can receive network data. The network data can include data produced by an interaction with a deception mechanism. The deception mechanism can be part of the security of the network. An interaction can include a potential threat to the network. The network device can further be configured to analyze the network data using a data science engine, including identifying a pattern of network behavior. The network device can further generate an attack pattern that includes the behavior of the potential threat. The network device can further use the attack pattern to modify deception mechanisms on the network.

### CROSS REFERENCES TO RELATED APPLICATIONS

This application claims the benefit under 35 U.S.C. §119 of U.S. Provisional Application No. 62/286,564, filed on Jan. 25, 2016; and U.S. Provisional Application No. 62/344,267, filed on Jun. 1, 2016; each of which are incorporated herein by reference in their entirety.

### BRIEF SUMMARY

Provided are methods, including computer-implemented methods or methods implemented by a network device, devices including network devices, and computer-program products that use data science techniques to analyze network data. Form this analysis, a network security infrastructure can deploy appropriate deception mechanisms into network, in order to defend the network from threats.

In various implementations, a network security device on a network can be configured to receive network data from the network. Security for the network can include a deception mechanism. Network data can include data produced by an interaction with the deception mechanism. This interaction can include a potential threat to the network. The network security device can further be configured to analyze the network data using a data science engine of the network device. Analyzing the network data can include identifying a pattern of network behavior that describes the potential threat. The network security device can further generating an attack pattern. The attack pattern can include the identified pattern of network behavior. The network security device can further be configured to modify security for the network. Modifying the security can include using the attack pattern to modify the use of one or more deception mechanisms on the network.

In various implementations, the data science engine of the network security device can be configured to categorize the network data using clustering, wherein clustering includes identifying one or more network devices in the network that have similar features. In various implementations, a feature includes a type of a network device, identification information for the network device, a hardware configuration of the network device, or a software configuration of the network device.

In various implementations, the data science engine can be configured to use statistical analysis to generate an attack signature. Statistical analysis can include determining a probability that activity indicated by the network data is related to a known attack pattern.

In various implementations, the data science engine can configured to use a scoring model to determine a priority for the potential threat. A scoring model can assign a score value to the network data. The score value can indicate a probability of the potential threat affecting a particular part of the network.

In various implementations, the data science engine can configured to use the network data and predictive analysis to determine probable future network behavior. The predictive analysis can use one or more known attack patterns to determine the probable future network behavior. The probable future network behavior can associated with the potential threat.

In various implementations, the data science engine can be configured to relate the attack pattern to a known attack pattern. The data science engine can further be configured to assign a correlation coefficient to the attack pattern. The correlation coefficient can measure an association between the attack pattern and the known attack pattern.

In various implementations, the network security device can further be configured to identify the potential threat. In various implementations, the network security device can further be configured to determine a location of the potential threat in the network.

In various implementations, modifying the security for the network can include determining an additional deception mechanism using the attack pattern. The additional deception mechanism can be configured to be included in the pattern of network behavior.

In various implementations, modifying the security for the network can includes modifying the deception mechanism using the attack pattern. Modifying the deception mechanism can include configuring the deception mechanism to conform to the pattern of network behavior.

### BRIEF DESCRIPTION OF THE DRAWINGS

Illustrative embodiments are described in detail below with reference to the following figures:

FIG. 1 illustrates an example of a network threat detection and analysis system, in which various implementations of a deception-based security system can be used;

FIGS. 2A-2D provide examples of different installation configurations that can be used for different customer networks;

FIG. 3A-3B illustrate examples of customer networks where some of the customer networks' network infrastructure is “in the cloud,” that is, is provided by a cloud services provider;

FIG. 4 illustrates an example of an enterprise network;

FIG. 5 illustrates a general example of an Internet-of-Things network;

FIG. 6 illustrates an example of an Internet-of-Things network, here implemented in a private home;

FIG. 7 illustrates of an Internet-of-Things network, here implemented in a small business;

FIG. 8 illustrates an example of the basic operation of an industrial control system;

FIG. 9 illustrates an example of a SCADA system, here used for distributed monitoring and control;

FIG. 10 illustrates an example of a distributed control;

FIG. 11 illustrates an example of a PLC implemented in a manufacturing control process

FIG. 12 illustrates an example of a network threat detection system;

FIG. 13 illustrates an example of a process that may be implemented by an attack pattern detector to identify a pattern of behavior as a possible threat;

FIG. 14A-14B illustrate an example of two stages of a process for confirming that the pattern of behavior is an actual threat;

FIGS. 15A-15B illustrate examples of network threat detection systems that use static and/or dynamic security mechanisms to locate, identify, and confirm a threat to a network;

FIG. 16 illustrates an example of a process for confirming a network abnormality as an actual threat;

FIG. 17 illustrates examples of security mechanisms that may be deployed into a network to entrap a potential threat;

FIG. 18 illustrates examples of various data sources that may provide data that is collected by a dynamic threat detection system;

FIG. 19 illustrates an example of an attack pattern generator that uses data science techniques to analyze network data and determine suspected attack patterns from the network data; and

FIG. 20 illustrates an example of a deployment generator that uses data science techniques to determine a selection of security mechanisms to deploy, and placement of the security mechanisms in a network.

### DETAILED DESCRIPTION

Network deception mechanisms, often referred to as “honeypots,” “honey tokens,” and “honey nets,” among others, defend a network from threats by distracting or diverting the threat. Honeypot-type deception mechanisms can be installed in a network for a particular site, such as a business office, to act as decoys in the site's network. Honeypot-type deception mechanisms are typically configured to be indistinguishable from active, production systems in the network. Additionally, such deception mechanisms are typically configured to be attractive to a network threat by having seemingly valuable data and/or by appearing vulnerable to infiltration. Though these deception mechanisms can be indistinguishable from legitimate parts of the site network, deception mechanisms are not part of the normal operation of the network, and would not be accessed during normal, legitimate use of the site network. Because normal users of the site network would not normally use or access a deception mechanism, any use or access to the deception mechanism is suspected to be a threat to the network.

“Normal” operation of a network generally includes network activity that conforms with the intended purpose of a network. For example, normal or legitimate network activity can include the operation of a business, medical facility, government office, education institution, or the ordinary network activity of a private home. Normal network activity can also include the non-business-related, casual activity of users of a network, such as accessing personal email and visiting websites on personal time, or using network resources for personal use. Normal activity can also include the operations of network security devices, such as firewalls, anti-virus tools, intrusion detection systems, intrusion protection systems, email filters, adware blockers, and so on. Normal operations, however, exclude deceptions mechanisms, in that deception mechanisms are not intended to take part in business operations or casual use. As such, network users and network systems do not normally access deceptions mechanisms except perhaps for the most routine network administrative tasks. Access to a deception mechanism, other than entirely routine network administration, may thus indicate a threat to the network.

Threats to a network can include active attacks, where an attacker interacts or engages with systems in the network to steal information or do harm to the network. An attacker may be a person, or may be an automated system. Examples of active attacks include denial of service (DoS) attacks, distributed denial of service (DDoS) attacks, spoofing attacks, “man-in-the-middle” attacks, attacks involving malformed network requests (e.g. Address Resolution Protocol (ARP) poisoning, “ping of death,” etc.), buffer, heap, or stack overflow attacks, and format string attacks, among others. Threats to a network can also include self-driven, self-replicating, and/or self-triggering malicious software. Malicious software can appear innocuous until activated, upon which the malicious software may attempt to steal information from a network and/or do harm to the network. Malicious software is typically designed to spread itself to other systems in a network. Examples of malicious software include ransomware, viruses, worms, Trojan horses, spyware, keyloggers, rootkits, and rogue security software, among others.

In current implementations, deception-based security mechanisms are generally statically configured or are configured to behave within pre-determined parameters. This means that the appearance and behavior, from the point of view of an entity on the network, may be predictable. Additionally, the location of the deception mechanisms may be fixed or within pre-determined parameters. The deception mechanisms may be changed manually by a human system administrator, or automatically by fixed rules.

Predictable behavior and static locations, however, can make deception-based security mechanism easy to identify. Using various network analysis tools, an intruder on a network can profile a network system that appears to be a deception system, and from the profile determine that the network system is not a normally used, production system. Additionally, the network intruder can establish the location of the deception mechanism from, for example, an Internet Protocol (IP) or Media Access Control (MAC) address. Having identified a deception mechanism, the intruder can simply avoid the system. In some cases, the intruder may even make the location of the deception mechanism public, so that other threats to the network can avoid the deception mechanism.

A more effective network threat detection system may, rather than using static deception mechanisms, use deception mechanisms in a targeted and dynamic fashion, or use a combination of static and dynamic deception mechanisms. Deception mechanisms may initially be deployed based on network data or in response to alerts raised in response to activity in the network. The deception mechanism may be configured to look attractive to an attack, for example by having seemingly valuable data and/or having security flaws that may make it easy to infiltrate the deception mechanism. The deception mechanisms may further be strategically deployed into parts of the network that have legitimately valuable hardware or data resources.

The network threat detection system subsequently receive network data that reflects activity within the network. Some of that network activity will be normal legitimate network activity, some will be activity that appears legitimate but that may not be, and some of the network activity may involve interactions with deception mechanisms. From this information, the network threat detection system may identify a potential threat to the network. In various implementations, the network threat detection system may then deploy additional deception mechanisms, or modify existing deception mechanisms, to attempt attract and/or identify the potential threat. In various implementations, the network threat detection system may further analyze the potential threat by allowing network activity related to the potential threat to continue to affect the deception mechanisms, while isolating the network activity from the rest of the network.

Through deploying additional deception mechanisms and/or modifying existing deception mechanisms, the network threat detection system may be able to confirm a potential threat as an actual threat. The network threat detection system may further be able to identify and/or profile the threat. This information can be used to improve the overall security of the network, and further can be shared with the greater network security community to improve network security around the world.

In various implementations, a network threat detection system can use data science techniques to analyze network data, and from the analysis adjust the deployment of deception mechanisms in a network. For example, the network threat detection system can use clustering to identify network devices that have similar features. A threat that has affected a deception mechanism having a particular set of features may affect network devices that have similar features, and clustering can identify potentially affected network devices. The network threat detection system can then generate deception mechanism with similar features to attempt to attract the attention of the potential threat. Alternatively or additionally, the network threat detection system can check production network devices with similar features to see if the production network devices have been affected by the threat.

As another example, the network threat detection system can use statistical analysis to generate an attack signature. Statistical analysis can be used to determine a probability that activity found in network data is related to a known attack pattern. By comparing a digital signature for particular network data to digital signatures for known attack patterns, the network threat detection system can determine a probability that the particular network data shows evidence of a known attack. A likely (or unlikely) match with a known attack pattern can be used to generate an attack signature for a pattern of network behavior, which can be used to identify similar network behavior in the future.

As another example, the network threat detection system can use a scoring model to determine a priority for a potential threat. A scoring model can be used to assign values to certain physical parts of the network and/or data on the network. The network threat detection system can use the scoring model to determine a probability that the threat is affecting a particular part of the network. The network threat detection system can further configure deception mechanisms that resemble the particular part of the network, to attempt to attract the threat. Alternatively or additionally, the particular part of the network can be inspected to see if the threat has affected that part of the network.

As another example, the network threat detection system can use predictive analysis to determine probable future network behavior. Predictive analysis can use known attack patterns to determine future network behavior that may occur should current network activity progress. This information can be used by the network threat detection system to place deception mechanisms in the probable path of an attack or threat, and thereby divert and/or identify the attack.

As another example, the network threat detection system can relate an attack pattern, identified from a pattern of network behavior, to known attack patterns. The network threat detection system can then assign a correlation coefficient that can reflect the correlation between the attack pattern and the known attack pattern. The network threat detection system can further use the correlation coefficient to identify parts of the network that are likely to be affected by the potential threat. The network threat detection system can further deploy deception mechanisms that resemble these parts of the network, in order to attract or divert the threat from the actual network. Alternatively or additionally, the parts of the network that are likely to be affected by the potential threat can be inspected to see if the network has, in fact, been affected.

Using these and other data science techniques, a network threat detection system dynamically deploy and redeploy deception mechanism to identify and thwart threats to a network. The deception mechanisms can further be used to analyze a threat. The resulting analysis data can be used to generate indicators, which can be used to improve the security of the network.

### I. DECEPTION-BASED SECURITY SYSTEMS

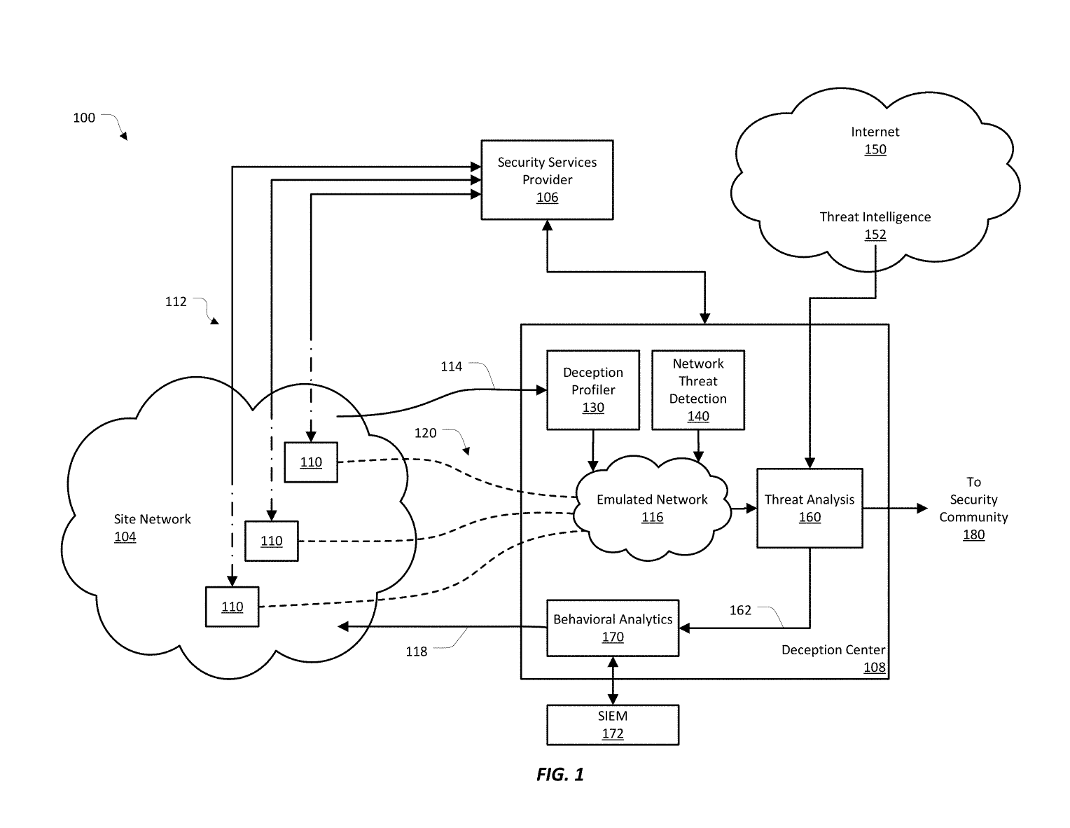

FIG. 1 illustrates an example of a network threat detection and analysis system 100, in which various implementations of a deception-based security system can be used. The network threat detection and analysis system 100, or, more briefly, network security system 100, provides security for a site network 104 using deceptive security mechanisms, a variety of which may be called “honeypots.” The deceptive security mechanisms may be controlled by and inserted into the site network 104 using a deception center 108 and sensors 110, which may also be referred to as deception sensors, installed in the site network 104. In some implementations, the deception center 108 and the sensors 110 interact with a security services provider 106 located outside of the site network 104. The deception center 108 may also obtain or exchange data with sources located on the Internet 150.

Security mechanisms designed to deceive, sometimes referred to as “honeypots,” may also be used as traps to divert and/or deflect unauthorized use of a network away from the real network assets. A deception-based security mechanism may be a computer attached to the network, a process running on one or more network systems, and/or some other device connected to the network. A security mechanism may be configured to offer services, real or emulated, to serve as bait for an attack on the network. Deception-based security mechanisms that take the form of data, which may be called “honey tokens,” may be mixed in with real data in devices in the network. Alternatively or additionally, emulated data may also be provided by emulated systems or services.

Deceptive security mechanisms can also be used to detect an attack on the network. Deceptive security mechanisms are generally configured to appear as if they are legitimate parts of a network. These security mechanisms, however, are not, in fact, part of the normal operation of the network. Consequently, normal activity on the network is not likely to access the security mechanisms. Thus any access over the network to the security mechanism is automatically suspect.

The network security system 100 may deploy deceptive security mechanisms in a targeted and dynamic fashion. Using the deception center 108 the network security system 100 can scan the site network 104 and determine the topology of the site network 104. The deception center 108 may then determine devices to emulate with security mechanisms, including the type and behavior of the device. The security mechanisms may be selected and configured specifically to attract the attention of network attackers. The security mechanisms may also be selected and deployed based on suspicious activity in the network. Security mechanisms may be deployed, removed, modified, or replaced in response to activity in the network, to divert and isolate network activity related to an apparent attack, and to confirm that the network activity is, in fact, part of a real attack.

The site network 104 is a network that may be installed among the buildings of a large business, in the office of a small business, at a school campus, at a hospital, at a government facility, or in a private home. The site network 104 may be described as a local area network (LAN) or a group of LANS. The site network 104 may be one site belonging to an organization that has multiple site networks 104 in one or many geographical locations. In some implementations, the deception center 108 may provide network security to one site network 104, or to multiple site networks 104 belonging to the same entity.

The site network 104 is where the networking devices and users of the an organizations network may be found. The site network 104 may include network infrastructure devices, such as routers, switches hubs, repeaters, wireless base stations, and/or network controllers, among others. The site network 104 may also include computing systems, such as servers, desktop computers, laptop computers, tablet computers, personal digital assistants, and smart phones, among others. The site network 104 may also include other analog and digital electronics that have network interfaces, such as televisions, entertainment systems, thermostats, refrigerators, and so on.

The deception center 108 provides network security for the site network 104 (or multiple site networks for the same organization) by deploying security mechanisms into the site network 104, monitoring the site network 104 through the security mechanisms, detecting and redirecting apparent threats, and analyzing network activity resulting from the apparent threat. To provide security for the site network 104, in various implementations the deception center 108 may communicate with sensors 110 installed in the site network 104, using network tunnels 120. As described further below, the tunnels 120 may allow the deception center 108 to be located in a different sub-network (“subnet”) than the site network 104, on a different network, or remote from the site network 104, with intermediate networks (possibly including the Internet 150) between the deception center 108 and the site network 104.

In some implementations, the network security system 100 includes a security services provider 106. In these implementations, the security services provider 106 may act as a central hub for providing security to multiple site networks, possibly including site networks controlled by different organizations. For example, the security services provider 106 may communicate with multiple deception centers 108 that each provide security for a different site network 104 for the same organization. In some implementations, the security services provider 106 is located outside the site network 104. In some implementations, the security services provider 106 is controlled by a different entity than the entity that controls the site network. For example, the security services provider 106 may be an outside vendor. In some implementations, the security services provider 106 is controlled by the same entity as that controls the site network 104.

In some implementations, when the network security system 100 includes a security services provider 106, the sensors 110 and the deception center 108 may communicate with the security services provider 106 in order to be connected to each other. For example, the sensors 110, which may also be referred to as deception sensors, may, upon powering on in the site network 104, send information over a network connection 112 to the security services provider 106, identifying themselves and the site network 104 in which they are located. The security services provider 106 may further identify a corresponding deception center 108 for the site network 104. The security services provider 106 may then provide the network location of the deception center 108 to the sensors 110, and may provide the deception center 108 with the network location of the sensors 110. A network location may take the form of, for example, an Internet Protocol (IP) address. With this information, the deception center 108 and the sensors 110 may be able to configure tunnels 120 to communicate with each other.

In some implementations, the network security system 100 does not include a security services provider 106. In these implementations, the sensors 110 and the deception center 108 may be configured to locate each other by, for example, sending packets that each can recognize as coming for the other. Using these packets, the sensors 110 and deception center 108 may be able to learn their respective locations on the network. Alternatively or additionally, a network administrator can configure the sensors 110 with the network location of the deception center 108, and vice versa.

In various implementations, the sensors 110 are a minimal combination of hardware and/or software, sufficient to form a network connection with the site network 104 and a tunnel 120 with the deception center 108. For example, a sensor 110 may be constructed using a low-power processor, a network interface, and a simple operating system. In various implementations, the sensors 110 provide the deception center 108 with visibility into the site network 104, such as for example being able to operate as a node in the site network 104, and/or being able to present or project deceptive security mechanisms into the site network 104, as described further below. Additionally, in various implementations, the sensors 110 may provide a portal through which a suspected attack on the site network 104 can be redirected to the deception center 108, as is also described below.

In various implementations, the deception center 108 may be configured to profile the site network 104, deploy deceptive security mechanisms for the site network 104, detect suspected threats to the site network 104, analyze the suspected threat, and analyze the site network 104 for exposure and/or vulnerability to the supposed threat.

To provide the site network 104, the deception center 108 may include a deception profiler 130. In various implementations, the deception profiler may 130 derive information 114 from the site network 104, and determine, for example, the topology of the site network 104, the network devices included in the site network 104, the software and/or hardware configuration of each network device, and/or how the network is used at any given time. Using this information, the deception profiler 130 may determine one or more deceptive security mechanisms to deploy into the site network 104.

In various implementations, the deception profiler may configure an emulated network 116 to emulate one or more computing systems. Using the tunnels 120 and sensors 110, the emulated computing systems may be projected into the site network 104, where they serve as deceptions. The emulated computing systems may include address deceptions, low-interaction deceptions, and/or high-interaction deceptions. In some implementations, the emulated computing systems may be configured to resemble a portion of the network. In these implementations, this network portion may then be projected into the site network 104.

In various implementations, a network threat detection engine 140 may monitor activity in the emulated network 116, and look for attacks on the site network 104. For example, the network threat detection engine 140 may look for unexpected access to the emulated computing systems in the emulated network 116. The network threat detection engine 140 may also use information 114 extracted from the site network 104 to adjust the emulated network 116, in order to make the deceptions more attractive to an attack, and/or in response to network activity that appears to be an attack. Should the network threat detection engine 140 determine that an attack may be taking place, the network threat detection engine 140 may cause network activity related to the attack to be redirected to and contained within the emulated network 116.

In various implementations, the emulated network 116 is a self-contained, isolated, and closely monitored network, in which suspect network activity may be allowed to freely interact with emulated computing systems. In various implementations, questionable emails, files, and/or links may be released into the emulated network 116 to confirm that they are malicious, and/or to see what effect they have. Outside actors can also be allowed to access emulated system, steal data and user credentials, download malware, and conduct any other malicious activity. In this way, the emulated network 116 not only isolated a suspected attack from the site network 104, but can also be used to capture information about an attack. Any activity caused by suspect network activity may be captured in, for example, a history of sent and received network packets, log files, and memory snapshots.

In various implementations, activity captured in the emulated network 116 may be analyzed using a targeted threat analysis engine 160. The threat analysis engine 160 may examine data collected in the emulated network 116 and reconstruct the course of an attack. For example, the threat analysis engine 160 may correlate various events seen during the course of an apparent attack, including both malicious and innocuous events, and determine how an attacker infiltrated and caused harm in the emulated network 116. In some cases, the threat analysis engine 160 may use threat intelligence 152 from the Internet 150 to identify and/or analyze an attack contained in the emulated network 116. The threat analysis engine 160 may also confirm that suspect network activity was not an attack. The threat analysis engine 160 may produce indicators that describe the suspect network activity, including indicating whether the suspect activity was or was not an actual threat. The threat analysis engine 160 may share these indicators with the security community 180, so that other networks can be defended from the attack. The threat analysis engine 160 may also send the indicators to the security services provider 106, so that the security services provider 106 can use the indicators to defend other site networks.

In various implementations, the threat analysis engine 160 may also send threat indicators, or similar data, to a behavioral analytics engine 170. The behavioral analytics engine 170 may be configured to use the indicators to probe 118 the site network 104, and see whether the site network 104 has been exposed to the attack, or is vulnerable to the attack. For example, the behavioral analytics engine 170 may search the site network 104 for computing systems that resemble emulated computing systems in the emulated network 116 that were affected by the attack. In some implementations, the behavioral analytics engine 170 can also repair systems affected by the attack, or identify these systems to a network administrator. In some implementations, the behavioral analytics engine 170 can also reconfigure the site network's 104 security infrastructure to defend against the attack.

The behavioral analytics engine 170 can work in conjunction with a Security Information and Event Management (SIEM) 172 system. In various implementations, SIEM includes software and/or services that can provide real-time analysis of security alerts generates by network hardware and applications. In various implementations, the deception center 108 can communicate with the SIEM 172 system to obtain information about computing and/or networking systems in the site network 104.

Using deceptive security mechanisms, the network security system 100 may thus be able to distract and divert attacks on the site network 104. The network security system 100 may also be able to allow, using the emulated network 116, and attack to proceed, so that as much can be learned about the attack as possible. Information about the attack can then be used to find vulnerabilities in the site network 104. Information about the attack can also be provided to the security community 180, so that the attack can be thwarted elsewhere.

### II. CUSTOMER INSTALLATIONS

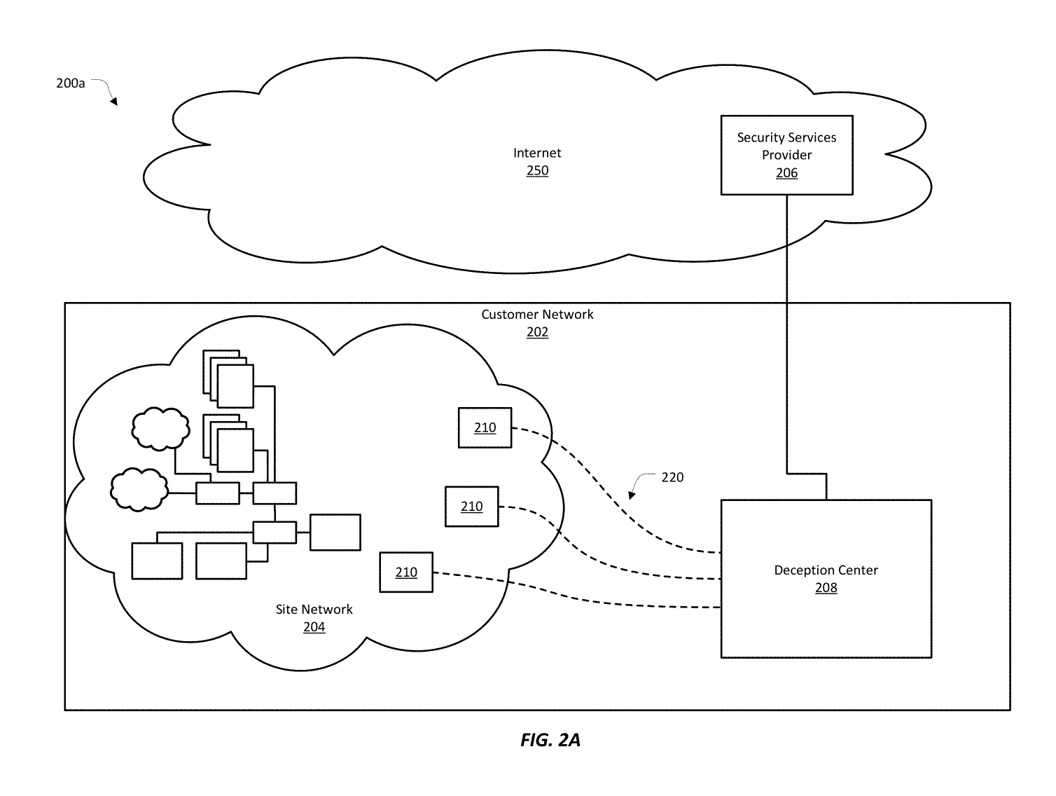

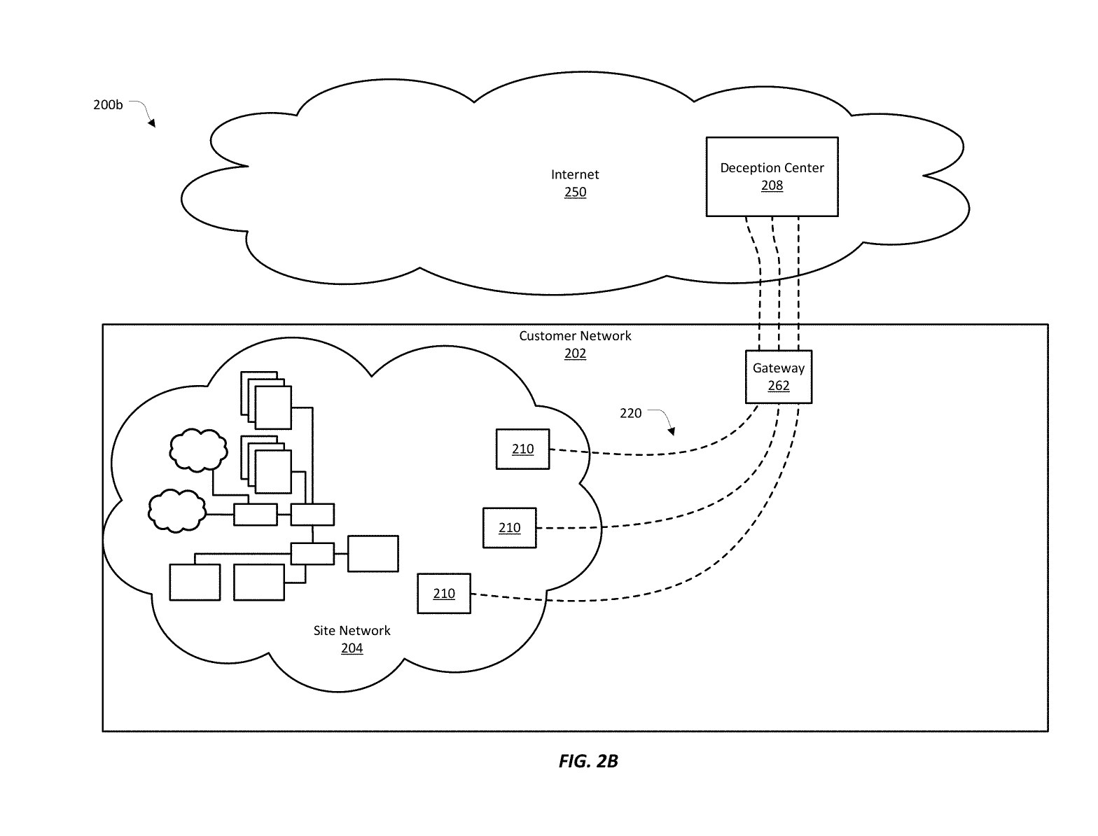

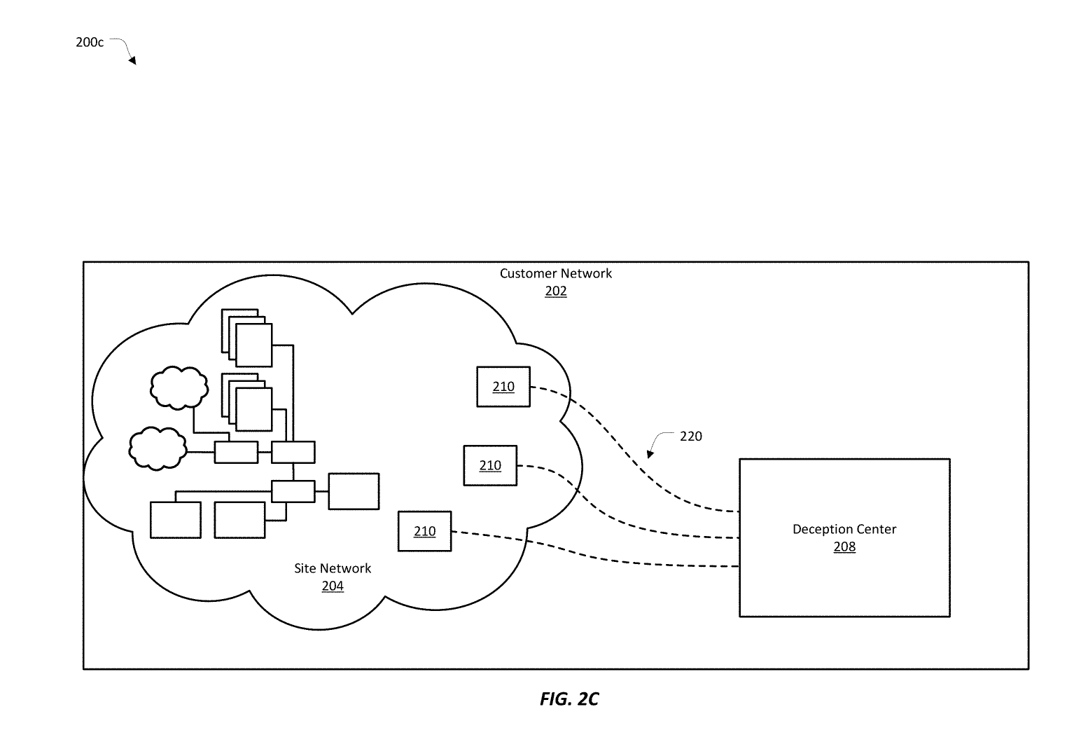

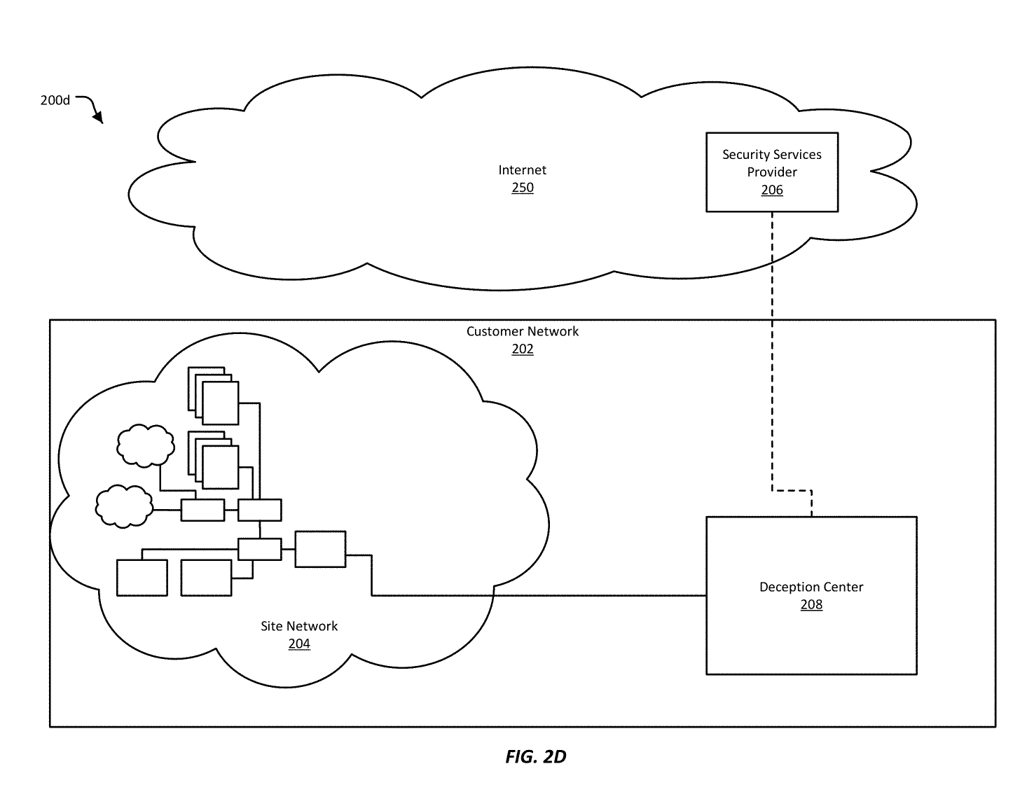

The network security system, such as the deception-based system described above, may be flexibly implemented to accommodate different customer networks. FIGS. 2A-2C provide examples of different installation configurations 200a-200c that can be used for different customer networks 202. A customer network 202 may generally be described as a network or group of networks that is controlled by a common entity, such as a business, a school, or a person. The customer network 202 may include one or more site networks 204. The customer network's 202 site networks 204 may be located in one geographic location, may be behind a common firewall, and/or may be multiple subnets within one network. Alternatively or additionally, a customer network's 202 site networks 204 may be located in different geographic locations, and be connected to each other over various private and public networks, including the Internet 250.

Different customer networks 202 may have different requirements regarding network security. For example, some customer networks 202 may have relatively open connections to outside networks such as the Internet 250, while other customer networks 202 have very restricted access to outside networks. The network security system described in FIG. 1 may be configurable to accommodate these variations.

FIG. 2A illustrates one example of an installation configuration 200a, where a deception center 208 is located within the customer network 202. In this example, being located within the customer network 202 means that the deception center 208 is connected to the customer network 202, and is able to function as a node in the customer network 202. In this example, the deception center 208 may be located in the same building or within the same campus as the site network 204. Alternatively or additionally, the deception center 208 may be located within the customer network 202 but at a different geographic location than the site network 204. The deception center 208 thus may be within the same subnet as the site network 204, or may be connected to a different subnet within the customer network.

In various implementations, the deception center 208 communicates with sensors 210, which may also be referred to as deception sensors, installed in the site network over network tunnels 220 In this example, the network tunnels 220 may cross one or more intermediate within the customer network 202.

In this example, the deception center 208 is able to communicate with a security services provider 206 that is located outside the customer network 202, such as on the Internet 250. The security services provider 206 may provide configuration and other information for the deception center 208. In some cases, the security services provider 206 may also assist in coordinating the security for the customer network 202 when the customer network 202 includes multiple site networks 204 located in various geographic areas.

FIG. 2B illustrates another example of an installation configuration 200b, where the deception center 208 is located outside the customer network 202. In this example, the deception center 208 may connected to the customer network 202 over the Internet 250. In some implementations, the deception center 208 may be co-located with a security services provider, and/or may be provided by the security services provider.

In this example, the tunnels 220 connect the deception center 208 to the sensors 210 through a gateway 262. A gateway is a point in a network that connects the network to another network. For example, in this example, the gateway 262 connects the customer network 202 to outside networks, such as the Internet 250. The gateway 262 may provide a firewall, which may provide some security for the customer network 202. The tunnels 220 may be able to pass through the firewall using a secure protocol, such as Secure Socket Shell (SSH) and similar protocols. Secure protocols typically require credentials, which may be provided by the operator of the customer network 202.

FIG. 2C illustrates another example of an installation configuration 200c, where the deception center 208 is located inside the customer network 202 but does not have access to outside networks. In some implementations, the customer network 202 may require a high level of network security. In these implementations, the customer network's 202 connections to the other networks may be very restricted. Thus, in this example, the deception center 208 is located within the customer network 202, and does not need to communicate with outside networks. The deception center 208 may use the customer networks 202 internal network to coordinate with and establish tunnels 220 to the sensors 210. Alternatively or additionally, a network administrator may configure the deception center 208 and sensors 210 to enable them to establish the tunnels. 220.

FIG. 2D illustrates another example of an installation configuration 200d. In this example, the deception center 208 is located inside the customer network 202, and further is directly connected to the site network 204. Directly connected, in this example, can mean that the deception center 208 is connected to a router, hub, switch, repeater, or other network infrastructure device that is part of the site network 204. Directly connected can alternatively or additionally mean that the deception center 208 is connected to the site network 204 using a Virtual Local Area Network (VLAN). For example, the deception center 208 can be connected to VLAN trunk port. In these examples, the deception center 208 can project deceptions into the site network 204 with or without the use of sensors, such as are illustrated in FIGS. 2A-2C.

In the example of FIG. 2D, the deception center 208 can also optionally be connected to an outside security services provider 206. The security services provider 206 can manage the deception center 208, including providing updated security data, sending firmware upgrades, and/or coordinating different deception centers 208 for different site networks 204 belonging to the same customer network 202. In some implementations, the deception center 208 can operate without the assistances of an outside security services provider 206.

### III. CUSTOMER NETWORKS

The network security system, such as the deception-based system discussed above, can be used for variety of customer networks. As noted above, customer networks can come in wide variety of configurations. For example, a customer network may have some of its network infrastructure “in the cloud.” A customer network can also include a wide variety of devices, including what may be considered “traditional” network equipment, such as servers and routers, and non-traditional, “Internet-of-Things” devices, such as kitchen appliances. Other examples of customer networks include established industrial networks, or a mix of industrial networks and computer networks.

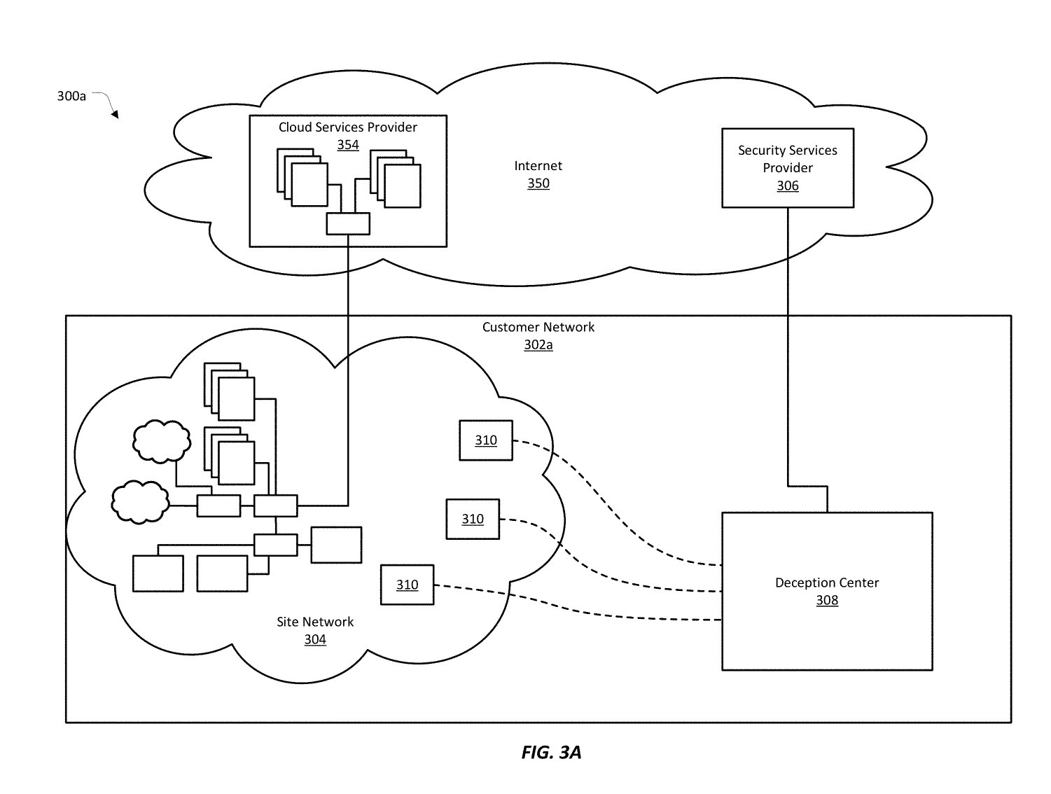

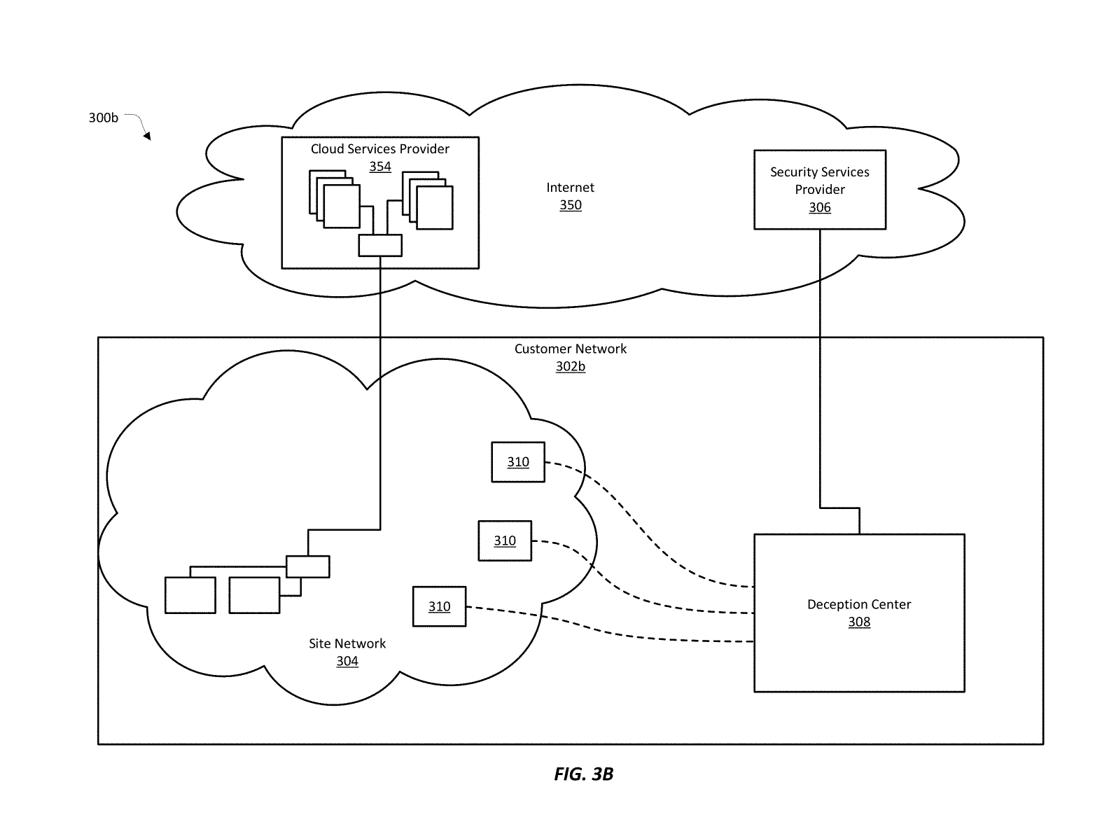

FIG. 3A-3B illustrate examples of customer networks 302a-302b where some of the customer networks' 302a-302b network infrastructure is “in the cloud,” that is, is provided by a cloud services provider 354. These example customer networks 302a-302b may be defended by a network security system that includes a deception center 308 and sensors 310, which may also be referred to as deception sensors, and may also include an off-site security services provider 306.

A cloud services provider is a company that offers some component of cloud computer—such as Infrastructure as a Service (IaaS), Software as a Service (SaaS) or Platform as Service (PaaS)—to other businesses and individuals. A cloud services provider may have a configurable pool of computing resources, including, for example, networks, servers, storage, applications, and services. These computing resources can be available on demand, and can be rapidly provisioned. While a cloud services provider's resources may be shared between the cloud service provider's customers, from the perspective of each customer, the individual customer may appear to have a private network within the cloud, including for example having dedicated subnets and IP addresses.

In the examples illustrated in FIGS. 3A-3B, the customer networks' 302a-302b network is partially in a site network 304, and partially provided by the cloud services provider 354. In some cases, the site network 304 is the part of the customer networks 302a-302b that is located at a physical site owned or controlled by the customer network 302a-302b. For example, the site network 304 may be a network located in the customer network's 302a-302b office or campus. Alternatively or additionally, the site network 304 may include network equipment owned and/or operated by the customer network 302 that may be located anywhere. For example, the customer networks' 302a-302b operations may consist of a few laptops owned by the customer networks 302a-302b, which are used from the private homes of the lap tops' users, from a co-working space, from a coffee shop, or from some other mobile location.

In various implementations, sensors 310 may be installed in the site network 304. The sensors 310 can be used by the network security system to project deceptions into the site network 304, monitor the site network 304 for attacks, and/or to divert suspect attacks into the deception center 308.

In some implementations, the sensors 310 may also be able to project deceptions into the part of the customer networks 302a-302b network that is provided by the cloud services provider 354. In most cases, it may not be possible to install sensors 310 inside the network of the cloud services provider 354, but in some implementations, this may not be necessary. For example, as discussed further below, the deception center 308 can acquire the subnet address of the network provided by the cloud services provider 354, and use that subnet address the create deceptions. Though these deceptions are projected form the sensors 310 installed in the site network 304, the deceptions may appear to be within the subnet provided by the cloud services provider 354.

In illustrated examples, the deception center 308 is installed inside the customer networks 302a-302b. Though not illustrated here, the deception center 308 can also be installed outside the customer networks 302a-302b, such as for example somewhere on the Internet 350. In some implementations, the deception center 308 may reside at the same location as the security service provider 306. When located outside the customer networks 302a-302b, the deception center 308 may connect to the sensors 310 in the site network 304 over various public and/or private networks.

FIG. 3A illustrates an example of a configuration 300a where the customer network's 302a network infrastructure is located in the cloud and the customer network 302a also has a substantial site network 304. In this example, the customer may have an office where the site network 304 is located, and where the customer's employees access and use the customer network 302a. For example, developers, sales and marketing personnel, human resources and finance employees, may access the customer network 302a from the site network 304. In the illustrated example, the customer may obtain applications and services from the cloud services provider 354. Alternatively or additionally, the cloud services provider 354 may provide data center services for the customer. For example, the cloud services provider 354 may host the customer's repository of data (e.g., music provided by a streaming music service, or video provided by a streaming video provider). In this example, the customer's own customers may be provided data directly from the cloud services provider 354, rather than from the customer network 302a.

FIG. 3B illustrates and example of a configuration 300b where the customer network's 302b network is primarily or sometimes entirely in the cloud. In this example, the customer network's 302b site network 304 may include a few laptops, or one or two desktop servers. These computing devices may be used by the customer's employees to conduct the customer's business, while the cloud services provider 354 provides the majority of the network infrastructure needed by the customer. For example, a very small company may have no office space and no dedicated location, and have as computing resources only the laptops used by its employees. This small company may use the cloud services provider 354 to provide its fixed network infrastructure. The small company may access this network infrastructure by connecting a laptop to any available network connection (e.g, in a co-working space, library, or coffee shop). When no laptops are connected to the cloud services provider 354, the customer network 302 may be existing entirely within the cloud.

In the example provided above, the site network 304 can be found wherever the customer's employees connect to a network and can access the cloud services provider 354. Similarly, the sensors 310 can be co-located with the employees' laptops. For example, whenever an employee connects to a network, she can enable a sensor 310, which can then project deceptions into the network around her. Alternatively or additionally, sensors 310 can be installed in a fixed location (such as the home of an employee of the customer) from which they can access the cloud services provider 354 and project deceptions into the network provided by the cloud services provider 354.

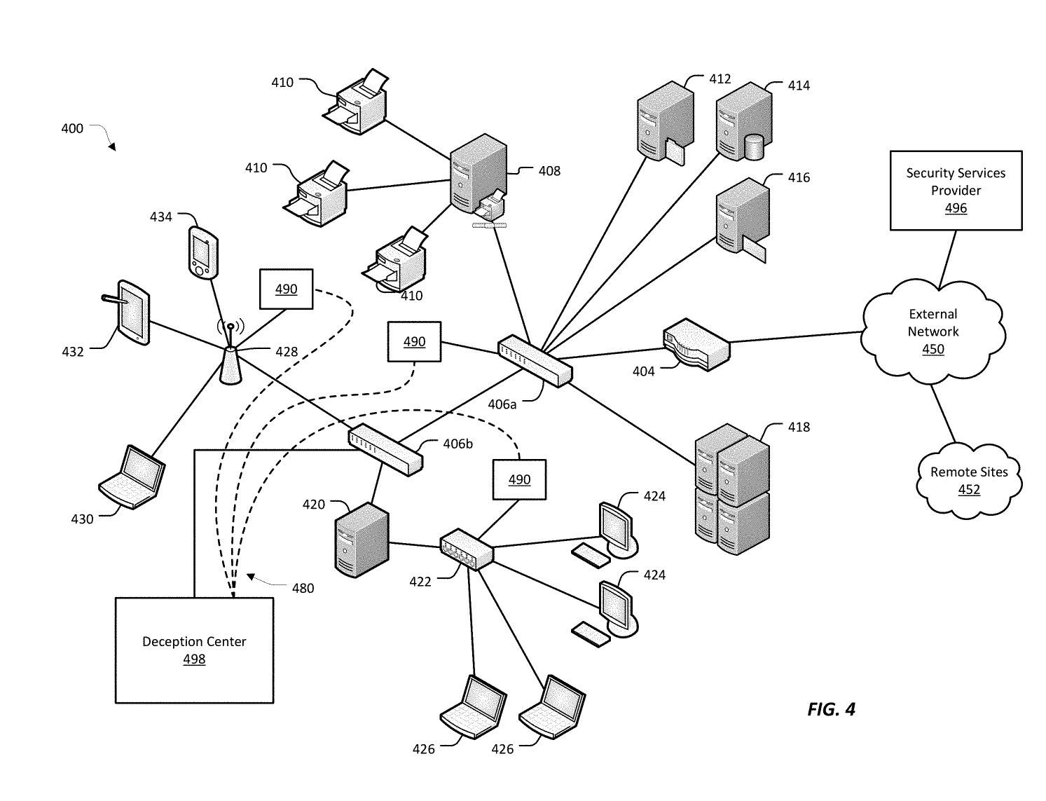

The network security system, such as the deception-based system discussed above, can provide network security for a variety of customer networks, which may include a diverse array of devices. FIG. 4 illustrates an example of an enterprise network 400, which is one such network that can be defended by a network security system. The example enterprise network 400 illustrates examples of various network devices and network clients that may be included in an enterprise network. The enterprise network 400 may include more or fewer network devices and/or network clients, and/or may include network devices, additional networks including remote sites 452, and/or systems not illustrated here. Enterprise networks may include networks installed at a large site, such as a corporate office, a university campus, a hospital, a government office, or a similar entity. An enterprise network may include multiple physical sites. Access to an enterprise networks is typically restricted, and may require authorized users to enter a password or otherwise authenticate before using the network. A network such as illustrated by the example enterprise network 400 may also be found at small sites, such as in a small business.

The enterprise network 400 may be connected to an external network 450. The external network 450 may be a public network, such as the Internet. A public network is a network that has been made accessible to any device that can connect to it. A public network may have unrestricted access, meaning that, for example, no password or other authentication is required to connect to it. The external network 450 may include third-party telecommunication lines, such as phone lines, broadcast coaxial cable, fiber optic cables, satellite communications, cellular communications, and the like. The external network 450 may include any number of intermediate network devices, such as switches, routers, gateways, servers, and/or controllers that are not directly part of the enterprise network 400 but that facilitate communication between the network 400 and other network-connected entities, such as a remote site 452.

Remote sites 452 are networks and/or individual computers that are generally located outside the enterprise network 400, and which may be connected to the enterprise network 400 through intermediate networks, but that function as if within the enterprise network 400 and connected directly to it. For example, an employee may connect to the enterprise network 400 while at home, using various secure protocols, and/or by connecting to a Virtual Private Network (VPN) provided by the enterprise network 400. While the employee's computer is connected, the employee's home is a remote site 452. Alternatively or additionally, the enterprise network's 400 owner may have a satellite office with a small internal network. This satellite office's network may have a fixed connection to the enterprise network 400 over various intermediate networks. This satellite office can also be considered a remote site.

The enterprise network 400 may be connected to the external network 450 using a gateway device 404. The gateway device 404 may include a firewall or similar system for preventing unauthorized access while allowing authorized access to the enterprise network 400. Examples of gateway devices include routers, modems (e.g. cable, fiber optic, dial-up, etc.), and the like.

The gateway device 404 may be connected to a switch 406a. The switch 406a provides connectivity between various devices in the enterprise network 400. In this example, the switch 406a connects together the gateway device 404, various servers 408, 412, 414, 416, 418, an another switch 406b. A switch typically has multiple ports, and functions to direct packets received on one port to another port. In some implementations, the gateway device 404 and the switch 406a may be combined into a single device.

Various servers may be connected to the switch 406a. For example, a print server 408 may be connected to the switch 406a. The print server 408 may provide network access to a number of printers 410. Client devices connected to the enterprise network 400 may be able to access one of the printers 410 through the print server 408.

Other examples of servers connected to the switch 406a include a file server 412, database server 414, and email server 416. The file server 412 may provide storage for and access to data. This data may be accessible to client devices connected to the enterprise network 400. The database server 414 may store one or more databases, and provide services for accessing the databases. The email server 416 may host an email program or service, and may also store email for users on the enterprise network 400.

As yet another example, a server rack 418 may be connected to the switch 406a. The server rack 418 may house one or more rack-mounted servers. The server rack 418 may have one connection to the switch 406a, or may have multiple connections to the switch 406a. The servers in the server rack 418 may have various purposes, including providing computing resources, file storage, database storage and access, and email, among others.

An additional switch 406b may also be connected to the first switch 406a. The additional switch 406b may be provided to expand the capacity of the network. A switch typically has a limited number of ports (e.g., 8, 16, 32, 64 or more ports). In most cases, however, a switch can direct traffic to and from another switch, so that by connecting the additional switch 406b to the first switch 406a, the number of available ports can be expanded.

In this example, a server 420 is connected to the additional switch 406b. The server 420 may manage network access for a number of network devices or client devices. For example, the server 420 may provide network authentication, arbitration, prioritization, load balancing, and other management services as needed to manage multiple network devices accessing the enterprise network 400. The server 420 may be connected to a hub 422. The hub 422 may include multiple ports, each of which may provide a wired connection for a network or client device. A hub is typically a simpler device than a switch, and may be used when connecting a small number of network devices together. In some cases, a switch can be substituted for the hub 422. In this example, the hub 422 connects desktop computers 424 and laptop computers 426 to the enterprise network 400. In this example, each of the desktop computers 424 and laptop computers 426 are connected to the hub 422 using a physical cable.

In this example, the additional switch 406b is also connected to a wireless access point 428. The wireless access point 428 provides wireless access to the enterprise network 400 for wireless-enabled network or client devices. Examples of wireless-enabled network and client devices include laptops 430, tablet computers 432, and smart phones 434, among others. In some implementations, the wireless access point 428 may also provide switching and/or routing functionality.

The example enterprise network 400 of FIG. 4 is defended from network threats by a network threat detection and analysis system, which uses deception security mechanisms to attract and divert attacks on the network. The deceptive security mechanisms may be controlled by and inserted into the enterprise network 400 using a deception center 498 and sensors 490, which may also be referred to as deception sensors, installed in various places in the enterprise network 400. In some implementations, the deception center 498 and the sensors 490 interact with a security services provider 496 located outside of the enterprise network 400. The deception center 498 may also obtain or exchange data with sources located on external networks 450, such as the Internet.

In various implementations, the sensors 490 are a minimal combination of hardware and/or software, sufficient to form a network connection with the enterprise network 400 and a network tunnel 480 with the deception center 498. For example, a sensor 490 may be constructed using a low-power processor, a network interface, and a simple operating system. In some implementations, any of the devices in the enterprise network (e.g., the servers 408, 412, 416, 418 the printers 410, the computing devices 424, 426, 430, 432, 434, or the network infrastructure devices 404, 406a, 406b, 428) can be configured to act as a sensor.

In various implementations, one or more sensors 490 can be installed anywhere in the enterprise network 400, include being attached switches 406a, hubs 422, wireless access points 428, and so on. The sensors 490 can further be configured to be part of one or more VLANs. The sensors 490 provide the deception center 498 with visibility into the enterprise network 400, such as for example being able to operate as a node in the enterprise network 400, and/or being able to present or project deceptive security mechanisms into the enterprise network 400. Additionally, in various implementations, the sensors 490 may provide a portal through which a suspected attack on the enterprise network 400 can be redirected to the deception center 498.

The deception center 498 provides network security for the enterprise network 400 by deploying security mechanisms into the enterprise network 400, monitoring the enterprise network 400 through the security mechanisms, detecting and redirecting apparent threats, and analyzing network activity resulting from the apparent threat. To provide security for the enterprise network 400, in various implementations the deception center 498 may communicate with sensors 490 installed in the enterprise network 400, using, for example, network tunnels 480. The tunnels 480 may allow the deception center 498 to be located in a different sub-network (“subnet”) than the enterprise network 400, on a different network, or remote from the enterprise network 400, with intermediate networks between the deception center 498 and the enterprise network 400. In some implementations, the enterprise network 400 can include more than one deception center 498. In some implementations, the deception center may be located off-site, such as in an external network 450.

In some implementations, the security services provider 496 may act as a central hub for providing security to multiple site networks, possibly including site networks controlled by different organizations. For example, the security services provider 496 may communicate with multiple deception centers 498 that each provide security for a different enterprise network 400 for the same organization. As another example, the security services provider 496 may coordinate the activities of the deception center 498 and the sensors 490, such as enabling the deception center 498 and the sensors 490 to connect to each other. In some implementations, the security services provider 496 is located outside the enterprise network 400. In some implementations, the security services provider 496 is controlled by a different entity than the entity that controls the site network. For example, the security services provider 496 may be an outside vendor. In some implementations, the security services provider 496 is controlled by the same entity as that controls the enterprise network 400. In some implementations, the network security system does not include a security services provider 496.

FIG. 4 illustrates one example of what can be considered a “traditional” network, that is, a network that is based on the interconnection of computers. In various implementations, a network security system, such as the deception-based system discussed above, can also be used to defend “non-traditional” networks that include devices other than traditional computers, such as for example mechanical, electrical, or electromechanical devices, sensors, actuators, and control systems. Such “non-traditional” networks may be referred to as the Internet of Things (IoT). The Internet of Things encompasses newly-developed, every-day devices designed to be networked (e.g., drones, self-driving automobiles, etc.) as well as common and long-established machinery that has augmented to be connected to a network (e.g., home appliances, traffic signals, etc.).

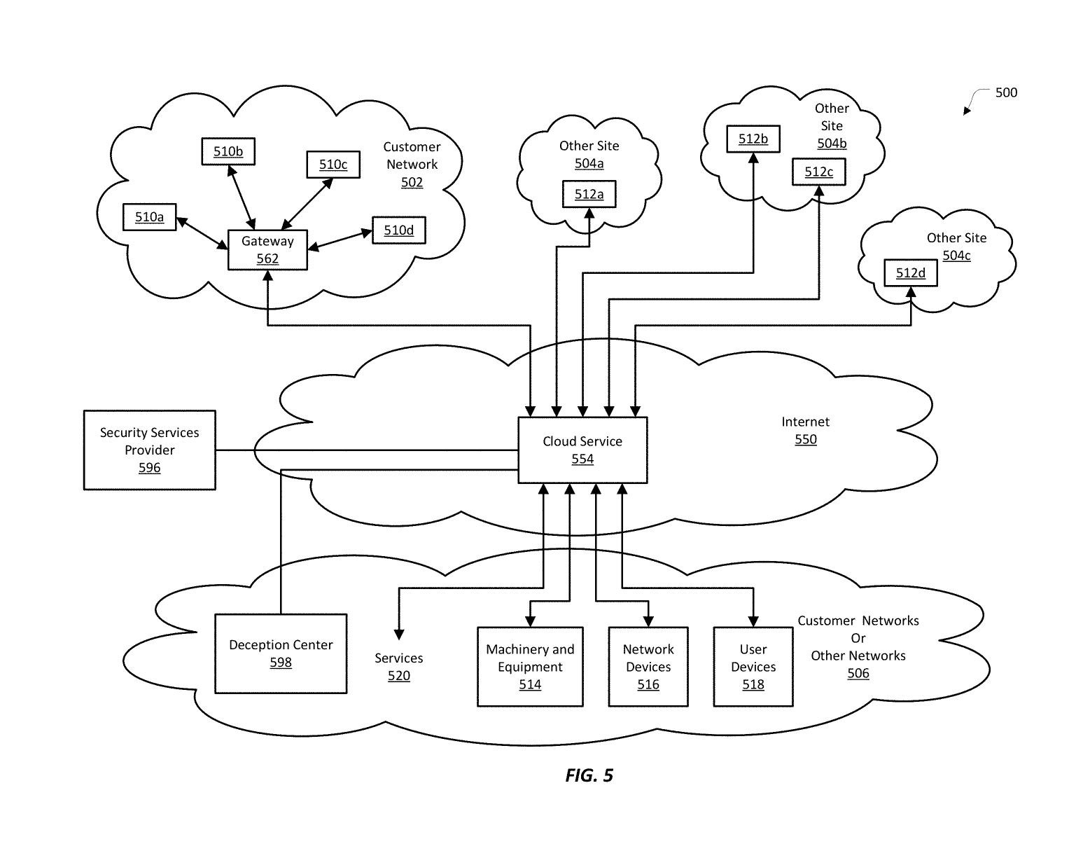

FIG. 5 illustrates a general example of an IoT network 500. The example IoT network 500 can be implemented wherever sensors, actuators, and control systems can be found. For example, the example IoT network 500 can be implemented for buildings, roads and bridges, agriculture, transportation and logistics, utilities, air traffic control, factories, and private homes, among others. In various implementations, the IoT network 500 includes cloud service 554 that collects data from various sensors 510a-510d, 512a-512d, located in various locations. Using the collected data, the cloud service 554 can provide services 520, control of machinery and equipment 514, exchange of data with traditional network devices 516, and/or exchange of data with user devices 518. In some implementations, the cloud service 554 can work with a deception center 528 and/or a security service provider 526 to provide security for the network 500.

A cloud service, such as the illustrated cloud service 554, is a resource provided over the Internet 550. Sometimes synonymous with “cloud computing,” the resource provided by the cloud services is in the “cloud” in that the resource is provided by hardware and/or software at some location remote from the place where the resource is used. Often, the hardware and software of the cloud service is distributed across multiple physical locations. Generally, the resource provided by the cloud service is not directly associated with specific hardware or software resources, such that use of the resource can continue when the hardware or software is changed. The resource provided by the cloud service can often also be shared between multiple users of the cloud service, without affecting each user's use. The resource can often also be provided as needed or on-demand. Often, the resource provided by the cloud service 554 is automated, or otherwise capable of operating with little or no assistance from human operators.

Examples of cloud services include software as a service (SaaS), infrastructure as a service (IaaS), platform as a service (PaaS), desktop as a service (DaaS), managed software as a service (MSaaS), mobile backend as a service (MBaaS), and information technology management as a service (ITMaas). Specific examples of cloud services include data centers, such as those operated by Amazon Web Services and Google Web Services, among others, that provide general networking and software services. Other examples of cloud services include those associated with smartphone applications, or “apps,” such as for example apps that track fitness and health, apps that allow a user to remotely manage her home security system or thermostat, and networked gaming apps, among others. In each of these examples, the company that provides the app may also provide cloud-based storage of application data, cloud-based software and computing resources, and/or networking services. In some cases, the company manages the cloud services provided by the company, including managing physical hardware resources. In other cases, the company leases networking time from a data center provider.

In some cases, the cloud service 554 is part of one integrated system, run by one entity. For example, the cloud service 554 can be part of a traffic control system. In this example, sensors 510a-510d, 512a-512d can be used to monitor traffic and road conditions.

In this example, the cloud service 554 can attempt to optimize the flow of traffic and also provide traffic safety. For example, the sensors 510a-510d, 512a-512d can include a sensor 512a on a bridge that monitors ice formation. When the sensor 512a detects that ice has formed on the bridge, the sensor 512a can alert the cloud service 554. The cloud service 554, can respond by interacting with machinery and equipment 514 that manages traffic in the area of the bridge. For example, the cloud service 554 can turn on warning signs, indicating to drivers that the bridge is icy. Generally, the interaction between the sensor 512, the cloud service 554, and the machinery and equipment 514 is automated, requiring little or no management by human operators.

In various implementations, the cloud service 554 collects or receives data from sensors 510a-510d, 512a-512d, distributed across one or more networks. The sensors 510a-510d, 512a-512d include devices capable of “sensing” information, such as air or water temperature, air pressure, weight, motion, humidity, fluid levels, noise levels, and so on. The sensors 510a-510d, 512a-512d can alternatively or additionally include devices capable of receiving input, such as cameras, microphones, touch pads, keyboards, key pads, and so on.

In some cases, a group of sensors 510a-510d may be common to one customer network 502. For example, the sensors 510a-510d may be motion sensors, traffic cameras, temperature sensors, and other sensors for monitoring traffic in a city's metro area. In this example, the sensors 510a-510d can be located in one area of the city, or be distribute across the city, and be connected to a common network. In these cases, the sensors 510a-510d can communicate with a gateway device 562, such as a network gateway. The gateway 562 can further communicate with the cloud service 554.

In some cases, in addition to receiving data from sensors 510a-510d in one customer network 502, the cloud service 554 can also receive data from sensors 512a-512d in other sites 504a-504c. These other sites 504a-504c can be part of the same customer network 502 or can be unrelated to the customer network 502. For example, the other sites 504a-504c can each be the metro area of a different city, and the sensors 512a-512d can be monitoring traffic for each individual city.

Generally, communication between the cloud service 554 and the sensors 510a-510d, 512a-512d is bidirectional. For example, the sensors 510a-510d, 512a-512d can send information to the cloud service 554. The cloud service 554 can further provide configuration and control information to the sensors 510a-510d, 512a-512d. For example, the cloud service 554 can enable or disable a sensor 510a-510d, 512a-512d or modify the operation of a sensor 510a-510d, 512a-512d, such as changing the format of the data provided by a sensor 510a-510d, 512a-512d or upgrading the firmware of a sensor 510a-510d, 512a-512d.

In various implementations, the cloud service 554 can operate on the data received from the sensors 510a-510d, 512a-512d, and use this data to interact with services 520 provided by the cloud service 554, or to interact with machinery and equipment 514, network devices 516, and/or user devices 518 available to the cloud service 554. Services 520 can include software-based services, such as cloud-based applications, website services, or data management services. Services 520 can alternatively or additionally include media, such as streaming video or music or other entertainment services. Services 520 can also include delivery and/or coordination of physical assets, such as for example package delivery, direction of vehicles for passenger pick-up and drop-off, or automate re-ordering and re-stocking of supplies. In various implementations, services 520 may be delivered to and used by the machinery and equipment 514, the network devices 516, and/or the user devices 518.

In various implementations, the machinery and equipment 514 can include physical systems that can be controlled by the cloud service 554. Examples of machinery and equipment 514 include factory equipment, trains, electrical street cars, self-driving cars, traffic lights, gate and door locks, and so on. In various implementations, the cloud service 554 can provide configuration and control of the machinery and equipment 514 in an automated fashion.

The network devices 516 can include traditional networking equipment, such as server computers, data storage devices, routers, switches, gateways, and so on. In various implementations, the cloud service 554 can provide control and management of the network devices 516, such as for example automated upgrading of software, security monitoring, or asset tracking. Alternatively or additionally, in various implementations the cloud service 554 can exchange data with the network devices 516, such as for example providing websites, providing stock trading data, or providing online shopping resources, among others. Alternatively or additionally, the network devices 516 can include computing systems used by the cloud service provider to manage the cloud service 554.

The user devices 518 can include individual personal computers, smart phones, tablet devices, smart watches, fitness trackers, medical devices, and so on that can be associated with an individual user. The cloud service 554 can exchange data with the user devices 518, such as for example provide support for applications installed on the user devices 518, providing websites, providing streaming media, providing directional navigation services, and so on. Alternatively or additionally, the cloud service 554 may enable a user to use a user device 518 to access and/or view other devices, such as the sensors 510a-510d, 512a-512d, the machinery and equipment 514, or the network devices 516.

In various implementations, the services 520, machinery and equipment 514, network devices 516, and user devices 518 may be part of one customer network 506. In some cases, this customer network 506 is the same as the customer network 502 that includes the sensors 510a-510d. In some cases, the services 520, machinery and equipment 514, network devices 516, and user devices 518 are part of the same network, and may instead be part of various other networks 506.

In various implementations, customer networks can include a deception center 598. The deception center 598 provides network security for the IoT network 500 by deploying security mechanisms into the IoT network 500, monitoring the IoT network 500 through the security mechanisms, detecting and redirecting apparent threats, and analyzing network activity resulting from the apparent threat. To provide security for the IoT network 500, in various implementations the deception center 598 may communicate with the sensors 510a-5106d, 512a-5012 installed in the IoT network 500, for example through the cloud service 554. In some implementations, the IoT network 500 can include more than one deception center 598. For example, each of customer network 502 and customer networks or other networks 506 can include a deception center 528.

In some implementations, the deception center 598 and the sensors 510a-510d, 512a-512d interact with a security services provider 596. In some implementations, the security services provider 596 may act as a central hub for providing security to multiple site networks, possibly including site networks controlled by different organizations. For example, the security services provider 596 may communicate with multiple deception centers 598 that each provide security for a different IoT network 500 for the same organization. As another example, the security services provider 596 may coordinate the activities of the deception center 598 and the sensors 510a-510d, 512a-512d, such as enabling the deception center 598 and the sensors 510a-510d, 512a-512d to connect to each other. In some implementations, the security services provider 596 is integrated into the cloud service 554. In some implementations, the security services provider 596 is controlled by a different entity than the entity that controls the site network. For example, the security services provider 596 may be an outside vendor. In some implementations, the security services provider 596 is controlled by the same entity as that controls the IoT network 500. In some implementations, the network security system does not include a security services provider 596.

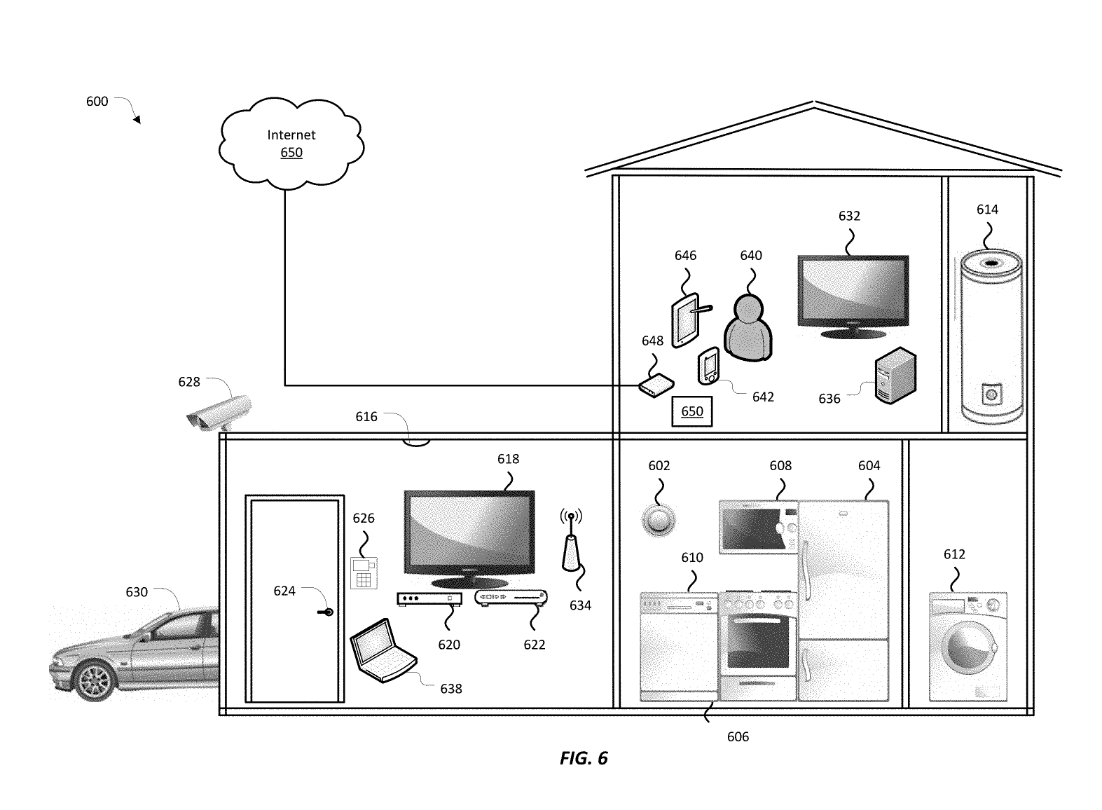

IoT networks can also include small networks of non-traditional devices. FIG. 6 illustrates an example of a customer network that is a small network 600, here implemented in a private home. A network for a home is an example of small network that may have both traditional and non-traditional network devices connected to the network 600, in keeping with an Internet of Things approach. Home networks are also an example of networks that are often implemented with minimal security. The average homeowner is not likely to be a sophisticated network security expert, and may rely on his modem or router to provide at least some basic security. The homeowner, however, is likely able to at least set up a basic home network. A deception-based network security device may be as simple to set up as a home router or base station, yet provide sophisticated security for the network 600.

The example network 600 of FIG. 6 may be a single network, or may include multiple sub-networks. These sub-networks may or may not communicate with each other. For example, the network 600 may include a sub-network that uses the electrical wiring in the house as a communication channel. Devices configured to communicate in this way may connect to the network using electrical outlets, which also provide the devices with power. The sub-network may include a central controller device, which may coordinate the activities of devices connected to the electrical network, including turning devices on and off at particular times. One example of a protocol that uses the electrical wiring as a communication network is X10.

The network 600 may also include wireless and wired networks, built into the home or added to the home solely for providing a communication medium for devices in the house. Examples of wireless, radio-based networks include networks using protocols such as Z-Wave™, Zigbee™ (also known as Institute of Electrical and Electronics Engineers (IEEE) 802.15.4), Bluetooth™, and Wi-Fi (also known as IEEE 802.11), among others. Wireless networks can be set up by installing a wireless base station in the house. Alternatively or additionally, a wireless network can be established by having at least two devices in the house that are able to communicate with each other using the same protocol.

Examples of wired networks include Ethernet (also known as IEEE 802.3), token ring (also known as IEEE 802.5), Fiber Distributed Data Interface (FDDI), and Attached Resource Computer Network (ARCNET), among others. A wired network can be added to the house by running cabling through the walls, ceilings, and/or floors, and placing jacks in various rooms that devices can connect to with additional cables. The wired network can be extended using routers, switches, and/or hubs. In many cases, wired networks may be interconnected with wireless networks, with the interconnected networks operating as one seamless network. For example, an Ethernet network may include a wireless base station that provides a Wi-Fi signal for devices in the house.

As noted above, a small network 600 implemented in a home is one that may include both traditional network devices and non-traditional, everyday electronics and appliances that have also been connected to the network 600. Examples of rooms where one may find non-traditional devices connected to the network are the kitchen and laundry rooms. For example, in the kitchen a refrigerator 604, oven 606, microwave 608, and dishwasher 610 may be connected to the network 600, and in the laundry room a washing machine 612 may be connected to the network 600. By attaching these appliances to the network 600, the homeowner can monitor the activity of each device (e.g., whether the dishes are clean, the current state of a turkey in the oven, or the washing machine cycle) or change the operation of each device without needing to be in the same room or even be at home. The appliances can also be configured to resupply themselves. For example, the refrigerator 604 may detect that a certain product is running low, and may place an order with a grocery delivery service for the product to be restocked.

The network 600 may also include environmental appliances, such as a thermostat 602 and a water heater 614. By having these devices connected to the network 600, the homeowner can monitor the current environment of the house (e.g., the air temperature or the hot water temperature), and adjust the settings of these appliances while at home or away. Furthermore, software on the network 600 or on the Internet 650 may track energy usage for the heating and cooling units and the water heater 614. This software may also track energy usage for the other devices, such as the kitchen and laundry room appliances. The energy usage of each appliance may be available to the homeowner over the network 600.

In the living room, various home electronics may be on the network 600. These electronics may have once been fully analog or may have been standalone devices, but now include a network connection for exchanging data with other devices in the network 600 or with the Internet 650. The home electronics in this example include a television 618, a gaming system 620, and a media device 622 (e.g., a video and/or audio player). Each of these devices may play media hosted, for example, on network attached storage 636 located elsewhere in the network 600, or media hosted on the Internet 650.

The network 600 may also include home safety and security devices, such as a smoke detector 616, an electronic door lock 624, and a home security system 626. Having these devices on the network may allow the homeowner to track the information monitored and/or sensed by these devices, both when the homeowner is at home and away from the house. For example, the homeowner may be able to view a video feed from a security camera 628. When the safety and security devices detect a problem, they may also inform the homeowner. For example, the smoke detector 616 may send an alert to the homeowner's smartphone when it detects smoke, or the electronic door lock 624 may alert the homeowner when there has been a forced entry. Furthermore, the homeowner may be able to remotely control these devices. For example, the homeowner may be able to remotely open the electronic door lock 624 for a family member who has been locked out. The safety and security devices may also use their connection to the network to call the fire department or police if necessary.

Another non-traditional device that may be found in the network 600 is the family car 630. The car 630 is one of many devices, such as laptop computers 638, tablet computers 646, and smartphones 642, that connect to the network 600 when at home, and when not at home, may be able to connect to the network 600 over the Internet 650. Connecting to the network 600 over the Internet 650 may provide the homeowner with remote access to his network. The network 600 may be able to provide information to the car 630 and receive information from the car 630 while the car is away. For example, the network 600 may be able to track the location of the car 630 while the car 630 is away.

In the home office and elsewhere around the house, this example network 600 includes some traditional devices connected to the network 600. For example, the home office may include a desktop computer 632 and network attached storage 636. Elsewhere around the house, this example includes a laptop computer 638 and handheld devices such as a tablet computer 646 and a smartphone 642. In this example, a person 640 is also connected to the network 600. The person 640 may be connected to the network 600 wirelessly through personal devices worn by the person 640, such as a smart watch, fitness tracker, or heart rate monitor. The person 640 may alternatively or additionally be connected to the network 600 through a network-enabled medical device, such as a pacemaker, heart monitor, or drug delivery system, which may be worn or implanted.

The desktop computer 632, laptop computer 638, tablet computer 646, and/or smartphone 642 may provide an interface that allows the homeowner to monitor and control the various devices connected to the network. Some of these devices, such as the laptop computer 638, the tablet computer 646, and the smartphone 642 may also leave the house, and provide remote access to the network 600 over the Internet 650. In many cases, however, each device on the network may have its own software for monitoring and controlling only that one device. For example, the thermostat 602 may use one application while the media device 622 uses another, and the wireless network provides yet another. Furthermore, it may be the case that the various sub-networks in the house do not communicate with each other, and/or are viewed and controlled using software that is unique to each sub-network. In many cases, the homeowner may not have one unified and easily understood view of his entire home network 600.

The small network 600 in this example may also include network infrastructure devices, such as a router or switch (not shown) and a wireless base station 634. The wireless base station 634 may provide a wireless network for the house. The router or switch may provide a wired network for the house. The wireless base station 634 may be connected to the router or switch to provide a wireless network that is an extension of the wired network. The router or switch may be connected to a gateway device 648 that connects the network 600 to other networks, including the Internet 650. In some cases, a router or switch may be integrated into the gateway device 648. The gateway device 648 is a cable modem, digital subscriber line (DSL) modem, optical modem, analog modem, or some other device that connects the network 600 to an ISP. The ISP may provide access to the Internet 650. Typically, a home network only has one gateway device 648. In some cases, the network 600 may not be connected to any networks outside of the house. In these cases, information about the network 600 and control of devices in the network 600 may not be available when the homeowner is not connected to the network 600; that is, the homeowner may not have access to his network 600 over the Internet 650.

Typically, the gateway device 648 includes a hardware and/or software firewall. A firewall monitors incoming and outgoing network traffic and, by applying security rules to the network traffic, attempts to keep harmful network traffic out of the network 600. In many cases, a firewall is the only security system protecting the network 600. While a firewall may work for some types of intrusion attempts originating outside the network 600, the firewall may not block all intrusion mechanisms, particularly intrusions mechanisms hidden in legitimate network traffic. Furthermore, while a firewall may block intrusions originating on the Internet 650, the firewall may not detect intrusions originating from within the network 600. For example, an infiltrator may get into the network 600 by connecting to signal from the wireless base station 634. Alternatively, the infiltrator may connect to the network 600 by physically connecting, for example, to the washing machine 612. The washing machine 612 may have a port that a service technician can connect to service the machine. Alternatively or additionally, the washing machine 612 may have a simple Universal Serial Bus (USB) port. Once an intruder has gained access to the washing machine 612, the intruder may have access to the rest of the network 600.

To provide more security for the network 600, a deception-based network security device 660 can be added to the network 600. In some implementations, the security device 660 is a standalone device that can be added to the network 600 by connecting it to a router or switch. In some implementations, the security device 660 can alternatively or additionally be connected to the network's 600 wireless sub-network by powering on the security device 660 and providing it with Wi-Fi credentials. The security device 660 may have a touchscreen, or a screen and a keypad, for inputting Wi-Fi credentials. Alternatively or additionally, the homeowner may be able to enter network information into the security device by logging into the security device 660 over a Bluetooth™ or Wi-Fi signal using software on a smartphone, tablet, or laptop, or using a web browser. In some implementations, the security device 660 can be connected to a sub-network running over the home's electrical wiring by connecting the security device 660 to a power outlet. In some implementations, the security device 660 may have ports, interfaces, and/or radio antennas for connecting to the various sub-networks that can be included in the network 600. This may be useful, for example, when the sub-networks do not communicate with each other, or do not communicate with each other seamlessly. Once powered on and connected, the security device 660 may self-configure and monitor the security of each sub-network in the network 600 that it is connected to.

In some implementations, the security device 660 may be configured to connect between the gateway device 648 and the network's 600 primary router, and/or between the gateway device 648 and the gateway device's 648 connection to the wall. Connected in one or both of these locations, the security device 648 may be able to control the network's 600 connection with outside networks. For example, the security device can disconnect the network 600 from the Internet 650.

In some implementations, the security device 660, instead of being implemented as a standalone device, may be integrated into one or more of the appliances, home electronics, or computing devices (in this example network 600), or in some other device not illustrated here. For example, the security device 660—or the functionality of the security device 660—may be incorporated into the gateway device 648 or a desktop computer 632 or a laptop computer 638. As another example, the security device 660 can be integrated into a kitchen appliance (e.g., the refrigerator 604 or microwave 608), a home media device (e.g., the television 618 or gaming system 620), or the home security system 626. In some implementations, the security device 660 may be a printed circuit board that can be added to another device without requiring significant changes to the other device. In some implementations, the security device 660 may be implemented using an Application Specific Integrated Circuit (ASIC) or Field Programmable Gate Array (FPGA) that can be added to the electronics of a device. In some implementations, the security device 660 may be implemented as a software module or modules that can run concurrently with the operating system or firmware of a networked device. In some implementations, the security device 660 may have a physical or virtual security barrier that prevents access to it by the device that it is integrated into. In some implementations, the security device's 660 presence in another device may be hidden from the device into which the security device 660 is integrated.

In various implementations, the security device 660 may scan the network 600 to determine which devices are present in the network 600. Alternatively or additionally, the security device 660 may communicate with a central controller in the network 600 (or multiple central controllers, when there are sub-networks, each with their own central controller) to learn which devices are connected to the network 600. In some implementations, the security device 660 may undergo a learning period, during which the security device 660 learns the normal activity of the network 600, such as what time of day appliances and electronics are used, what they are used for, and/or what data is transferred to and from these devices. During the learning period, the security device 660 may alert the homeowner to any unusual or suspicious activity. The homeowner may indicate that this activity is acceptable, or may indicate that the activity is an intrusion. As described below, the security device 660 may subsequently take preventive action against the intrusion.

Once the security device 660 has learned the topology and/or activity of the network 600, the security device 660 may be able to provide deception-based security for the network 600. In some implementations, the security device 660 may deploy security mechanisms that are configured to emulate devices that could be found in the network 600. In some implementations, the security device 660 may monitor activity on the network 600, including watching the data sent between the various devices on the network 600, and between the devices and the Internet 650. The security device 660 may be looking for activity that is unusual, unexpected, or readily identifiable as suspect. Upon detecting suspicious activity in the network 600, the security device 660 may deploy deceptive security mechanisms.

In some implementations, the deceptive security mechanisms are software processes running on the security device 660 that emulate devices that may be found in the network 600. In some implementations, the security device 660 may be assisted in emulating the security devices by another device on the network 600, such as the desktop computer 632. From the perspective of devices connected to the network 600, the security mechanisms appear just like any other device on the network, including, for example, having an Internet Protocol (IP) address, a Media Access Control (MAC) address, and/or some other identification information, having an identifiable device type, and responding to or transmitting data just as would the device being emulated. The security mechanisms may be emulated by the security device 660 itself; thus, while, from the point of view of the network 600, the network 600 appears to have additional devices, no physical equivalent (other than the security device 660) can be found in the house.

The devices and data emulated by a security mechanism are selected such that the security mechanism is an attractive target for intrusion attempts. Thus, the security mechanism may emulate valuable data, and/or devices that are easily hacked into, and/or devices that provide easy access to the reset of the network 600. Furthermore, the security mechanisms emulate devices that are likely to be found in the network 600, such as a second television, a second thermostat, or another laptop computer. In some implementations, the security device 660 may contact a service on the Internet 650 for assistance in selecting devices to emulate and/or for how to configure emulated devices. The security devices 660 may select and configure security mechanisms to be attractive to intrusions attempts, and to deflect attention away from more valuable or vulnerable network assets. Additionally, the security mechanisms can assist in confirming that an intrusion into the network 600 has actually taken place.

In some implementations, the security device 660 may deploy deceptive security mechanisms in advance of detecting any suspicious activity. For example, having scanned the network, the security device 660 may determine that the network 600 includes only one television 618 and one smoke detector 616. The security device 660 may therefore choose to deploy security mechanisms that emulate a second television and a second smoke detector. With security mechanisms preemptively added to the network, when there is an intrusion attempt, the intruder may target the security mechanisms instead of valuable or vulnerable network devices. The security mechanisms thus may serve as decoys and may deflect an intruder away from the network's 600 real devices.

In some implementations, the security mechanisms deployed by the security device 660 may take into account specific requirements of the network 600 and/or the type of devices that can be emulated. For example, in some cases, the network 600 (or a sub-network) may assign identifiers to each device connected to the network 600, and/or each device may be required to adopt a unique identifier. In these cases, the security device 660 may assign an identifier to deployed security mechanisms that do not interfere with identifiers used by actual devices in the network 600. As another example, in some cases, devices on the network 600 may register themselves with a central controller and/or with a central service on the Internet 650. For example, the thermostat 602 may register with a service on the Internet 650 that monitors energy use for the home. In these cases, the security mechanisms that emulate these types of devices may also register with the central controller or the central service. Doing so may improve the apparent authenticity of the security mechanism, and may avoid conflicts with the central controller or central service. Alternatively or additionally, the security device 660 may determine to deploy security mechanisms that emulate other devices, and avoid registering with the central controller or central service.

In some implementations, the security device 660 may dynamically adjust the security mechanisms that it has deployed. For example, when the homeowner adds devices to the network 600, the security device 660 may remove security mechanisms that conflict with the new devices, or change a security mechanism so that the security mechanism's configuration is not incongruous with the new devices (e.g., the security mechanisms should not have the same MAC address as a new device). As another example, when the network owner removes a device from the network 600, the security device 660 may add a security mechanism that mimics the device that was removed. As another example, the security device may change the activity of a security mechanism, for example, to reflect changes in the normal activity of the home, changes in the weather, the time of year, the occurrence of special events, and so on.

The security device 660 may also dynamically adjust the security mechanisms it has deployed in response to suspicious activity it has detected on the network 600. For example, upon detecting suspicious activity, the security device 660 may change the behavior of a security mechanism or may deploy additional security mechanisms. The changes to the security mechanisms may be directed by the suspicious activity, meaning that if, for example, the suspicious activity appears to be probing for a wireless base station 634, the security device 660 may deploy a decoy wireless base station.

Changes to the security mechanisms are meant not only to attract a possible intrusion, but also to confirm that an intrusion has, in fact occurred. Since the security mechanisms are not part of the normal operation of the network 600, normal occupants of the home are not expected to access the security mechanisms. Thus, in most cases, any access of a security mechanism is suspect. Once the security device 660 has detected an access to a security mechanism, the security device 660 may next attempt to confirm that an intrusion into the network 600 has taken place. An intrusion can be confirmed, for example, by monitoring activity at the security mechanism. For example, login attempts, probing of data emulated by the security mechanism, copying of data from the security mechanism, and attempts to log into another part of the network 600 from the security mechanism indicate a high likelihood that an intrusion has occurred.

Once the security device 660 is able to confirm an intrusion into the network 600, the security device 660 may alert the homeowner. For example, the security device 660 may sound an audible alarm, send an email or text message to the homeowner or some other designated persons, and/or send an alert to an application running on a smartphone or tablet. As another example, the security device 660 may access other network devices and, for example, flash lights, trigger the security system's 626 alarm, and/or display messages on devices that include display screens, such as the television 618 or refrigerator 604. In some implementations, depending on the nature of the intrusion, the security device 660 may alert authorities such as the police or fire department.

In some implementations, the security device 660 may also take preventive actions. For example, when an intrusion appears to have originated outside the network 600, the security device 660 may block the network's 600 access to the Internet 650, thus possibly cutting off the intrusion. As another example, when the intrusion appears to have originated from within the network 600, the security device 660 may isolate any apparently compromised devices, for example by disconnecting them from the network 600. When only its own security mechanisms are compromised, the security device 660 may isolate itself from the rest of the network 600. As another example, when the security device 660 is able to determine that the intrusion very likely included physical intrusion into the house, the security device 660 may alert the authorities. The security device 660 may further lock down the house by, for example, locking any electronic door locks 624.

In some implementations, the security device 660 may be able to enable a homeowner to monitor the network 600 when a suspicious activity has been detected, or at any other time. For example, the homeowner may be provided with a software application that can be installed on a smartphone, tablet, desktop, and/or laptop computer. The software application may receive information from the security device 660 over a wired or wireless connection. Alternatively or additionally, the homeowner may be able to access information about his network through a web browser, where the security device 660 formats webpages for displaying the information. Alternatively or additionally, the security device 660 may itself have a touchscreen or a screen and key pad that provide information about the network 600 to the homeowner.

The information provided to the homeowner may include, for example, a list and/or graphic display of the devices connected to the network 600. The information may further provide a real-time status of each device, such as whether the device is on or off, the current activity of the device, data being transferred to or from the device, and/or the current user of the device, among other things. The list or graphic display may update as devices connect and disconnect from the network 600, such as for example laptops and smartphones connecting to or disconnecting from a wireless sub-network in the network 600. The security device 660 may further alert the homeowner when a device has unexpectedly been disconnected from the network 600. The security device 660 may further alert the homeowner when an unknown device connects to the network 600, such as for example when a device that is not known to the homeowner connects to the Wi-Fi signal.

The security device 660 may also maintain historic information. For example, the security device 660 may provide snapshots of the network 600 taken once a day, once a week, or once a month. The security device 660 may further provide a list of devices that have, for example, connected to the wireless signal in the last hour or day, at what times, and for how long. The security device 660 may also be able to provide identification information for these devices, such as MAC addresses or usernames. As another example, the security device 660 may also maintain usage statistics for each device in the network 600, such as for example the times at which each device was in use, what the device was used for, how much energy the device used, and so on.

The software application or web browser or display interface that provides the homeowner with information about his network 600 may also enable the homeowner to make changes to the network 600 or to devices in the network 600. For example, through the security device 660, the homeowner may be able to turn devices on or off, change the configuration of a device, change a password for a device or for the network, and so on.

In some implementations, the security device 660 may also display currently deployed security mechanisms and their configuration. In some implementations, the security device 660 may also display activity seen at the security mechanisms, such as for example a suspicious access to a security mechanism. In some implementations, the security device 660 may also allow the homeowner to customize the security mechanisms. For example, the homeowner may be able to add or remove security mechanisms, modify data emulated by the security mechanisms, modify the configuration of security mechanism, and/or modify the activity of a security mechanism.

A deception-based network security device 660 thus can provide sophisticated security for a small network. The security device 660 may be simple to add to a network, yet provide comprehensive protection against both external and internal intrusions. Moreover, the security device 660 may be able to monitor multiple sub-networks that are each using different protocols. The security device 660, using deceptive security mechanisms, may be able to detect and confirm intrusions into the network 600. The security device 660 may be able to take preventive actions when an intrusion occurs. The security device 660 may also be able to provide the homeowner with information about his network, and possibly also control over devices in the network.

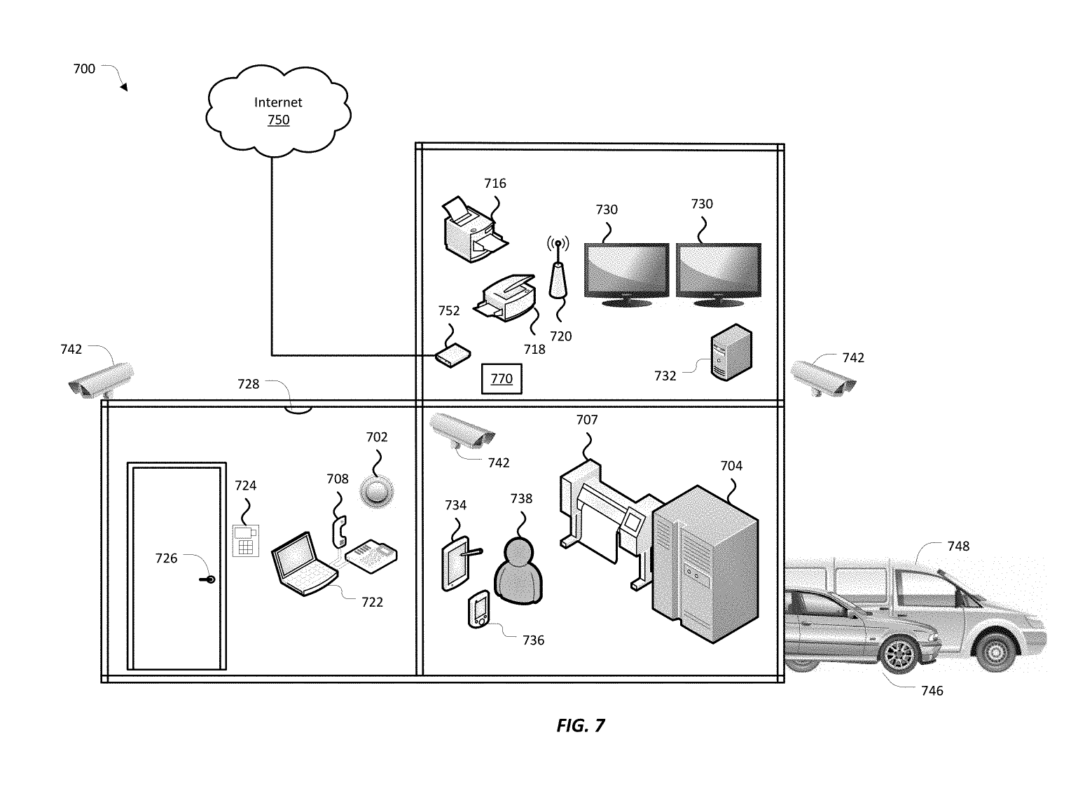

FIG. 7 illustrates another example of a small network 700, here implemented in a small business. A network in a small business may have both traditional and non-traditional devices connected to the network 700. Small business networks are also examples of networks that are often implemented with minimal security. A small business owner may not have the financial or technical resources, time, or expertise to configure a sophisticated security infrastructure for her network 700. The business owner, however, is likely able to at least set up a network 700 for the operation of the business. A deception-based network security device that is at least as simple to set up as the network 700 itself may provide inexpensive and simple yet sophisticated security for the network 700.

The example network 700 may be one, single network, or may include multiple sub-networks. For example, the network 700 may include a wired sub-network, such as an Ethernet network, and a wireless sub-network, such as an 802.11 Wi-Fi network. The wired sub-network may be implemented using cables that have been run through the walls and/or ceilings to the various rooms in the business. The cables may be connected to jacks in the walls that devices can connect to in order to connect to the network 700. The wireless network may be implemented using a wireless base station 720, or several wireless base stations, which provide a wireless signal throughout the business. The network 700 may include other wireless sub-networks, such as a short-distance Bluetooth™ network. In some cases, the sub-networks communicate with one another. For example, the Wi-Fi sub-network may be connected to the wired Ethernet sub-network. In some cases, the various sub-networks in the network 700 may not be configured to or able to communicate with each other.

As noted above, the small business network 700 may include both computers, network infrastructure devices, and other devices not traditionally found in a network. The network 700 may also include electronics, machinery, and systems that have been connected to the network 700 according to an Internet-of-Things approach. Workshop machinery that was once purely analog may now have computer controls. Digital workshop equipment may be network-enabled. By connecting shop equipment and machinery to the network 700, automation and efficiency of the business can be improved and orders, materials, and inventory can be tracked. Having more devices on the network 700, however, may increase the number of vulnerabilities in the network 700. Devices that have only recently become network-enabled may be particularly vulnerable because their security systems have not yet been hardened through use and attack. A deception-based network security device may provide simple-to-install and sophisticated security for a network that may otherwise have only minimal security.

The example small business of FIG. 7 includes a front office. In the front office, the network may include devices for administrative tasks. These devices may include, for example, a laptop 722 and a telephone 708. These devices may be attached to the network 700 in order to, for example, access records related to the business, which may be stored on a server 732 located elsewhere in the building. In the front office, security devices for the building may also be found, including, for example, security system controls 724 and an electronic door lock 726. Having the security devices on the network 700 may enable the business owner to remotely control access to the building. The business owner may also be able to remotely monitor the security of building, such as for example being able to view video streams from security cameras 742. The front office may also be where environmental controls, such as a thermostat 702, are located. Having the thermostat 702 on the network 700 may allow the business owner to remotely control the temperature settings. A network-enabled thermostat 702 may also track energy usage for the heating and cooling systems. The front office may also include safety devices, such as a network-connected smoke alarm 728. A network-connected smoke alarm may be able to inform the business owner that there is a problem in the building be connecting to the business owner's smartphone or computer.

Another workspace in this example small business is a workshop. In the workshop, the network 700 may include production equipment for producing the goods sold by the business. The production equipment may include, for example, manufacturing machines 704 (e.g. a milling machine, a Computer Numerical Control (CNC) machine, a 3D printer, or some other machine tool) and a plotter 706. The production equipment may be controlled by a computer on the network 700, and/or may receive product designs over the network 700 and independently execute the designs. In the workshop, one may also find other devices related to the manufacturing of products, such as radiofrequency identification (RFID) scanners, barcode or Quick Response (QR) code generators, and other devices for tracking inventory, as well as electronic tools, hand tools, and so on.

In the workshop and elsewhere in the building, mobile computing devices and people 738 may also be connected to the network 700. Mobile computing devices include, for example, tablet computers 734 and smartphones 736. These devices may be used to control production equipment, track supplies and inventory, receive and track orders, and/or for other operations of the business. People 738 may be connected to the network through network-connected devices worn or implanted in the people 738, such as for example smart watches, fitness trackers, heart rate monitors, drug delivery systems, pacemakers, and so on.

At a loading dock, the example small business may have a delivery van 748 and a company car 746. When these vehicles are away from the business, they may be connected to the network 700 remotely, for example over the Internet 750. By being able to communicate with the network 700, the vehicles may be able to receive information such as product delivery information (e.g., orders, addresses, and/or delivery times), supply pickup instructions, and so on. The business owner may also be able to track the location of these vehicles from the business location, or over the Internet 750 when away from the business, and/or track who is using the vehicles.

The business may also have a back office. In the back office, the network 700 may include traditional network devices, such as computers 730, a multi-function printer 716, a scanner 718, and a server 732. In this example, the computers 730 may be used to design products for manufacturing in the workshop, as well as for management of the business, including tracking orders, supplies, inventory, and/or human resources records. The multi-function printer 716 and scanner 718 may support the design work and the running of the business. The server 732 may store product designs, orders, supply records, and inventory records, as well as administrative data, such as accounting and human resources data.

The back office may also be where a gateway device 752 is located. The gateway device 752 connects the small business to other networks, including the Internet 750. Typically, the gateway device 752 connects to an ISP, and the ISP provides access to the Internet 750. In some cases, a router may be integrated into the gateway device 752. In some cases, gateway device 752 may be connected to an external router, switch, or hub, not illustrated here. In some cases, the network 700 is not connected to any networks outside of the business's own network 700. In these cases, the network 700 may not have a gateway device 752.

The back office is also where the network 700 may have a deception-based network security device 760. The security device 760 may be a standalone device that may be enabled as soon as it is connected to the network 700. Alternatively or additionally, the security device 760 may be integrated into another device connected to the network 700, such as the gateway device 752, a router, a desktop computer 730, a laptop computer 722, the multi-function printer 716, or the thermostat 702, among others. When integrated into another device, the security device 760 may use the network connection of the other device, or may have its own network connection for connecting to the network 700. The security device 760 may connect to the network 700 using a wired connection or a wireless connection.

Once connected to the network 700, the security device 760 may begin monitoring the network 700 for suspect activity. In some implementations, the security device 760 may scan the network 700 to learn which devices are connected to the network 700. In some cases, the security device 760 may learn the normal activity of the network 700, such as what time the various devices are used, for how long, by whom, for what purpose, and what data is transferred to and from each device, among other things.

In some implementations, having learned the configuration and/or activity of the network 700, the security device 760 may deploy deceptive security mechanisms. These security mechanisms may emulate devices that may be found on the network 700, including having an identifiable device type and/or network identifiers (such as a MAC address and/or IP address), and being able to send and receive network traffic that a device of a certain time would send and receive. For example, for the example small business, the security device 760 may configure a security mechanism to emulate a 3D printer, a wide-body scanner, or an additional security camera. The security device 760 may further avoid configuring a security mechanism to emulate a device that is not likely to be found in the small business, such as a washing machine. The security device 760 may use the deployed security mechanisms to monitor activity on the network 700.

In various implementations, when the security device 760 detects suspect activity, the security device 760 may deploy additional security mechanisms. These additional security mechanisms may be selected based on the nature of suspect activity. For example, when the suspect activity appears to be attempting to break into the shop equipment, the security device 760 may deploy a security mechanism that looks like shop equipment that is easy to hack. In some implementations, the security device 760 may deploy security mechanisms only after detecting suspect activity on the network 700.

The security device 760 selects devices to emulate that are particularly attractive for an infiltration, either because the emulated device appears to have valuable data or because the emulated device appears to be easy to infiltrate, or for some other reason. In some implementations, the security device 760 connects to a service on the Internet 750 for assistance in determining which devices to emulate and/or how to configure the emulated device. Once deployed, the security mechanisms serve as decoys to attract the attention of a possible infiltrator away from valuable network assets. In some implementations, the security device 760 emulates the security mechanisms using software processes. In some implementations, the security device 760 may be assisted in emulating security mechanisms by a computer 730 on the network.

In some implementations, the security device 760 may deploy security mechanisms prior to detecting suspicious activity on the network 700. In these implementations, the security mechanisms may present more attractive targets for a possible, future infiltration, so that if an infiltration occurs, the infiltrator will go after the security mechanisms instead of the actual devices on the network 700.

In various implementations, the security device 760 may also change the security mechanisms that it has deployed. For example, the security device 760 may add or remove security mechanisms as the operation of the business changes, as the activity on the network 700 changes, as devices are added or removed from the network 700, as the time of year changes, and so on.

Besides deflecting a possible network infiltration away from valuable or vulnerable network devices, the security device 760 may use the security mechanisms to confirm that the network 700 has been infiltrated. Because the security mechanisms are not part of actual devices in use by the business, any access to them over the network is suspect. Thus, once the security device 760 detects an access to one of its security mechanisms, the security device 760 may attempt to confirm that this access is, in fact, an unauthorized infiltration of the network 700.

To confirm that a security mechanism has been infiltrated, the security device 760 may monitor activity seen at the security mechanism. The security device 760 may further deploy additional security mechanisms, to see if, for example, it can present an even more attractive target to the possible infiltrator. The security device 760 may further look for certain activity, such as log in attempts to other devices in the network, attempts to examine data on the security mechanism, attempts to move data from the security mechanism to the Internet 750, scanning of the network 700, password breaking attempts, and so on.

Once the security device 760 has confirmed that the network 700 has been infiltrated, the security device 760 may alert the business owner. For example, the security device 760 may sound an audible alarm, email or send text messages to the computers 730 and/or handheld devices 734, 736, send a message to the business's cars 746, 748, flash lights, or trigger the security system's 724 alarm. In some implementations, the security device 760 may also take preventive measures. For example, the security device 760 may disconnect the network 700 from the Internet 750, may disconnect specific devices from the network 700 (e.g., the server 732 or the manufacturing machines 704), may turn some network-connected devices off, and/or may lock the building.

In various implementations, the security device 760 may allow the business owner to monitor her network 700, either when an infiltration is taking place or at any other time. For example, the security device 760 may provide a display of the devices currently connected to the network 700, including flagging any devices connected to the wireless network that do not appear to be part of the business. The security device 760 may further display what each device is currently doing, who is using them, how much energy each device is presently using, and/or how much network bandwidth each device is using. The security device 760 may also be able to store this information and provide historic configuration and/or usage of the network 700.

The security device 760 may have a display it can use to show information to the business owner. Alternatively or additionally, the security device 760 may provide this information to a software application that can run on a desktop or laptop computer, a tablet, or a smartphone. Alternatively or additionally, the security device 760 may format this information for display through a web browser. The business owner may further be able to control devices on the network 700 through an interface provided by the security device 760, including, for example, turning devices on or off, adjusting settings on devices, configuring user accounts, and so on. The business owner may also be able to view any security mechanisms presently deployed, and may be able to re-configure the security mechanisms, turn them off, or turn them on.

IoT networks can also include industrial control systems. Industrial control system is a general term that encompasses several types of control systems, including supervisory control and data acquisition (SCADA) systems, distributed control systems (DCS) and other control system configurations, such as Programmable Logic Controllers (PLCs), often found in the industrial sectors and infrastructures. Industrial control systems are often found in industries such as electrical, water and wastewater, oil and natural gas, chemical, transportation, pharmaceutical, pulp and paper, food and beverage, and discrete manufacturing (e.g., automotive, aerospace, and durable goods). While a large percentage of industrial control systems may be privately owned and operated, federal agencies also operate many industrial processes, such as air traffic control systems and materials handling (e.g., Postal Service mail handling).

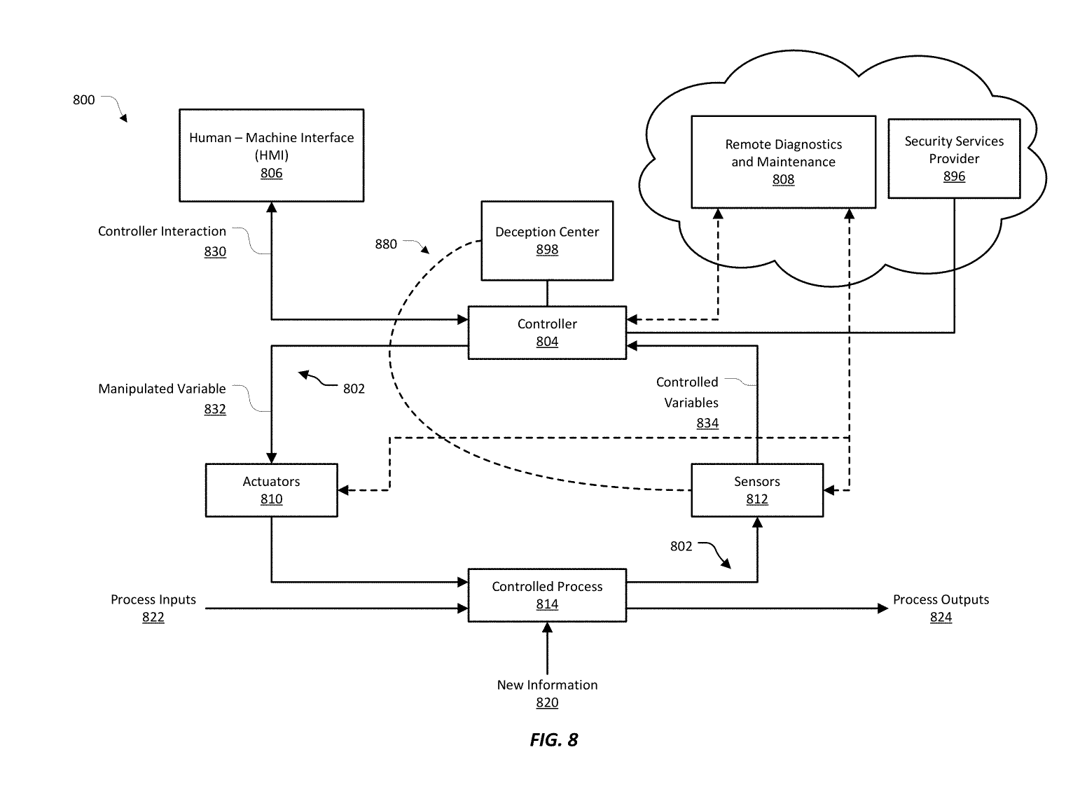

FIG. 8 illustrates an example of the basic operation of an industrial control system 800. Generally, an industrial control system 800 may include a control loop 802, a human-machine interface 806, and remote diagnostics and maintenance 808. In some implementations, the example industrial control system can be defended by a network threat detection and analysis system, which can include a deception center 898 and a security services provider 896.

A control loop 802 may consist of sensors 812, controller 804 hardware such as PLCs, actuators 810, and the communication of variables 832, 834. The sensors 812 may be used for measuring variables in the system, while the actuators 810 may include, for example, control valves breakers, switches, and motors. Some of the sensors 812 may be deceptions sensors. Controlled variables 834 may be transmitted to the controller 804 from the sensors 812. The controller 804 may interpret the controlled variables 834 and generates corresponding manipulated variables 832, based on set points provided by controller interaction 830. The controller 804 may then transmit the manipulated variables 832 to the actuators 810. The actuators 810 may drive a controlled process 814 (e.g., a machine on an assembly line). The controlled process 814 may accept process inputs 822 (e.g., raw materials) and produce process outputs 824 (e.g., finished products). New information 820 provided to the controlled process 814 may result in new sensor 812 signals, which identify the state of the controlled process 814 and which may also transmitted to the controller 804.

In some implementations, at least some of the sensors 812 can also provide the deception center 898 with visibility into the industrial control system 800, such as for example being able to present or project deceptive security mechanisms into the industrial control system. Additionally, in various implementations, the sensors 812 may provide a portal through which a suspected attack on the industrial control system can be redirected to the deception center 898. The deception center 898 and the sensors 812 may be able to communicate using network tunnels 880.

The deception center 898 provides network security for the industrial control system 800 by deploying security mechanisms into the industrial control system 800, monitoring the industrial control system through the security mechanisms, detecting and redirecting apparent threats, and analyzing network activity resulting from the apparent threat. In some implementations, the industrial control system 800 can include more than one deception center 898. In some implementations, the deception center may be located off-site, such as on the Internet.

In some implementations, the deception center 898 may interact with a security services provider 896 located outside the industrial control system 800. The security services provider 896 may act as a central hub for providing security to multiple sites that are part of the industrial control system 800, and/or for multiple separate, possibly unrelated, industrial control systems. For example, the security services provider 896 may communicate with multiple deception centers 898 that each provide security for a different industrial control system 800 for the same organization. As another example, the security services provider 896 may coordinate the activities of the deception center 898 and the sensors 812, such as enabling the deception center 898 and the sensors 812 to connect to each other. In some implementations, the security services provider 896 is located outside the industrial control system 800. In some implementations, the security services provider 896 is controlled by a different entity than the entity that controls the site network. For example, the security services provider 896 may be an outside vendor. In some implementations, the security services provider 896 is controlled by the same entity as that controls the industrial control system. In some implementations, the network security system does not include a security services provider 896.

The human-machine interface 806 provides operators and engineers with an interface for controller interaction 830. Controller interaction 830 may include monitoring and configuring set points and control algorithms, and adjusting and establishing parameters in the controller 804. The human-machine interface 806 typically also receives information from the controller 804 that allows the human-machine interface 806 to display process status information and historical information about the operation of the control loop 802.

The remote diagnostics and maintenance 808 utilities are typically used to prevent, identify, and recover from abnormal operation or failures. For diagnostics, the remote diagnostics and maintenance utilities 808 may monitor the operation of each of the controller 804, sensors 812, and actuators 810. To recover after a problem, the remote diagnostics and maintenance utilities 808 may provide recovery information and instructions to one or more of the controller 804, sensors 812, and/or actuators 810.

A typical industrial control system contains many control loops, human-machine interfaces, and remote diagnostics and maintenance tools, built using an array of network protocols on layered network architectures. In some cases, multiple control loops are nested and/or cascading, with the set point for one control loop being based on process variables determined by another control loop. Supervisory-level control loops and lower-level control loops typically operate continuously over the duration of a process, with cycle times ranging from milliseconds to minutes.

One type of industrial control system that may include many control loops, human-machine interfaces, and remote diagnostics and maintenance tools is a supervisory control and data acquisition (SCADA) system. SCADA systems are used to control dispersed assets, where centralized data acquisition is typically as important as control of the system. SCADA systems are used in distribution systems such as, for example, water distribution and wastewater collection systems, oil and natural gas pipelines, electrical utility transmission and distribution systems, and rail and other public transportation systems, among others. SCADA systems typically integrate data acquisition systems with data transmission systems and human-machine interface software to provide a centralized monitoring and control system for numerous process inputs and outputs. SCADA systems are typically designed to collect field information, transfer this information to a central computer facility, and to display the information to an operator in a graphic and/or textual manner. Using this displayed information, the operator may, in real time, monitor and control an entire system from a central location. In various implementations, control of any individual sub-system, operation, or task can be automatic, or can be performed by manual commands.

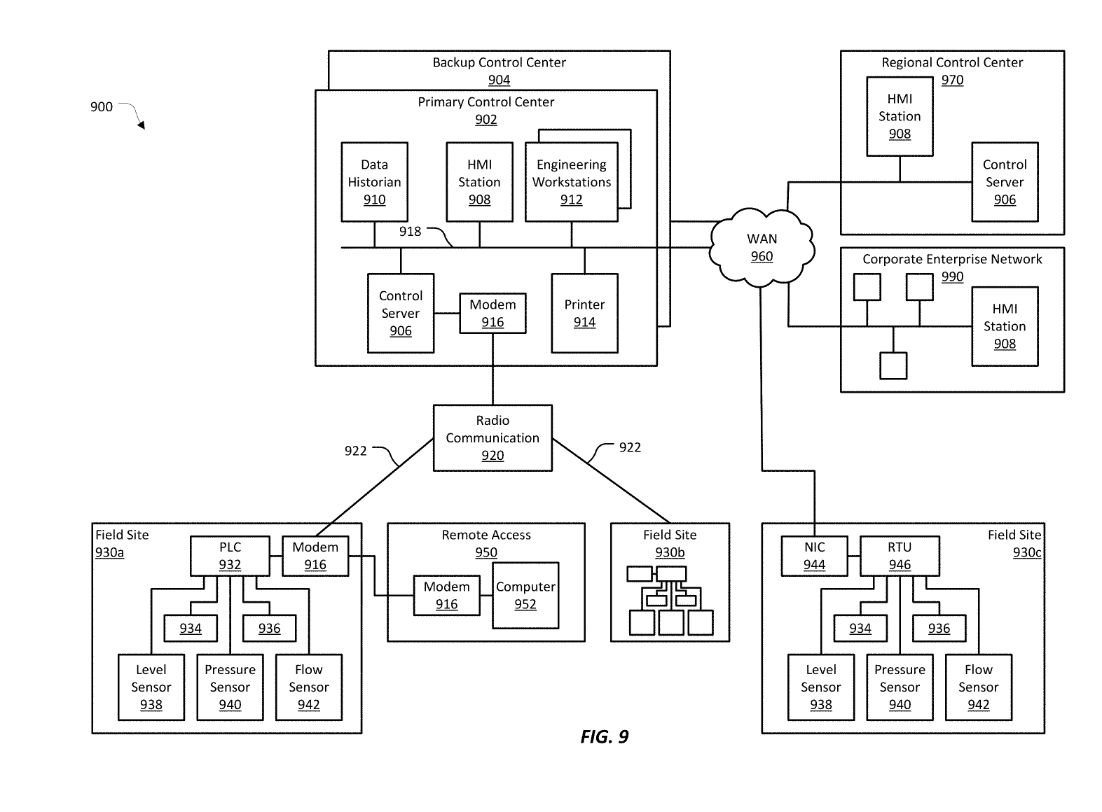

FIG. 9 illustrates an example of a SCADA system 900, here used for distributed monitoring and control. This example SCADA system 900 includes a primary control center 902 and three field sites 930a-930c. A backup control center 904 provides redundancy in case of there is a malfunction at the primary control center 902. The primary control center 902 in this example includes a control server 906—which may also be called a SCADA server or a Master Terminal Unit (MTU)—and a local area network (LAN) 908. The primary control center 902 may also include a human-machine interface station 908, a data historian 910, engineering workstations 912, and various network equipment such as printers 914, each connected to the LAN 918.

The control server 906 typically acts as the master of the SCADA system 900. The control server 906 typically includes supervisory control software that controls lower-level control devices, such as Remote Terminal Units (RTUs) and PLCs, located at the field sites 930a-930c. The software may tell the system 900 what and when to monitor, what parameter ranges are acceptable, and/or what response to initiate when parameters are outside of acceptable values.

The control server 906 of this example may access Remote Terminal Units and/or PLCs at the field sites 930a-930c using a communications infrastructure, which may include radio-based communication devices, telephone lines, cables, and/or satellites. In the illustrated example, the control server 906 is connected to a modem 916, which provides communication with serial-based radio communication 920, such as a radio antenna. Using the radio communication 920, the control server 906 can communicate with field sites 930a-930b using radiofrequency signals 922. Some field sites 930a-930b may have radio transceivers for communicating back to the control server 906.

A human-machine interface station 908 is typically a combination of hardware and software that allows human operators to monitor the state of processes in the SCADA system 900. The human-machine interface station 908 may further allow operators to modify control settings to change a control objective, and/or manually override automatic control operations, such as in the event of an emergency. The human-machine interface station 908 may also allow a control engineer or operator to configure set points or control algorithms and parameters in a controller, such as a Remote Terminal Unit or a PLC. The human-machine interface station 908 may also display process status information, historical information, reports, and other information to operators, administrators, mangers, business partners, and other authorized users. The location, platform, and interface of a human-machine interface station 908 may vary. For example, the human-machine interface station 908 may be a custom, dedicated platform in the primary control center 902, a laptop on a wireless LAN, or a browser on a system connected to the Internet.

The data historian 910 in this example is a database for logging all process information within the SCADA system 900. Information stored in this database can be accessed to support analysis of the system 900, for example for statistical process control or enterprise level planning.

The backup control center 904 may include all or most of the same components that are found in the primary control center 902. In some cases, the backup control center 904 may temporarily take over for components at the primary control center 902 that have failed or have been taken offline for maintenance. In some cases, the backup control center 904 is configured to take over all operations of the primary control center 902, such as when the primary control center 902 experiences a complete failure (e.g., is destroyed in a natural disaster).

The primary control center 902 may collect and log information gathered by the field sites 930a-930c and display this information using the human-machine interface station 908. The primary control center 902 may also generate actions based on detected events. The primary control center 902 may, for example, poll field devices at the field sites 930a-930c for data at defined intervals (e.g., 5 or 60 seconds), and can send new set points to a field device as required. In addition to polling and issuing high-level commands, the primary control center 902 may also watch for priority interrupts coming from the alarm systems at the field sites 930a-930c.

In this example, the primary control center 902 uses point-to-point connections to communication with three field sites 930a-930c, using radio telemetry for two communications with two of the field sites 930a-930b. In this example, the primary control center 902 uses a wide area network (WAN) 960 to communicate with the third field site 930c. In other implementations, the primary control center 902 may use other communication topologies to communicate with field sites. Other communication topologies include rings, stars, meshes, trees, lines or series, and busses or multi-drops, among others. Standard and proprietary communication protocols may be used to transport information between the primary control center 902 and field sites 930a-930c. These protocols may use telemetry techniques such as provided by telephone lines, cables, fiber optics, and/or radiofrequency transmissions such as broadcast, microwave, and/or satellite communications.

The field sites 930a-930c in this example perform local control of actuators and monitor local sensors. For example, a first field site 930a may include a PLC 932. A PLC is a small industrial computer originally designed to perform the logic functions formerly executed by electrical hardware (such as relays, switches, and/or mechanical timers and counters). PLCs have evolved into controllers capable of controlling complex processes, and are used extensively in both SCADA systems and distributed control systems. Other controllers used at the field level include process controllers and Remote Terminal Units, which may provide the same level of control as a PLC but may be designed for specific control applications. In SCADA environments, PLCs are often used as field devices because they are more economical, versatile, flexible, and configurable than special-purpose controllers.

The PLC 932 at a field site, such as the first field site 930a, may control local actuators 934, 936 and monitor local sensors 938, 940, 942. Examples of actuators include valves 934 and pumps 936, among others. Examples of sensors include level sensors 938, pressure sensors 940, and flow sensors 942, among others. Any of the actuators 934, 936 or sensors 938, 940, 942 may be “smart” actuators or sensors, more commonly called intelligent electronic devices (IEDs). Intelligent electronic devices may include intelligence for acquiring data, communicating with other devices, and performing local processing and control. An intelligent electronic device could combine an analog input sensor, analog output, low-level control capabilities, a communication system, and/or program memory in one device. The use of intelligent electronic devices in SCADA systems and distributed control systems may allow for automatic control at the local level. Intelligent electronic devices, such as protective relays, may communicate directly with the control server 906. Alternatively or additionally, a local Remote Terminal Unit may poll intelligent electronic devices to collect data, which it may then pass to the control server 906.

Field sites 930a-930c are often equipped with remote access capability that allows field operators to perform remote diagnostics and repairs. For example, the first remote 930a may include a modem 916 connected to the PLC 932. A remote access 950 site may be able to, using a dial up connection, connect to the modem 916. The remote access 950 site may include its own modem 916 for dialing into to the field site 930a over a telephone line. At the remote access 950 site, an operator may use a computer 952 connected to the modem 916 to perform diagnostics and repairs on the first remote site 930a.

The example SCADA system 900 includes a second field site 930b, which may be provisioned in substantially the same way as the first field site 930a, having at least a modem and a PLC or Remote Terminal that controls and monitors some number of actuators and sensors.

The example SCADA system 900 also includes a third field site 930c that includes a network interface card (NIC) 944 for communicating with the system's 900 WAN 960. In this example, the third field site 930c includes a Remote Terminal Unit 946 that is responsible for controlling local actuators 934, 936 and monitoring local sensors 938, 940, 942. A Remote Terminal Unit, also called a remote telemetry unit, is a special-purpose data acquisition and control unit typically designed to support SCADA remote stations. Remote Terminal Units may be field devices equipped with wireless radio interfaces to support remote situations where wire-based communications are unavailable. In some cases, PLCs are implemented as Remote Terminal Units.

The SCADA system 900 of this example also includes a regional control center 970 and a corporate enterprise network 980. The regional control center 970 may provide a higher level of supervisory control. The regional control center 970 may include at least a human-machine interface station 908 and a control server 906 that may have supervisory control over the control server 906 at the primary control center 902. The corporate enterprise network 980 typically has access, through the system's 900 WAN 960, to all the control centers 902, 904 and to the field sites 930a-930c. The corporate enterprise network 980 may include a human-machine interface station 908 so that operators can remotely maintain and troubleshoot operations.

Another type of industrial control system is the distributed control system (DCS). Distributed control systems are typically used to control production systems within the same geographic location for industries such as oil refineries, water and wastewater management, electric power generation plants, chemical manufacturing plants, and pharmaceutical processing facilities, among others. These systems are usually process control or discrete part control systems. Process control systems may be processes that run continuously, such as manufacturing processes for fuel or steam flow in a power plant, for petroleum production in a refinery, or for distillation in a chemical plant. Discrete part control systems have processes that have distinct processing steps, typically with a distinct start and end to each step, such as found in food manufacturing, electrical and mechanical parts assembly, and parts machining. Discrete-based manufacturing industries typically conduct a series of steps on a single item to create an end product.

A distributed control system typically uses a centralized supervisory control loop to mediate a group of localized controllers that share the overall tasks of carrying out an entire production process. By modularizing the production system, a distributed control system may reduce the impact of a single fault on the overall system. A distributed control system is typically interfaced with a corporate network to give business operations a view of the production process.

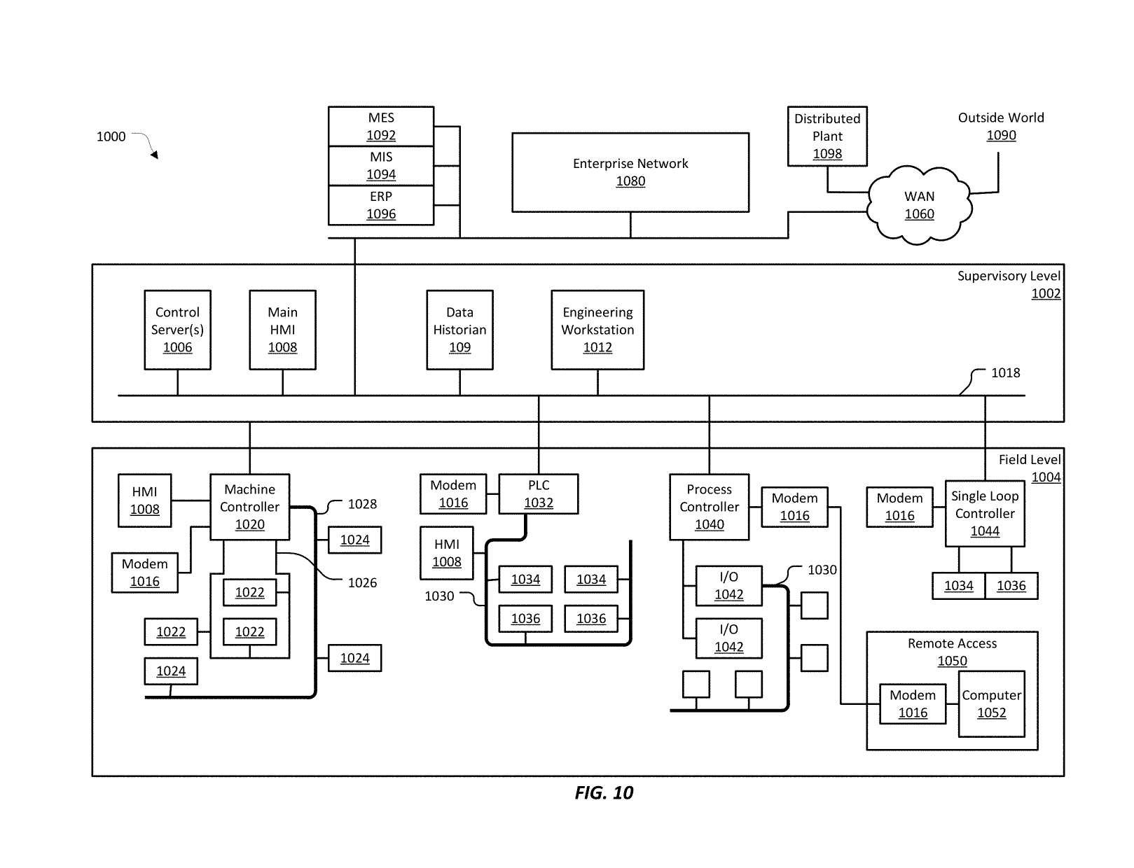

FIG. 10 illustrates an example of a distributed control system 1000. This example distributed control system 1000 encompasses a production facility, including bottom-level production processes at a field level 1004, supervisory control systems at a supervisory level 1002, and a corporate or enterprise layer.

At the supervisory level 1002, a control server 1006, operating as a supervisory controller, may communicate with subordinate systems via a control network 1018. The control server 1006 may send set points to distributed field controllers, and may request data from the distributed field controllers. The supervisory level 1002 may include multiple control servers 1006, with one acting as the primary control server and the rest acting as redundant, back-up control servers. The supervisory level 1002 may also include a main human-machine interface 1008 for use by operators and engineers, a data historian 1010 for logging process information from the system 1000, and engineering workstations 1012.

At the field level 1004, the system 1000 may include various distributed field controllers. In the illustrated example, the distributed control system 1000 includes a machine controller 1020, a PLC 1032, a process controller 1040, and a single loop controller 1044.

The distributed field controllers may each control local process actuators, based on control server 1006 commands and sensor feedback from local process sensors.

In this example, the machine controller 1020 drives a motion control network 1026. Using the motion control network 1026, the machine controller 1020 may control a number of servo drives 1022, which may each drive a motor. The machine controller 1020 may also drive a logic control bus 1028 to communicate with various devices 1024. For example, the machine controller 1020 may use the logic control bus 1028 to communicate with pressure sensors, pressure regulators, and/or solenoid valves, among other devices. One or more of the devices 1024 may be an intelligent electronic device. A human-machine interface 1008 may be attached to the machine controller 1020 to provide an operator with local status information about the processes under control of the machine controller 1020, and/or local control of the machine controller 1020. A modem 1016 may also be attached to the machine controller 1020 to provide remote access to the machine controller 1020.

The PLC 1032 in this example system 1000 uses a fieldbus 1030 to communicate with actuators 1034 and sensors 1036 under its control. These actuators 1034 and sensors 1036 may include, for example, direct current (DC) servo drives, alternating current (AC) servo drives, light towers, photo eyes, and/or proximity sensors, among others. A human-machine interface 1008 may also be attached to the fieldbus 1030 to provide operators with local status and control for the PLC 1032. A modem 1016 may also be attached to the PLC 1032 to provide remote access to the PLC 1032.

The process controller 1040 in this example system 1000 also uses a fieldbus 1030 to communicate with actuators and sensors under its control, one or more of which may be intelligent electronic devices. The process controller 1040 may communicate with its fieldbus 1030 through an input/output (I/O) server 1042. An I/O server is a control component typically responsible for collecting, buffering, and/or providing access to process information from control sub-components. An I/O server may be used for interfacing with third-party control components. Actuators and sensors under control of the process controller 1040 may include, for example, pressure regulators, pressure sensors, temperature sensors, servo valves, and/or solenoid valves, among others. The process controller 1040 may be connected to a modem 1016 so that a remote access 1050 site may access the process controller 1040. The remote access 1050 site may include a computer 1052 for use by an operator to monitor and control the process controller 1040. The computer 1052 may be connected to a local modem 1016 for dialing in to the modem 1016 connected to the process controller 1040.

The illustrated example system 1000 also includes a single loop controller 1044. In this example, the single loop controller 1044 interfaces with actuators 1034 and sensors 1036 with point-to-point connections, instead of a fieldbus. Point-to-point connections require a dedicated connection for each actuator 1034 and each sensor 1036. Fieldbus networks, in contrast, do not need point-to-point connections between a controller and individual field sensors and actuators. In some implementations, a fieldbus allows greater functionality beyond control, including field device diagnostics. A fieldbus can accomplish control algorithms within the fieldbus, thereby avoiding signal routing back to a PLC for every control operation. Standard industrial communication protocols are often used on control networks and fieldbus networks.

The single loop controller 1044 in this example is also connected to a modem 1016, for remote access to the single loop controller.

In addition to the supervisory level 1002 and field level 1004 control loops, the distributed control system 1000 may also include intermediate levels of control. For example, in the case of a distributed control system controlling a discrete part manufacturing facility, there could be an intermediate level supervisor for each cell within the plant. This intermediate level supervisor could encompass a manufacturing cell containing a machine controller that processes a part, and a robot controller that handles raw stock and final products. Additionally, the distributed control system could include several of these cells that manage field-level controllers under the main distributed control system supervisory control loop.

In various implementations, the distributed control system may include a corporate or enterprise layer, where an enterprise network 1080 may connect to the example production facility. The enterprise network 1080 may be, for example, located at a corporate office co-located with the facility, and connected to the control network 1018 in the supervisory level 1002. The enterprise network 1080 may provide engineers and managers with control and visibility into the facility. The enterprise network 1080 may further include Manufacturing Execution Systems (MES) 1092, control systems for managing and monitoring work-in-process on a factory floor. An MES can track manufacturing information in real time, receiving up-to-the-minute data from robots, machine monitors and employees. The enterprise network 1080 may also include Management Information Systems (MIS) 1094, software and hardware applications that implement, for example, decision support systems, resource and people management applications, project management, and database retrieval applications, as well as basic business functions such as order entry and accounting. The enterprise network 1080 may further include Enterprise Resource Planning (ERP) systems 1096, business process management software that allows an organization to use a system of integrated applications to manage the business and automate many back office functions related to technology, services, and human resources.

The enterprise network 1080 may further be connected to a WAN 1060. Through the WAN 1060, the enterprise network 1080 may connect to a distributed plant 1098, which may include control loops and supervisory functions similar to the illustrated facility, but which may be at a different geographic location. The WAN 1060 may also connect the enterprise network to the outside world 1090, that is, to the Internet and/or various private and public networks. In some cases, the WAN 1060 may itself include the Internet, so that the enterprise network 1080 accesses the distributed plant 1098 over the Internet.

As described above, SCADA systems and distributed control systems use Programmable Logic Controllers (PLCs) as the control components of an overall hierarchical system. PLCs can provide local management of processes through feedback control, as described above. In a SCADA implementation, a PLC can provide the same functionality as a Remote Terminal Unit. When used in a distributed control system, PLCs can be implemented as local controllers within a supervisory scheme. PLCs can have user-programmable memory for storing instructions, where the instructions implement specific functions such as I/O control, logic, timing, counting, proportional-integral-derivative (PID) control, communication, arithmetic, and data and file processing.

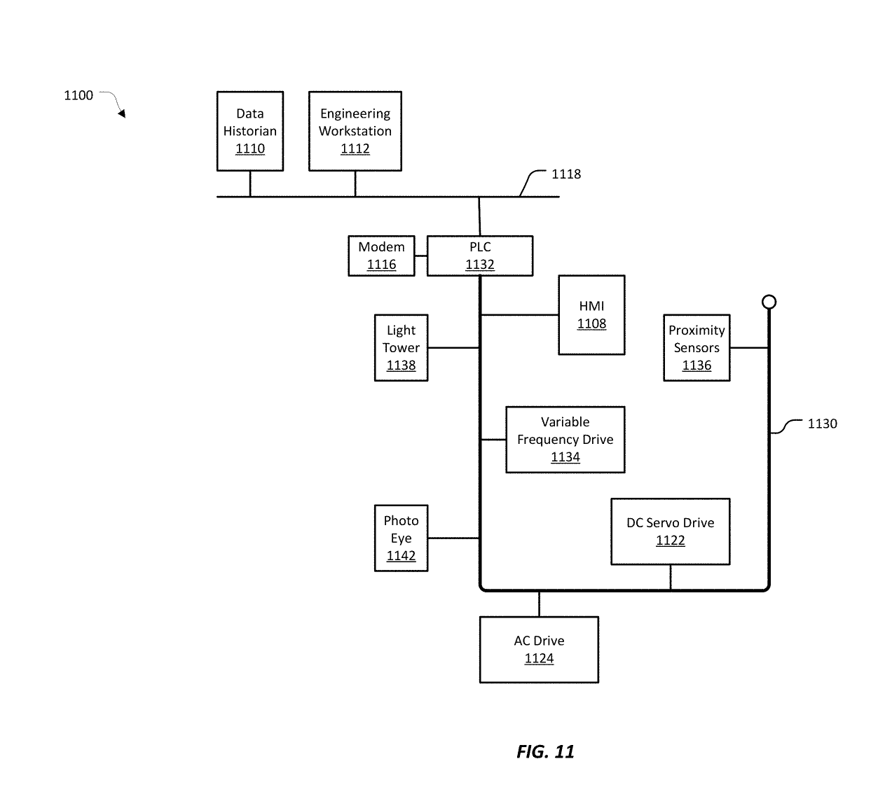

FIG. 11 illustrates an example of a PLC 1132 implemented in a manufacturing control process. The PLC 1132 in this example monitors and controls various devices over fieldbus network 1130. The PLC 1132 may be connected to a LAN 1118. An engineering workstation 1112 may also be connected to the LAN 1118, and may include a programming interface that provides access to the PLC 1132. A data historian 1110 on the LAN 1118 may store data produced by the PLC 1132.

The PLC 1132 in this example may control a number of devices attached to its fieldbus network 1130. These devices may include actuators, such as a DC servo drive 1122, an AC drive 1124, a variable frequency drive 1134, and/or a light tower 1138. The PLC 1132 may also monitor sensors connected to the fieldbus network 1130, such as proximity sensors 1136, and/or a photo eye 1142. A human-machine interface 1108 may also be connected to the fieldbus network 1130, and may provide local monitoring and control of the PLC 1132.

Most industrial control systems were developed years ago, long before public and private networks, desktop computing, or the Internet were a common part of business operations. These well-established industrial control systems were designed to meet performance, reliability, safety, and flexibility requirements. In most cases, they were physically isolated from outside networks and based on proprietary hardware, software, and communication protocols that included basic error detection and correction capabilities, but lacked secure communication capabilities. While there was concern for reliability, maintainability, and availability when addressing statistical performance and failure, the need for cyber security measures within these systems was not anticipated. At the time, security for industrial control systems mean physically securing access to the network and the consoles that controlled the systems.

Internet-based technologies have since become part of modern industrial control systems. Widely available, low-cost IP devices have replaced proprietary solutions, which increases the possibility of cyber security vulnerabilities and incidents. Industrial control systems have adopted Internet-based solutions to promote corporate connectivity and remote access capabilities, and are being designed and implemented using industry standard computers, operating systems (OS) and network protocols. As a result, these systems may to resemble computer networks. This integration supports new networking capabilities, but provides less isolation for industrial control systems from the outside world than predecessor systems. Networked industrial control systems may be exposed to similar threats as are seen in computer networks, and an increased likelihood that an industrial control system can be compromised.

Industrial control system vendors have begun to open up their proprietary protocols and publish their protocol specifications to enable third-party manufacturers to build compatible accessories. Organizations are also transitioning from proprietary systems to less expensive, standardized technologies such as Microsoft Windows and Unix-like operating systems as well as common networking protocols such as TCP/IP to reduce costs and improve performance. Another standard contributing to this evolution of open systems is Open Platform Communications (OPC), a protocol that enables interaction between control systems and PC-based application programs. The transition to using these open protocol standards provides economic and technical benefits, but also increases the susceptibility of industrial control systems to cyber incidents. These standardized protocols and technologies have commonly known vulnerabilities, which are susceptible to sophisticated and effective exploitation tools that are widely available and relatively easy to use.

Industrial control systems and corporate networking systems are often interconnected as a result of several changes in information management practices, operational, and business needs. The demand for remote access has encouraged many organizations to establish connections to the industrial control system that enable of industrial control systems engineers and support personnel to monitor and control the system from points outside the control network. Many organizations have also added connections between corporate networks and industrial control systems networks to allow the organization's decision makers to obtain access to critical data about the status of their operational systems and to send instructions for the manufacture or distribution of product.

In early implementations this might have been done with custom applications software or via an OPC server/gateway, but, in the past ten years this has been accomplished with TCP/IP networking and standardized IP applications like File Transfer Protocol (FTP) or Extensible Markup Language (XML) data exchanges. Often, these connections were implemented without a full understanding of the corresponding security risks. In addition, corporate networks are often connected to strategic partner networks and to the Internet. Control systems also make more use of WANs and the Internet to transmit data to their remote or local stations and individual devices. This integration of control system networks with public and corporate networks increases the accessibility of control system vulnerabilities. These vulnerabilities can expose all levels of the industrial control system network architecture to complexity-induced error, adversaries and a variety of cyber threats, including worms and other malware.

Many industrial control system vendors have delivered systems with dial-up modems that provide remote access to ease the burdens of maintenance for the technical field support personnel. Remote access can be accomplished, for example, using a telephone number, and sometimes an access control credential (e.g., valid ID, and/or a password). Remote access may provide support staff with administrative-level access to a system. Adversaries with war dialers—simple personal computer programs that dial consecutive phone numbers looking for modems—and password cracking software could gain access to systems through these remote access capabilities. Passwords used for remote access are often common to all implementations of a particular vendor's systems and may have not been changed by the end user. These types of connections can leave a system highly vulnerable because people entering systems through vendor-installed modems are may be granted high levels of system access.

Organizations often inadvertently leave access links such as dial-up modems open for remote diagnostics, maintenance, and monitoring. Also, control systems increasingly utilize wireless communications systems, which can be vulnerable. Access links not protected with authentication and/or encryption have the increased risk of adversaries using these unsecured connections to access remotely controlled systems. This could lead to an adversary compromising the integrity of the data in transit as well as the availability of the system, both of which can result in an impact to public and plant safety. Data encryption may be a solution, but may not be the appropriate solution in all cases.

Many of the interconnections between corporate networks and industrial control systems require the integration of systems with different communications standards. The result is often an infrastructure that is engineered to move data successfully between two unique systems. Because of the complexity of integrating disparate systems, control engineers often fail to address the added burden of accounting for security risks. Control engineers may have little training in security and often network security personnel are not involved in security design. As a result, access controls designed to protect control systems from unauthorized access through corporate networks may be minimal. Protocols, such as TCP/IP and others have characteristics that often go unchecked, and this may counter any security that can be done at the network or the application levels.

Public information regarding industrial control system design, maintenance, interconnection, and communication may be readily available over the Internet to support competition in product choices as well as to enable the use of open standards. Industrial control system vendors also sell toolkits to help develop software that implements the various standards used in industrial control system environments. There are also many former employees, vendors, contractors, and other end users of the same industrial control system equipment worldwide who have inside knowledge about the operation of control systems and processes.

Information and resources are available to potential adversaries and intruders of all calibers around the world. With the available information, it is quite possible for an individual with very little knowledge of control systems to gain unauthorized access to a control system with the use of automated attack and data mining tools and a factory-set default password. Many times, these default passwords are never changed.

### IV. NETWORK THREAT DETECTION

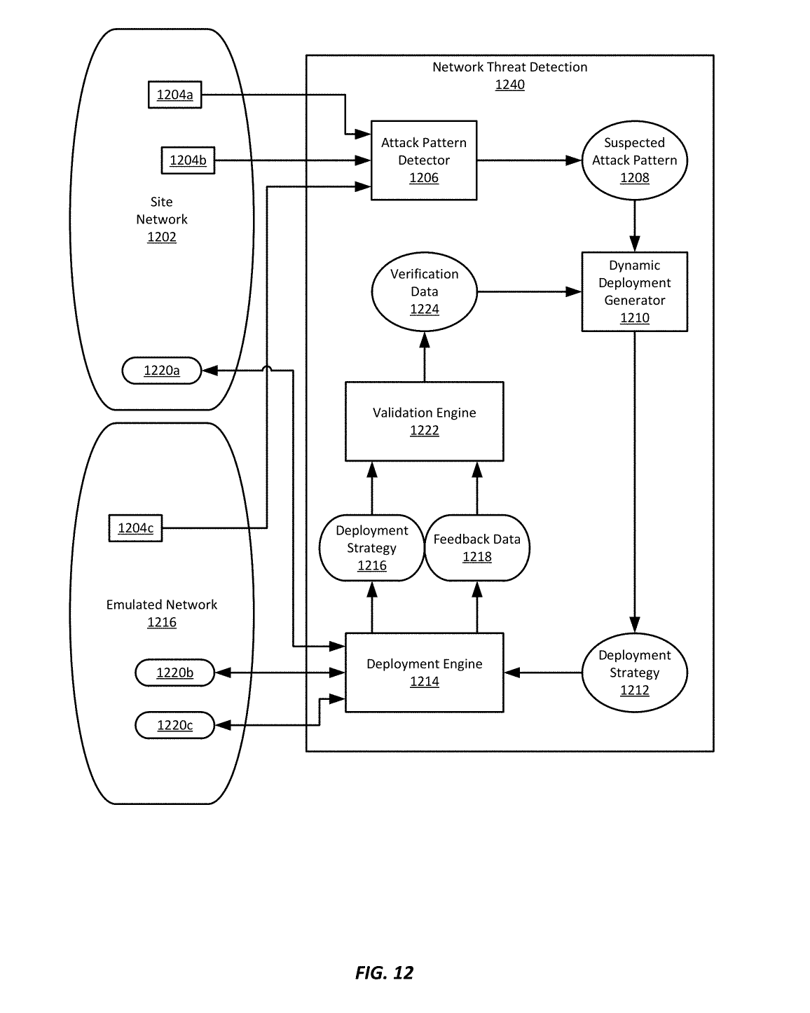

FIG. 12 illustrates an example of a network threat detection system 1240 that may be included in various implementations of a deception center. The threat detection system 1240 can use dynamic security mechanisms to locate, identify, and confirm a threat to a site network. The various components of the network threat detection system 1240 may be implemented as discreet hardware components, as software components executing on different computing systems, as software components executing on one computing system, or as a combination of hardware components and software components in one or multiple computing systems.

The threat detection system 1240 may be monitoring a site network 1202. The site network 1202 may include various interconnected network devices, including both computers and network infrastructure equipment, as well as home appliances and electronics, tools and manufacturing equipment, and other non-traditional network devices. An attack pattern detector 1206 may collect data 1204a-1204c from the site network 1202 and/or an emulated network 1216. This collected data 1204a-1204c may come from various sources, such as servers, computers devices, and network infrastructure devices in the site network 1202, and from previously-deployed deception mechanisms in the site network 1202 or in the emulated network 1216. The collected data 1204a-1204c may be structured or unstructured. The collected data 1204a-1204c may be continuously updated.

The attack pattern detector 1206 may monitor and/or analyze the collected data 1204a-1204c to determine whether a network abnormality has occurred or is occurring. In many cases, a network abnormality may fall within acceptable network usage. In other cases, the network abnormality may indicate a potential network threat. One example of a network abnormality is an access detected at a deception mechanism in the site network 1202. In some implementations, emulated network devices in the emulated network 1216 may be projected into the site network 1202 as deception mechanisms. Because the emulated network devices are not part of the normal business of the site network 1202, any access to them is automatically suspect. In various implementations, the attack pattern detector 1206 may identify or isolate the pattern of network behavior that describes the network abnormality. This pattern of behavior may be provided as a suspected attack pattern 1208 to a dynamic deployment generator 1210.

The dynamic deployment generator 1210 may analyze the suspected attack pattern 1208 and determine what should be done to confirm that an attack occurred or is in progress. The dynamic deployment generator 1210 may have access to various deceptive security mechanisms, which emulate devices that may be found in the site network 1202. The dynamic deployment generator 1210 may determine which of these security mechanisms are most likely to be attractive to the potential threat. The dynamic deployment generator 1210 may further determine how and where to use or deploy one or more security mechanisms. In some cases, the security mechanisms may be deployed into an emulated network 1216, while in other cases the security mechanisms may be deployed into the site network 1202. For example, when the suspected attack pattern 1208 indicates that a production server may have been accessed for illegitimate reasons, the dynamic deployment generator 1210 may initiate an emulated server in the emulated network 1216 that appears to be particularly vulnerable and/or to have valuable data. The emulated server may further be projected into the site network 1202 to attract the attention of the possible attacker. As another example, when the suspected attack pattern 1208 indicates that a deception mechanism has been logged into, the dynamic deployment generator 1210 may initiate emulated network devices in the emulated network 1216 that mimic production servers in the site network 1202. In this example, should the user who logged into the deception mechanism attempt to log into a production server, the user may instead be logged into an emulated version of the production server. In this example, the user's activity may be contained to the emulated network 1216.

In some implementations, the dynamic deployment generator 1210 may contact an external service, possibly located in on the Internet, for assistance in determining which security mechanisms to deploy and where to deploy them. For example, the dynamic deployment generator 1210 may contact an external security services provider. The dynamic deployment generator 1210 may produce a deployment strategy 1212 that includes one or more security mechanisms to deploy, as well as how and where those security mechanisms should be deployed.

The deployment strategy 1212 may be provided to a deployment engine 1214. The deployment engine may deploy security mechanisms 1220a-1220c into an emulated network 1216 and/or into the site into the site network 1202. In various implementations, the emulated network 1216 may emulate one or more network devices, possibly configured to resemble a real configuration of inter-connected routers and/or switches and network devices in a subnetwork. The emulated network devices may be, for example, address deception mechanisms, low-interaction deception mechanisms, and/or high-interaction deception mechanisms. In various implementations, the security mechanisms 1220b-1220c deployed into the emulated network 1216 can be projected into the site network 1202. In these implementations, the security mechanisms 1220b-1220c may function as actual nodes in the site network 1202. In various implementations, the emulated network 1216 may be hosted by a network emulator.

In various implementations, the deployment strategy 1212 may indicate where in network topology of the emulated network 1216 and/or the site network 1202 the security mechanisms 1220a-1220c are to be deployed. For example the deployment strategy 1212 may indicate that a certain number of security mechanisms 1220b-1220c should be deployed into the subnetwork where an attack appears to be occurring. These security mechanisms 1220b-1220c may be deployed into the emulated network 1216, from which they may be projected into the site network 1202 Alternatively or additionally, the deployment strategy 1212 may call for placing a security mechanisms 1220a at a node in the site network 1202 where it are most likely to attract the attention of the potential threat. Once deployed, the security mechanisms 1220a-1220c may begin collecting data about activity related to them. For example, the security mechanisms 1220a-1220c may record each time that they are accessed, what was accessed, and, with sufficient information, who accessed them. The security mechanisms 1220a-1220c may provide this data to the deployment engine 1214.

In various implementations, the deployment strategy 1212 may alternatively or additionally indicate that one or more deceptions should be escalated. For example, the suspected attack pattern 1208 may indicate that a MAC or IP address for an address deception was scanned, and the deployment strategy 1212 may then indicate that the address deception should be escalated to a low-interaction deception. As another example, the suspected attack pattern 1208 may indicate that a connection attempt to a low-interaction deception was seen, and the deployment strategy 1212 may then indicate that the low-interaction deception should be escalated to a high-interaction deception.

The deployment engine 1214 may provide a deployment strategy 1212 and feedback data 1218 from the security mechanisms 1220a-1220c to a validation engine 1222. The validation engine 1222 may analyze the deployment strategy 1216 and the feedback data 1218 from the security mechanisms 1220a-1220c to determine whether an actual attack has occurred or is in progress. In some cases, the network abnormality that triggered the deployment of the security mechanisms may be legitimate activity. For example, a network bot (e.g., an automated system) may be executing a routine walk of the network. In this example, the network bot may be accessing each IP address available in the site network 1202, and thus may also access a security mechanism deployed to resemble a network device that is using a specific IP address. In other cases, however, a network abnormality may be a port scanner that is attempting to collect IP addresses for illegitimate purposes. The validation engine 1222 may use the feedback data 1218 to confirm that the activity is malicious. The validation engine 1222 may provide verification data 1224. The verification data 1224 may, in some cases, confirm that an attack has occurred or is occurring. In other cases, the verification data 1224 may indicate that no attack has happened, or that more information is needed.

The verification data 1224 may be provided to the dynamic deployment generator 1210. The dynamic deployment generator 1210 may use the verification data 1224 to dynamically adjust the deployment strategy 1212. These adjustments may be directed towards establishing more attractive traps for the potential threat, and/or towards obtaining more information about the potential threat. For example, the dynamic deployment generator 1210 may call for dynamically adjusting or changing the nature of an already deployed security mechanism 1220a-1220c. Alternatively or additionally, the dynamic deployment generator 1210 may determine that a security mechanism 1220a-1220c can be disabled or removed from the site network 1202. Alternatively or additionally, the dynamic deployment generator 1210 may cause different security mechanisms to be deployed. These changes may be reflected in the deployment strategy 1212, and may be implemented by the deployment engine 1214.

In some implementations, the adjustments to the deployment strategy 1212 may be directed towards containing an apparent threat within the emulated network 1216. For example, the verification data 1224 may indicate that an unexpected access has occurred at a security mechanism 1220a deployed into the site network 1202. Using this information, the deployment strategy 1212 may include deploying security mechanisms 1220b-1220c into the emulated network 1216 that mimic production systems in the site network 1202. Should an apparent attacker attempt a lateral movement from the deception mechanism 1220a where he was detected to a production system, the apparent attacker may instead be logged into a security mechanism 1220b-1220c that mimics that production server. The apparent attacker may not be aware that his activity has been contained to the emulated network 1216. Using this deployment strategy 1212, the apparent attacker may be kept away from production systems.

The threat detection system 1240 may, using the components and data described above, determine that a network abnormality is an acceptable and legitimate use of the site network 1202, or that the network abnormality is an actual threat to the site network 1202. In some implementations, the threat detection system 1240 may also be able to take action to stop a perceived threat.

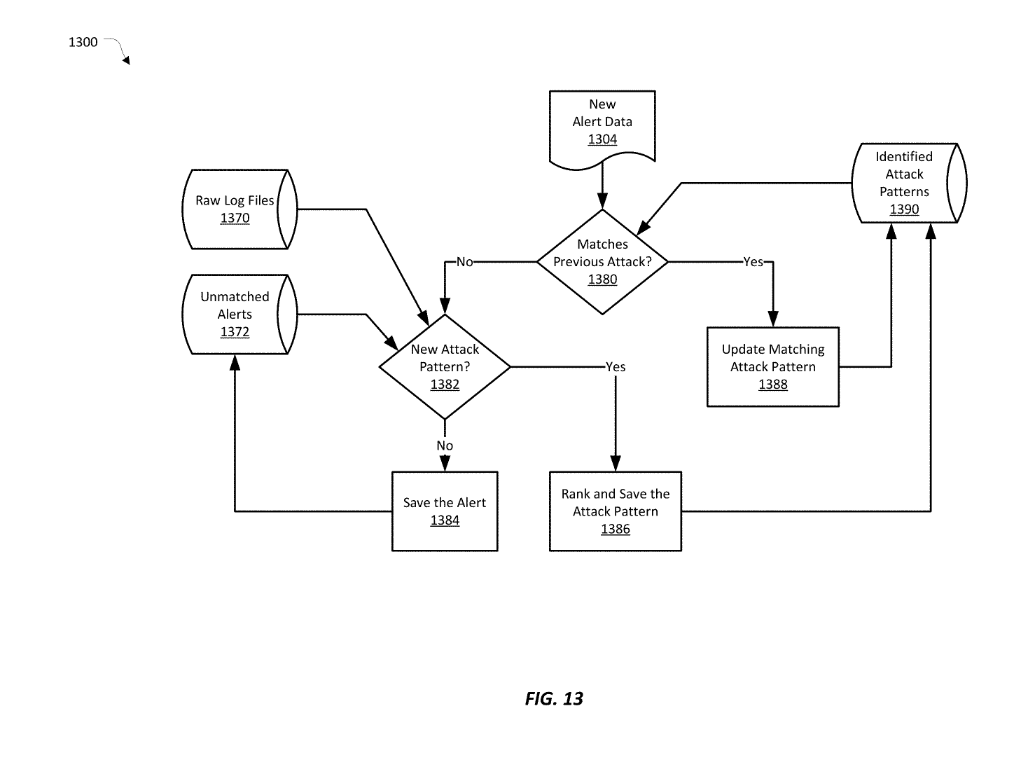

FIG. 13 illustrates an example of a process 1306 that may be implemented by an attack pattern detector to identify a pattern of behavior as a possible threat. The process 1306 may be implemented in hardware, software, or a combination of hardware and software. The attack pattern detector may include one or more integrated memory systems for storing data, or may be connected to external memory systems.

The process 1306 may receive new alert data 1304. The new alert data 1304 may include information about a network abnormality that may be a threat to the network. The new alert data 1304 may include information such as a possible identity of the source of the threat, what the nature of the threat appears to be, when the threat began or occurred, and/or where the threat occurred in the site network.

The new alert data 1304 may be examined, at step 1380, to determine whether the information provided by the new alert data 1304 matches a pervious attack. The new alert data 1304 may match a previous attack when the pattern of behavior indicated by the new alert data 1304 matches a pattern of behavior that is known to be a network threat. Previously identified attack patterns 1390 may be provided at step 1380 to make this determination. Alternatively or additionally, the new alert data 1304 may be related to a previously identified attack pattern 1390, and/or may describe behavior that is an extension of a known attack pattern.

When the new alert data 1304 matches an identified attack pattern 1390, and/or is related to an identified attack pattern, at step 1388, the matching attack pattern may be updated. Updating the matching attack pattern may include, for example, changing a ranking of the attack pattern. A ranking may indicate the seriousness of the attack pattern. For example, a more serious attack pattern may be more likely to be a real attack, and/or a higher ranking may indicate a greater need to address the attack. Alternatively or additionally, updating the matching attack pattern may include adding a location where the pattern of behavior was seen. Alternatively or additionally, updating the matching attack pattern may include, for example, describing variations on the attack pattern, alterations to the attack pattern, additional sources of this type of pattern, and so on.

When the new alert data 1304, at step 1380, does not match an identified attack pattern 1390, the process 1306 next attempts, at step 1382, to determine whether the new alert data 1304 describes a pattern of behavior that may be a new and previously unidentified threat to the network. To make this determination, various data may be provided at step 1382, such as, for example, raw log files 1370 and previously unmatched alerts 1372. Raw log files 1370 may provide additional information about the new alert data 1304 that can be used by the process 1306 to further determine whether an attack may be occurring. The previously unmatched alerts 1372 may be patterns of behavior that has previously been determined to not be an attack. The new alert data 1304 may be matched against these previously unmatched alerts 1372 to determine that the new alert data 1304 describes behavior already determined to not be an attack. Alternatively, the new alert data 1304 may indicate that a previous unmatched alert 1372 may, in fact, describe an actual attack.

Using the raw log files 1370, unmatched alerts 1372, and possibly other data, the process 1306 examine, for example, the seriousness of the behavior described by the new alert data 1304, the nature of the behavior, the source of the behavior, and so on. When it is determined, at step 1382, that the new alert data 1304 does not indicate a new attack pattern, the new alert data may be saved, at step 1384, with previously unmatched alerts 1372. When it is determined that the new alert data 1304 does, in fact, describe a new attack pattern, the new alert data may be saved, at step 1386, along with previously identified attack patterns 1390. In some cases, at step 1386, additional information may be stored with the new attack pattern data. For example, the new attack pattern may be given a rank, indicating the degree of seriousness, level of threat, and/or degree of immediacy.

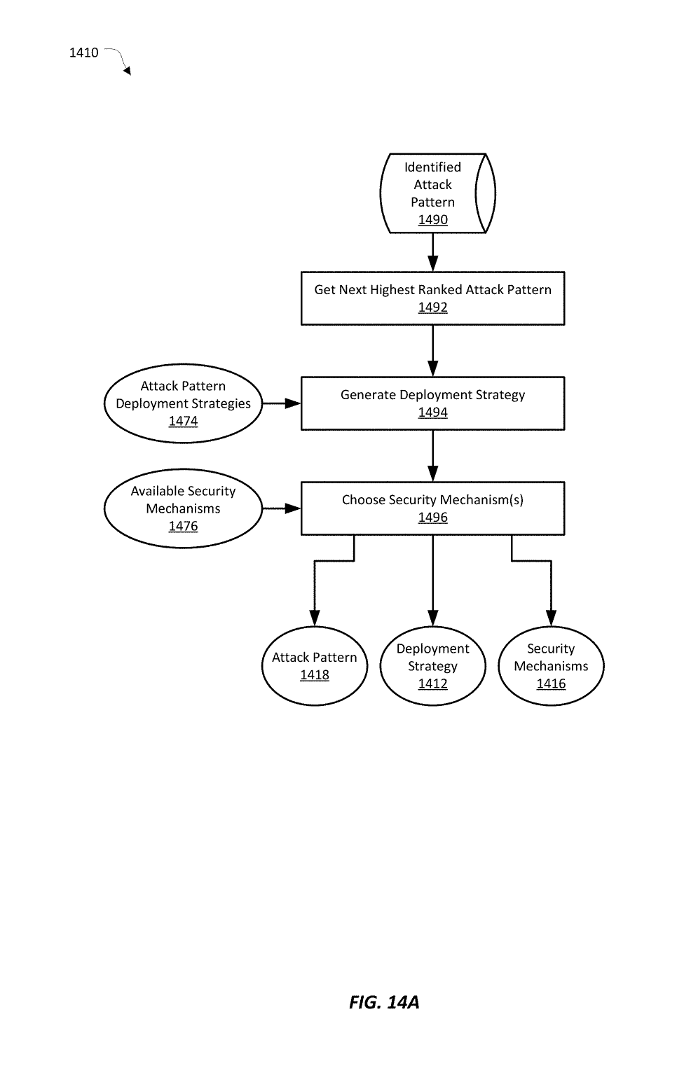

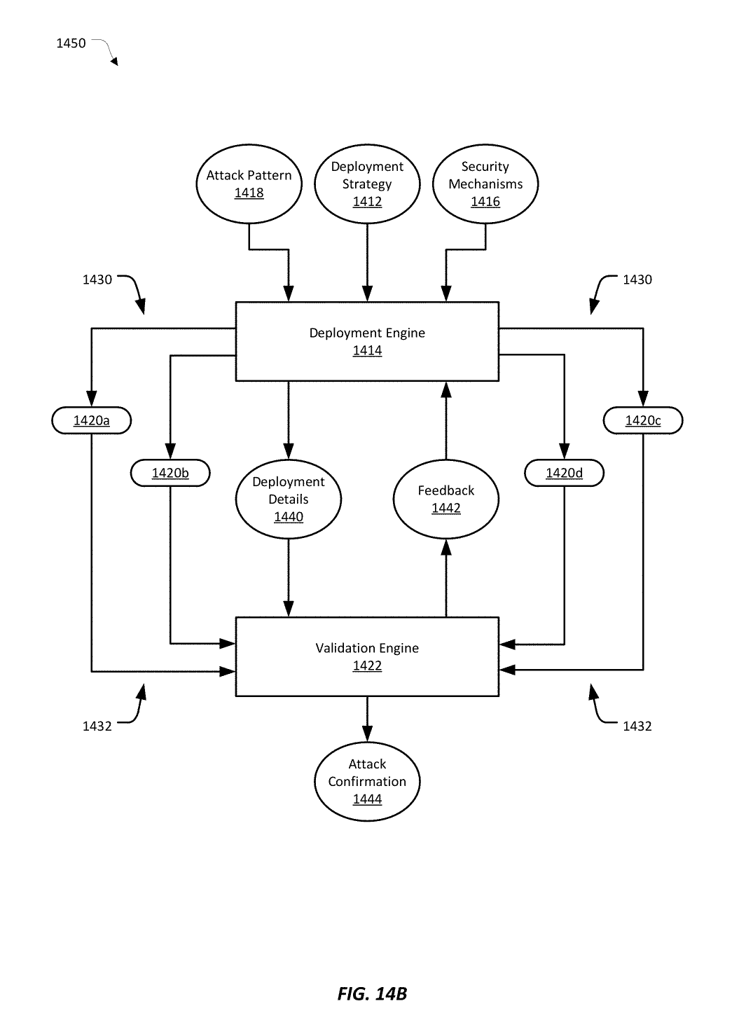

The process 1306 of FIG. 13 may identify a pattern of behavior that could be a threat to the network. The pattern, however, may only be a potential threat. FIG. 14A-14B illustrate an example of two stages of a process 1410, 1450 for confirming that the pattern of behavior is an actual threat. The process 1410 may be a first stage in an overall process for confirming a pattern as a threat, while the process 1450 may be a second stage. The process 1410 of FIG. 14A may be executed, for example, by a dynamic deployment generator. The process 1410 may be implemented in hardware, software, or a combination of hardware and software.

An identified attack pattern 1490 may be provided to the process 1410. The identified attack pattern 1490 may be produced, for example, by the process 1300 of FIG. 13. Additionally, in some cases, the process 1300 may identify multiple attack patterns simultaneously or successively, all of which may be provided to the process 1410 of FIG. 14A, or some of which may be provided while the rest are set aside for later processing. The process 1410 may, at step 1492, get the next highest ranked attack pattern. The ranking may indicate a seriousness, importance, urgency, or otherwise indicate an order in which the attack patterns should be addressed.

For the next highest ranked attack pattern, at step 1494, the process 1410 generates a dynamic deployment strategy. Pre-defined attack pattern deployment strategies 1474 may be provided at step 1494. The pre-defined attack pattern deployment strategies may include strategies that were effective against the same or similar attack patterns, or that were designed with certain attack patterns in mind. Alternatively or additionally, the process 1410 may, at step 1494 dynamically generate a deployment strategy based on prior attack pattern deployment strategies 1474, and/or the behavior described by the attack pattern. The process 1410 may not produce a deployment strategy exactly tailored for the attack pattern, and may instead produce a deployment strategy that is expected to be effective. Additionally, the process 1410 may produce more than one deployment strategy. Each of these deployment strategies may be ranked in various ways, such as their likelihood to be most attractive to the attack pattern, their impact on the network, how quickly they can be deployed, or resources required for their deployment. Each deployment strategy may be tried sequentially, or several deployment strategies, may be tried at the same time.

One example of a deployment strategy is a strategy for a port scanner attack. When the identified attack pattern 1490 indicates port scanning of a server, a deployment strategy may call for deploying one or more security mechanisms that emulate services provided by the server. One or more corresponding ports on the server may then be opened. A true port scanner attack may then attempt to access the emulated services through an open port. Alternatively or additionally, security mechanisms may be deployed outside of the server. These security mechanisms may also emulate services provided by the server, and attract the attention of the port scanner without the port scanner being able to enter the server.

Another example of a deployment strategy is a strategy for a network scanner attack. In this example, when the identified attack pattern 1490 indicates scanning of, for example, a subnet, a deployment strategy may call for deploying one or more emulated servers into the subnet. These emulated servers may resemble production servers in the subnet, and so may provide the same ports and servers as the production servers. The emulated servers, however, will monitor for network scanning activity.

Another example of a deployment strategy is a strategy for a database attack. When the attack pattern 1490 indicates unauthorized querying or copying of a database, the deployment strategy may include security mechanisms that mimic parts of the database, such as additional views or tables with artificial or artificially tainted data. The security mechanisms may report being accessed or copied, either of which indicates an attack on the database.

At step 1496, the process 1410 may select one or more security mechanisms from available security mechanisms 1476 that are called for by the deployment strategy or strategies generated at step 1496. Additionally or alternatively, at step 1496 the process 1410 may dynamically generate a security mechanism, and/or modify a security mechanism from among the available security mechanisms 1416.

The process 1410 may produce an attack pattern 1418, one or more deployment strategies 1412, and one or more security mechanisms 1416. The attack pattern 1418 may be the attack pattern that was selected at step 1492, and that is being confirmed as an actual threat. The deployment strategy or strategies 1412 may be one or more deployment strategies generated at step 1494. The security mechanisms 1416 may be the security mechanisms chosen at step 1496.

The outputs of the process 1410 may be provided to a second stage for confirming that a pattern of behavior is an actual threat. FIG. 14B illustrates an example of a process 1450 that may be used for the second stage. The process 1450 may be implemented in hardware, software, or a combination of hardware and software.

The process 1450 may receive an attack pattern 1418, one or more deployment strategies 1412, and one or more security mechanisms 1416. The attack pattern 1418, deployment strategies 1412, and security mechanisms 1416 may be provided by a first stage of the process to confirm an attack pattern as an actual threat, such as the process 1410 illustrated in FIG. 14A. In FIG. 14B, the attack pattern 1418 describes a pattern of behavior that is being verified to determine whether it is an actual attack. The deployment strategies 1412 describe one or more plans for verifying that the pattern is a threat, including a selection of one or more dynamic security mechanisms and a plan for where in the network to deploy them. The security mechanisms 1416 may be the processes and/or data that are to be deployed.

A deployment engine 1414 may receive the attack pattern 1418, deployment strategies 1412, and security mechanisms 1416, and may deploy 1430 one or more security mechanisms 1416, using one or more of the deployment strategies 1412. As noted above, the deployment engine 1414 may try different deployment strategies sequentially, or may try several deployment strategies concurrently. The deployment engine 1414 may also be configured to dynamically react to changing conditions in the network. For example, the attack pattern 1418 may describe a user whose credentials are suspect. In this example, the deployment engine 1414 may automatically deploy security mechanisms 1416 when the suspect user logs in. Furthermore, the deployment engine 1414 may also be configured to remove the security mechanisms 1416 when the user logs out. As another example, the deployment engine 1414 may launch additional security mechanisms configured to contain the suspect user within an emulated network. The deployment engine 1414 may provide deployment details 1440 to a validation engine 1422, where the deployment details 1440 may include, for example, the attack pattern 1418 and the deployment strategy 1412.

In some implementations, the validation engine 1422 may attempt to determine whether the attack pattern 1418 is, in fact, a real attack. Deployed security mechanisms 1420a-1420d may provide data 1432 about activity around them or related to them to the validation engine 1422. This data 1432 may indicate, for example, no activity, suspect activity, or confirmed activity. In some cases, the data 1432 may indicate that the deployment strategy may be more effective if adjusted. The validation engine 1422 may provide this feedback 1442 to the deployment engine. The deployment engine 1414 may take actions such as a real-time, dynamic modification of a deployed security mechanism 1420a-1420d, removing a deployed security mechanism 1420a-1420d, and/or deploying different security mechanisms.

In some cases, data from deployed security mechanisms 1420a-1420d may also be provided to one or more other systems. These other systems may be able to provide additional information about the attack pattern 1418. In some cases, these other systems may be able to address the threat, for example by blocking access to the network, revoking authentication, or terminating processes.

Ultimately, the validation engine 1422 may provide an attack confirmation 1444. An attack confirmation 1444 may confirm that the attack pattern 1418 is an actual attack. An attack confirmation 1444 may be brought to the attention of a human network administrator. Alternatively or additionally, an attack confirmation 1444 may be sent to network security systems that may be able to address the threat. In some cases, the validation engine 1422 may instead determine that the attack pattern 1418 was not an actual attack. Yet, in other cases, the validation engine 1422 may not come to a conclusion, in which case the attack pattern 1418 may be marked for continuing observation.

In some implementations, the network security system described above may also be configured to react to an attack confirmation 1444 by attempting corrective action against the attack. For example, the system may block the IP address that appears to be the source of the attack, or attempt to trace the attack to the source. Alternatively or additionally, the system may provide tainted data to the attacker, thereby possibly disabling the attacker's own system. Alternatively or additionally, the system may provide traceable data to the attacker. Traceable data may enable the system or others to track the attacker's movements in the network. In some implementations, tracking data may provide up-to-date information that may be used to dynamically change or modify an existing deployment strategy, or to deploy a new deployment strategy. Alternatively or additionally, the system may make information about the attacker public, such as for example in the anti-virus community, on anti-hacker forums, or through mass media outlets.

### V. DETECTING SECURITY THREATS USING DECEPTION SYSTEMS AND DATA SCIENCE

In various implementations, the systems and methods discussed above can be used to implement a dynamic network threat detection system. Generally, deception-based security mechanisms, such as honeypots, honey tokens, honey nets, and others, are statically or predictably configured, and are statically placed into a network. As a result, deception-based security mechanisms can be easy to locate and avoid. Thus, in various implementations, a network threat detection system can use deception-based security mechanisms in a targeted and dynamic fashion. By reacting to data received from a network, or by predicting possible future network behavior, the network threat detection system can modify, add, or remove deception mechanisms to attract or divert threats to a network. The deception mechanisms can further be used to confirm a potential threat as an actual threat. In various implementations, the deception mechanisms can also be used to analyze a threat, and produce indicators that describe and/or identify the threat. These indicators can then be used to improve the security of a network.

In various implementations, a network threat detection system can also use data science techniques to analyze network data. Examples of data science techniques include clustering network systems with similar features, statistical analysis that relates network activity to known attack patterns, scoring models that indicate a probability of a threat affecting particular parts of a network, predictive analysis that determines probable future network behavior, and correlation of an attack pattern to known attack patterns. Other data science techniques include data mining, machine learning, and game theory.

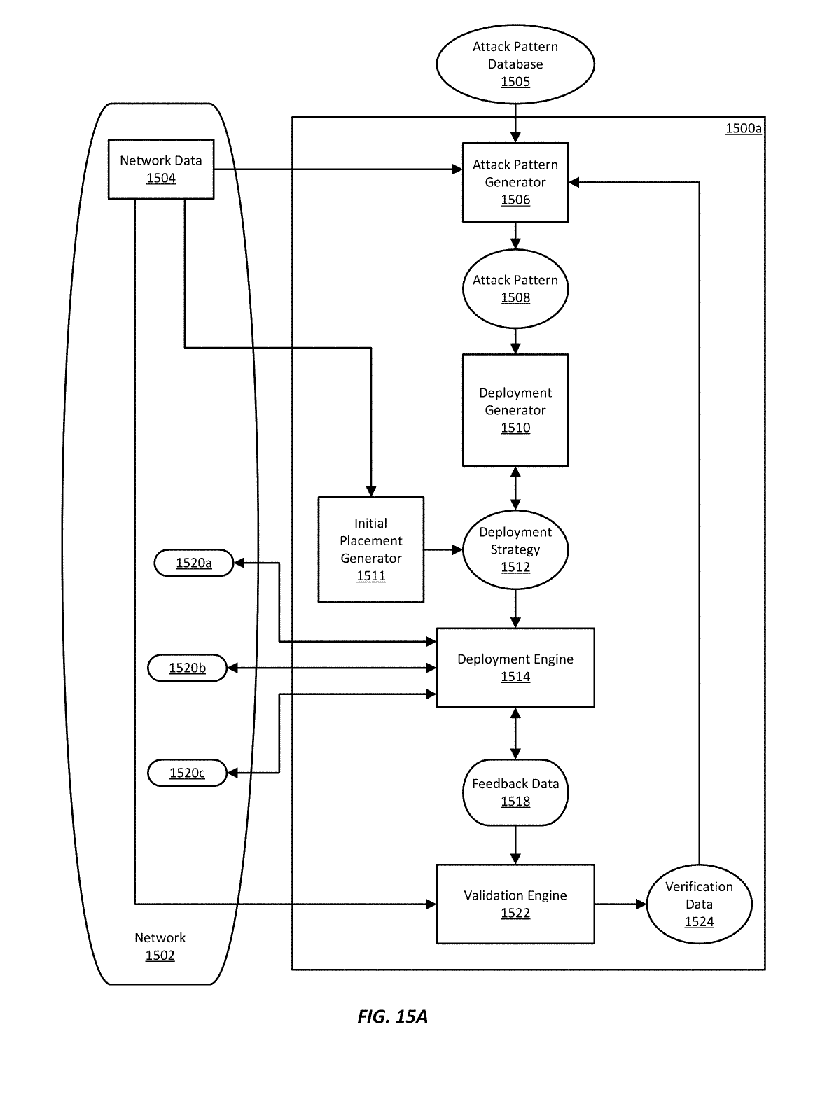

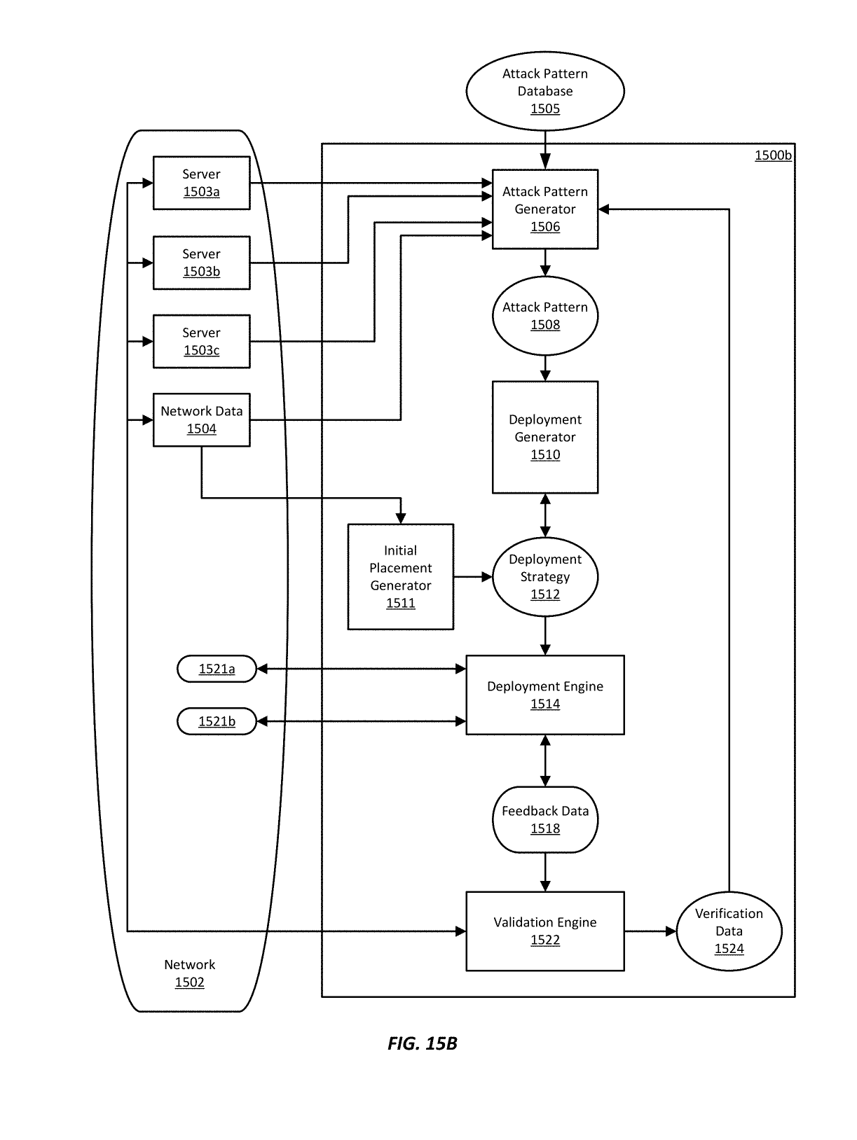

FIGS. 15A-15B illustrate examples of network threat detection systems 1500a, 1500b that use static and/or dynamic security mechanisms to locate, identify, and confirm a threat to a network 1502. The various components of the threat detection systems 1500a, 1500b may be implemented as discreet hardware components, as software components executing on different computing systems, as software components executing on one computing system, or as a combination of hardware components and software components in one or multiple computing systems. The threat detection systems 1500a, 1500b can be implemented to monitor an enterprise network, a cloud network, or a hybrid network that includes local network resources and network resources in the cloud.

The threat detection system 1500a of FIG. 15A may be monitoring a network 1502, which can be a customer network. The threat detection system 1500a can include an initial placement generator 1511 and an attack pattern generator 1506, which can collect network data 1504 from the network 1502. As discussed further below, this network data 1504 may come from various sources in the network 1502, such as production servers, virtual machines, and network infrastructure devices. These devices can provide log files, network packets, email, files, links, and other information. Additional network data 1504 can be provided by network security systems, such as perimeter defense systems, deception-based systems, intrusion detection systems, data science systems, and SIEM systems.

In various implementations, the network data 1504 may be structured or unstructured. Unstructured data is information that does not adhere to a pre-defined data model, or is not organized in a pre-defined manner. Unstructured data files often include text and/or multimedia content. Examples of unstructured data files include email messages, word processing documents, videos, photos, audio files, presentations, webpages, and other kinds of business documents. Though these files may have an internal structure, the data that they contain is considered “unstructured” because the data is not in an easily indexable format. In contrast, structured data generally resides in a readily indexable structure, such as a relational data base or a table. In various implementations, the network data 1504 may be stored locally to the threat detection system 1500a, for example in local storage drives. Alternatively or additionally, the network data 1504 can be stored remotely, for example in remote storage drives, or in a cloud storage system.

The network data 1504 can include information about network devices in the network. For example, the network data 1504 can include the number of network devices in the network 1502, the type of each device in the network 1502 (e.g., a desktop computer, a laptop computer, a tablet computer, a file server, a compute server, a router, a switch, etc.), identification information for a network device (e.g., an IP address, a MAC address, a manufacturer's identifier, a network name, etc.), a hardware configuration for the network device (e.g., a CPU type, a memory size, a hard drive size, the number and type of peripheral devices, a number of network ports, etc.), or a software configuration (e.g., an operating system type and/or version, installed applications, enabled services or ports, etc.), among other information about network devices.

In various implementations, the network data 1504 can include information about data included in the network 1502. For example, the network data 1504 can include types of various data (e.g., user data, customer data, human resources data, financial data, database data—etc.), locations in the network of data (e.g., file systems, databases, storage arrays, etc.), access privileges for data (e.g., who can read, write, and/or modify the data), or a value of the data (e.g., a monetary value, a privacy value, a secrecy value, or a combination of values), among others.

In various implementations, the network data 1504 can include information about a structure of the network. For example, the network data 1504 can include the location of network infrastructure devices (e.g., routers, switches, hubs, gateways, firewalls, etc.), the configuration of subnets within the network (e.g., the subnet address of a subnet, the relationship between one subnet and another, etc.), or the configuration of one or more VLANs in the network (e.g., what parts of the network are associated with each VLAN, which VLANs are on the same trunk, the addresses of each VLAN, etc.), among information about the structure of the network.

In various implementations, the network data 1504 can include network security information. For example, the network data 1504 can include information provided by network firewalls, anti-virus tools, IDS and IPS systems, and SIEM systems, among others. The information provided by these network security systems can include alerts, which may or may not reflect an actual threat to the network.

Using the network data 1504, the initial placement generator 1511 can make an initial selection and placement of security mechanisms in the network. The selection and placement, at this stage, is based primarily on the network data 1504, while later deployment of security mechanisms may be based on network data 1504 and data received from previously deployed security mechanisms.

In various implementations, the initial placement generator 1511 selects and configures security mechanisms that are appropriate for the particular network 1502. For example, the security mechanisms can be made to resemble the computing devices commonly found in the network 1502, including for example the type of a computing device (e.g., personal computers or rack-mounted server computers), the manufacturer of the computing device, the operating system run by the computing device, and/or the services available on the computing device.

In various implementations, the initial placement generator 1511 determines locations for the security mechanisms based on the configuration and use of the network 1502, as indicated by the network data 1504. In various implementations, the initial placement generator 1511 may distribute security mechanisms across the network 1502, and/or may concentrate security mechanisms in key points in the network 1502. For example, the initial placement generator 1511 can place security mechanisms at gateways or other entry points to the network 1504. Alternatively or additionally, the initial placement generator 1511 can place security mechanisms at common vulnerability points, such as where users can be found.

In various implementations, the initial placement generator 1511 may use a variety of data science techniques to generate a deployment strategy 1512. For example, the initial placement generator 1511 may build and implement a scoring model. In this example, the initial placement generator 1511 may take various network data 1504 as input, including network traffic patterns (e.g., a density of the network traffic, whether any of the network traffic is or is not encrypted, source and destination addresses, etc.), the value of assets such as hardware resources, data, and so on in in the network, previous attack patterns, and current alerts from network security devices, among others. A scoring model can be built based on some or all of these inputs. For example, a high score can be assigned to particularly valuable or vulnerable assets, and a low score can be assigned to less valuable or vulnerable assets. In various implementations, the model can be used to determine the number, position, and configuration of security mechanisms to deploy. The scoring model may be revised periodically based on new or modified inputs and the effectiveness of the previous deployment strategy 1512.

As another example, the initial placement generator 1511 may build and implement a probabilistic model. In this example, the initial placement generator 1511 may build correlation statistics, for example, between traffic patterns, asset types (and numbers), and the previous attack patterns, either in the same network 1502 or from threat intelligence gathered from the greater network security community. For example, when threat intelligence indicates malware has been released that exploits a particular operating system vulnerability, the initial placement generator 1511 can determine a correlation between the manner and methods of the malware and the systems and assets in the network 1502. The correlation can indicate a likelihood that the network 1502 can be affect by the threat, and possibly also which systems can be affected. For example, correlation statistics may to determine the probability of an attack in different subnets, the type of target that may be affected, and a pattern that may be followed by the threat. These probabilities may be used to determine the placement of the static security mechanisms.

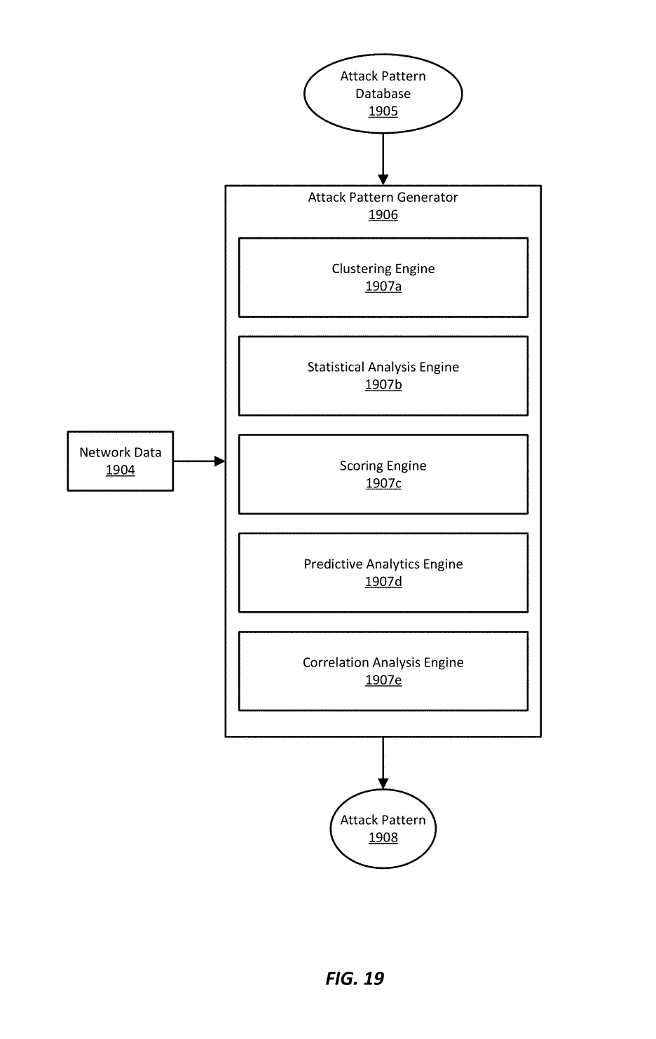

The attack pattern generator 1506 may monitor and/or analyze the network data 1504 in conjunction with previous attack pattern data in a database 1505 of known attack patterns. In various implementations, the attack pattern generator can use this information to determine whether a network abnormality has occurred or is occurring. In various implementations, the attack pattern generator 1506 can use data science techniques to analyze the network data 1504, as described further with respect to FIG. 19. In FIG. 15A, an identified network abnormality may fall within acceptable network usage, or may indicate a potential network threat. In these cases, the attack pattern generator 1506 may identify or isolate the pattern of network behavior that describes the network abnormality. This pattern of behavior may be provided as a suspected attack pattern 1508 to a deployment generator 1510.

The deployment generator 1510 may analyze the suspected attack pattern 1508. For example, the deployment generator 1510 may use the suspected attack pattern 1508 to identify within the network data 1504 all identifiable movements and interactions of an attack with the network 1502. The deployment generator 1510 may further determine what should be done to confirm that an attack occurred or is in progress. The deployment generator 1510 may have access to various security mechanisms, such as are described in further detail below. The deployment generator 1510 may determine which of the security mechanisms are most likely to be attractive to potential threats. The deployment generator 1510 may further determine how and where in the network 1502 to use or deploy one or more security mechanisms. The deployment generator 1510 may produce one or more deployment strategies 1512 that each include one or more security mechanisms to deploy, as well as how and where in the network 1502 those security mechanisms should be deployed.

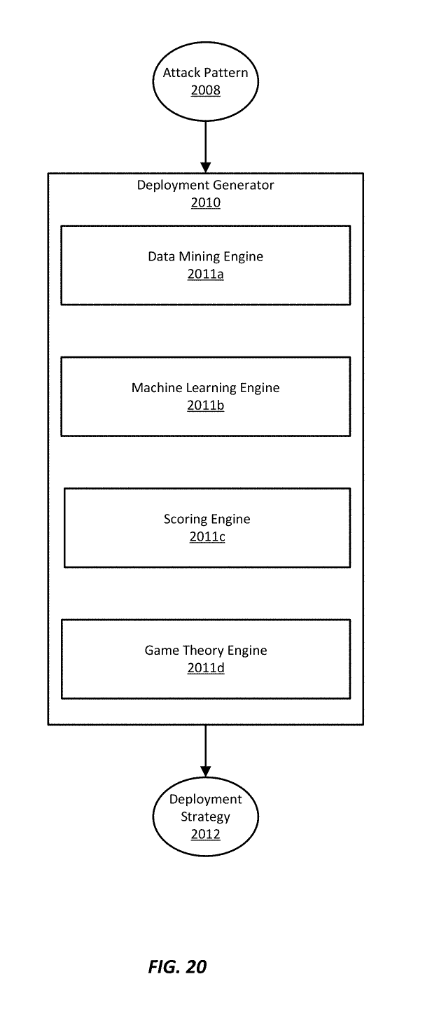

In various implementations, the deployment generator 1510 may employ one or more of a variety of data science techniques to analyze the attack pattern 1508 and adjust the deployment strategy 1512, as described further herein with respect to FIG. 20. In FIG. 15A, these adjustments may be directed towards establishing more attractive traps for the particular potential threat, and/or towards obtaining more information about the particular potential threat. For example, the deployment generator 1510 may call for dynamically adjusting or changing the nature of a previously deployed security mechanism 1520a-1520c. Alternatively or additionally, the deployment generator 1510 may determine that a security mechanism 1520a-1520c can be disabled or removed from the network 1502. Alternatively or additionally, the deployment generator 1510 may cause different security mechanisms to be deployed. Alternatively or additionally, the deployment generator 1510 may change the deployment locations of the security mechanisms. These changes may be reflected in the deployment strategy 1512, and may be implemented by the deployment engine 1514.

The deployment strategy 1512 may be provided to a deployment engine 1514. The deployment engine may deploy one or more security mechanisms 1520a-1520c into the network 1502 in accordance with the deployment strategy 1512. The deployment strategy 1512 may call for placing the security mechanisms 1520a-1520c at locations in the network 1502 where the security mechanisms 1520a-1520c are most likely to attract the attention of potential threats. For example, the security mechanisms 1520a-1520c could be placed in high traffic areas of the network 1502, or portions of the network 1502 having high value or sensitive assets, as indicated by network data 1504.

Once placed in the network 1502, the security mechanisms 1520a-1520c may begin collecting data about activity or interactions related to them. For example, the security mechanisms 1520a-1520c may record each time that they are accessed, what was accessed, and, with sufficient information, who accessed them (i.e., the source of the access or interaction). The security mechanisms 1520a-1520c may provide this data to the deployment engine 1514.

The deployment engine 1514 may provide feedback data 1518 from the security mechanisms 1520a-1520c to a validation engine 1522. Feedback data 1518 represents the data about interactions related to the security mechanisms 1520a-1520c. The validation engine 1522 may analyze the feedback data 1518 from the security mechanisms 1520a-1520c in conjunction with the network data 1504 to identify network abnormalities and to determine whether any actual attacks have occurred or are in progress. In some cases, network abnormalities on the network 1502 may be legitimate activity. For example, a network bot (e.g., an automated system) may be executing a routine walk of the network. In this example, the network bot may be accessing each Internet Protocol (IP) address available, and thus may also access a security mechanism deployed to resemble a network device using a specific IP address. In other cases, however, a network abnormality may be a port scanner that is attempting to collect IP addresses for illegitimate purposes. The validation engine 1522 may use the feedback data 1518 in conjunction with the network data 1504 to confirm that the activity is malicious. The validation engine 1522 may provide verification data 1524, which may include confirmed attacks in some embodiments. Thus, the verification data 1524 may, in some cases, confirm that an attack has occurred or is occurring, and may include some or all of feedback data 1518. In other cases, the verification data 1524 may indicate that no attack has happened, or that more information is needed.

The validation engine 1522 may use one or a variety of data science techniques to analyze network data 1504 and data received from the deployed security mechanisms 1520a-1520c. For example, the validation engine 1522 may implement statistical analysis with pattern matching to generate an attack signature if one or more interactions are part of a new confirmed threat, or may use an existing attack signature to confirm one or more interactions as a threat. Specifically, the validation engine 1522 may determine a digital signature for files, network sources, network traffic, processes, or other information extracted from the network data 1504 or feedback data that is associated with an attack pattern. Specifically, when an attack is identified, certain data may be gathered to determine the particular combination of network packets and services accessed, payloads delivered, files changed on the server, etc. From the activities on the network and on the server, statistical analysis may be used to identify the anomalous activity that belongs to this attack. The signature of the attack pattern can represent the minimal activity that identifies the threat. For example, the activity may be the payload contained in one network packet. In another example, the activity may be the changes to the registry on the server. In still another example, the activity may be a user access.

The validation engine 1522 may alternatively or additionally include a data mining engine. In various implementations, the data mining engine can trace an attack pattern through the network 1502 using attack data, such as who tried to access which service at what port and at what time. For example, if an access is noticed at a security mechanism 1520a-1520c, certain data may be gathered, such as a user identifier associated with the access, the time of the access, the machine from where the access occurred, the type of service accessed, and so on. The data mining engine may then trace back the user access pattern from the network device where the access occurred. The data mining engine may also determine if the accessed machine, as well as other machines, have been compromised.

The validation engine 1522 may alternatively or additionally include a pattern matching engine that may be used in conjunction with big data analysis to analyze the entire network to determine whether the attack pattern or signature is observed anywhere else in the network. The network traffic and host data may be quite large, such as for example in the gigabytes or terabytes range. Big data analysis comprises a set of computational methods to analyze data of such large volume. The signature may be developed by statistical analysis in one embodiment, as described above. In one embodiment, the network may be analyzed along the time axis.

The verification data 1524 may be provided to the attack pattern generator 1506. The attack pattern generator 1506 may analyze the verification data 1524 to adjust the suspected attack pattern 1508 provided to the deployment generator 1510. The threat detection system 1500a may continue monitoring the network 1502 until one or more conditions are satisfied. For example, the threat detection system 1500a may continue monitoring the network 1502 until it is explicitly stopped or paused by a user. If no active threats are detected by the threat detection system 1500a, the initial placement generator 1511 may place and activate new static security mechanisms, and further monitoring may be paused until an interaction has occurred with one of the placed security mechanisms. Monitoring of the network 1502 may also be paused or minimized based on the load on the threat detection system 1500a and network 1502. For example, the priority threshold of the suspected attacks, for which the security mechanisms are deployed, may be adjusted up or down so as to not affect the regular operation of the network 1502.

FIG. 15B illustrates another example of a threat detection system 1500b. The threat detection system 1500b of FIG. 15B may be monitoring a network 1502, which can be a customer network. A initial placement generator 1511 can determine a selection and placement of static security mechanisms in network 1502, such as an initial selection and placement, using network data 1504, and provides that selection and placement as a deployment strategy 1512, as discussed further with respect to FIG. 15A. In the example of FIG. 15B, an attack pattern generator 1506 can receive port scanning alerts from multiple servers 1503a-1503c on the network 1502, as well as other network data 1504. A port scanning alert can indicate that the ports on a server 1503a-1503c have been scanned by a port-scanning tool. Port scanning tools can be used by network attackers to probe networks for information, such as the services provided by the servers 1503a-1503c. This information may indicate vulnerabilities in the network 1502 that can potentially be exploited by an attacker.

Using clustering techniques that categorize data according to similarity, in various implementations, the attack pattern generator 1506 can determine that servers 1503a-1503c that sent scanning alerts have the same application (A1) installed. The application (A1) may offer a particular service (S1) on a particular port (P1). Using predictive analytics with network data and previous attack patterns from attack pattern database 1505 as inputs, the attack pattern generator 1506 can determine the part of the network 1502 where the scan will take place next as part of its attack pattern 1508. For example, database servers in a subnet (SN1) may have been scanned by a user. Based on this previous pattern of scans by the user, predictive analytics may determine that the database servers in a different subnet (SN2) will be accessed next by the user. The attack pattern generator 1506 may use the attack pattern 1508 to identify within the network data movements and interactions of the source of the scan with the network 1502. The attack pattern generator 1506 can further determine whether the same or similar scan happened on any other servers within the network 1502. The latter can be accomplished across the network 1502 using pattern matching techniques. The pattern of behavior may be developed using all of the available information and provided as an attack pattern 1508 to the deployment generator 1510.

The deployment generator 1510 may use this information to develop a deployment strategy 1512. For example, the deployment strategy 1512 may specify the deployment of two server deception systems 1521a, 1521b, in network 1502, configured to emulate the service (S1) offered by the application (A1) on the same port (P1). The emulated service at one server deception system 1521a may have the same authentication as the production servers 1503a-1503c. Should this server deception system 1521a be accessed using this authentication, then it is possible that the production servers 1503a-1503c have previously been broken into. The emulated service at the second server deception system 1521b may be made vulnerable, such as for example by being configured with weak authentication, no authentication, or with a default username and password.

The deployment strategy 1512 may be provided to a deployment engine 1514. The deployment engine may deploy the server deception systems 1521a, 1521b into the network 1502 in accordance with the deployment strategy 1512.

Once placed in the network 1502, the server deception systems 1521a, 1521b may begin collecting detailed data about activity or interactions related to them. For example, the server deception systems 1521a, 1521b may record each time that they are accessed, what was accessed, and, with sufficient information, who accessed them (i.e., the source of the access or interaction). The server deception systems 1521a, 1521b may provide this data to the deployment engine 1514.

The deployment engine 1514 may provide feedback data 1518 from the server deception systems 1521a, 1521b to a validation engine 1522. Feedback data 1518 represents the data about interactions related to the server deception systems 1521a, 1521b. The validation engine 1522 may analyze the feedback data 1518 from the server deception systems 1521a, 1521b in conjunction with other network data 1504, including detailed network traffic logs and data from servers 1503a-1503c, to identify network abnormalities and to determine whether any actual attacks have occurred or are in progress.

From this data, the validation engine 1522 may, for example, determine that both server deception systems 1521a, 1521b have been scanned, and that the second server deception system 1521b, having weak authentication, was accessed. Thus, in this example, the validation engine 1522 may confirm the threat as an attack inside the network 1502 targeting the application (A1), but note that the attacker does not have the proper credentials to break into the application (A1) yet. In other words, the attacker cannot yet access the first server deception system 1521a, which is configured with strong authentication. The validation engine 1522 may provide this information in the form of verification data 1524.

The verification data 1524 may be provided to the attack pattern generator 1506. The attack pattern generator 1506 may analyze the verification data 1524 to adjust the suspected attack pattern 1508 provided to the deployment generator 1510. Corrective action may then be taken. For example, the deployment generator 1510 may use the verification data 1524 to dynamically adjust the deployment strategy 1512, as described further above with respect to FIG. 15A. Further, network traffic log collection may be initiated in the parts of the network 1502 where the application (A1) has been deployed, if logs are not currently being collected at those locations.

The threat detection systems 1500a, 1500b illustrated in FIGS. 15A-15B may, using the components and data described above, determine whether a network abnormality is an acceptable and legitimate use of the networks 1502, 1516, or whether the network abnormality is an actual threat to the networks 1502, 1516. In some implementations, the threat detection systems 1500a, 1500b may also be able to take action to stop perceived threat.

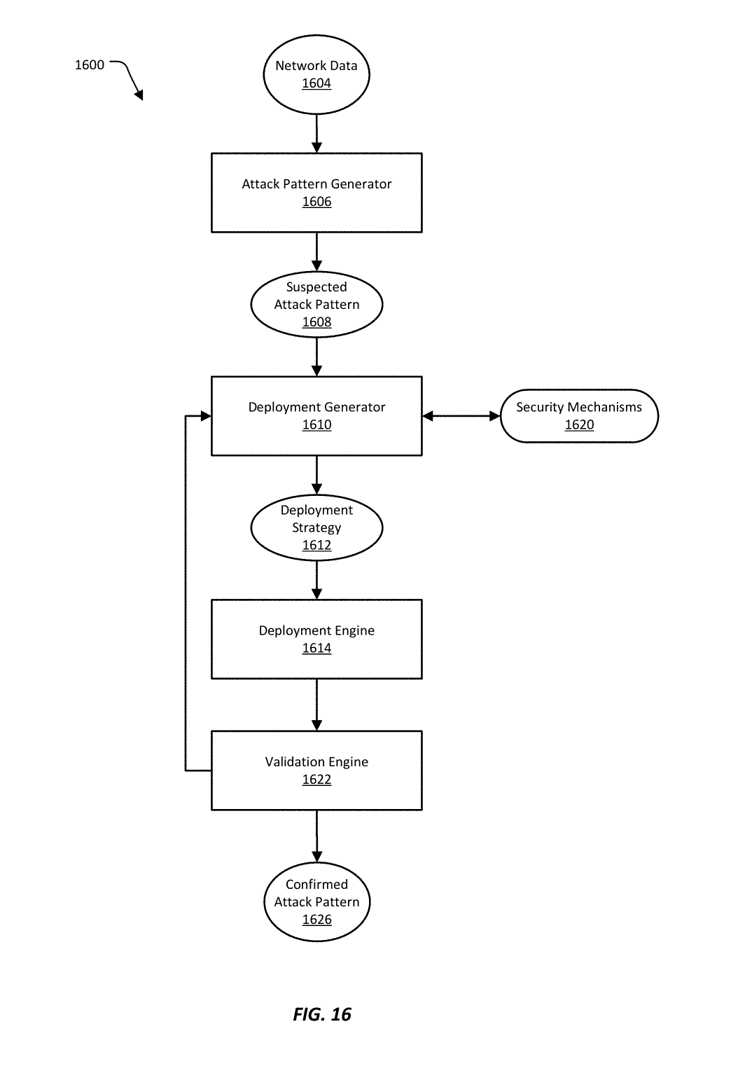

FIG. 16 illustrates an example of a process 1600 for confirming a network abnormality as an actual threat. In the process 1600, network data 1604 can be provided to an attack pattern generator 1606. The network data 1604 may include alerts and raw log files, and/or other data from a network, as discussed further below. The attack pattern generator 1606 can analyze the network data 1604 and provide a suspected attack pattern 1608. The suspected attack pattern 1608 can describe a pattern of behavior that may indicate that a network abnormality may be a threat. For example, the network data 1604 can include a large amount of data, produced by network devices and network security devices on the network. In various implementations, the attack pattern generator 1606 may be able to extract from all of this data a pattern of behavior that is specifically related to a network abnormality. The pattern of behavior can include, for examples, login attempts, network scans, systematic movement around the network, and uses of particular IP addresses, among others. The extracted pattern of behavior can be provided as the suspected attack pattern 1608.

The suspected attack pattern 1608 may be provided to a deployment generator 1610. The deployment generator 1610 may have access to a number of deployed and un-deployed security mechanisms 1620. In various implementations, the un-deployed security mechanisms 1620 can be provided as descriptions of the security mechanisms (e.g., a computer type, operation system version, and data set), or a snapshot of a security mechanism (e.g., data for a populated database), among others. The deployment generator 1610 can use the suspected attack pattern 1608 to generate a deployment strategy 1612. The deployment strategy 1612 can include one or more security mechanisms 1620, as well as information about how, where, and/or when the security mechanisms 1620 should be deployed into a network. The deployment strategy 1612 may further include the sequence in which the security mechanisms 1620 should be deployed.

The deployment strategy 1612 may be provided to a deployment engine 1614. The deployment engine 1614 may be responsible for deploying security mechanisms into a network. The deployment engine 1614 may also receive data from deployed security mechanisms (not illustrated). This data may provide information about a network abnormality, which can inform the deployment engine 1614 where to place security mechanisms, and/or how to configure the security mechanisms to be more attractive to the threat that may be posed by the network abnormality. The deployment engine 1614 may provide this and other data, such as the deployment strategy 1612, to a validation engine 1622.

The validation engine 1622 can analyze the data from deployed security mechanisms to determine whether the network is threatened, or is merely experiencing unusual but allowed activity. The validation engine 1622 may provide feedback to the deployment generator 1610 to dynamically adjust the deployment strategy 1612. Upon determining that a network abnormality is a threat or attack, the validation engine 1622 may produce a confirmed attack pattern 1626. The confirmed attack pattern 1626 may describe a pattern of network behavior that has now has been identified as a threat or attack.

An abnormal pattern of behavior seen in a network may be confirmed as an attack pattern by using security mechanisms selected and deployed to attract the attention of the actor or entity that is causing the abnormal network activity. For example, the security mechanisms can appear to be legitimate network resources or data, but in reality are not, and thus are not expected to be accessed by a user or entity that is using the network legitimately. Some accesses to security mechanisms are routing or incidental. For example, the security mechanisms may receive broadcast network packets, such as requests for address information. These types of accesses are routine and are generally expected, thus are do not trigger alerts from the security mechanisms. Access other than these routine and expected accesses, however, may indicate a threat.

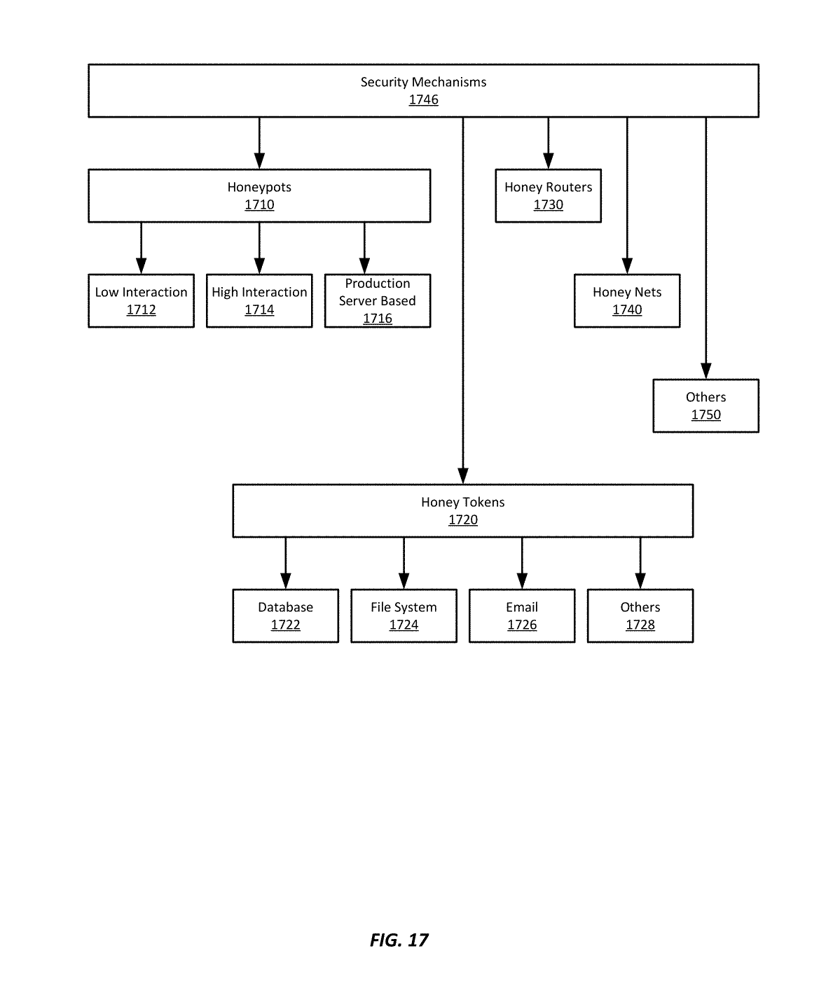

FIG. 17 illustrates examples of security mechanisms 1746 that may be deployed into a network to entrap a potential threat. The security mechanisms 1746 described here may generally be described as deception-based systems. Other security mechanisms, not described here, may also be used to entrap threats to a network.

A first group of security mechanisms 1746 are “honeypots” 1710 or deceptive systems. Some honeypots 1710 may be low interaction 1712. Low interaction honeypots 1710 include network services or processes, such as processes run to provide email, file transfer protocol (FTP), webservers, and so on. Low interaction 1712 honeypots may also include software deployed around a normal network resource that may mask and/or monitor the resource. Other honeypots 1710 may be high interaction 1714. High interaction 1714 honeypots include a full server system or systems. These full server systems may be integrated into a network, but are generally not part of the regular operation of the network. Another group of honeypots 1710 include production server-based 1716 honeypots. Production server-based 1716 honeypots include servers that are part of the regular operation of a network, but that are taken over to be a trap.

A second group of security mechanisms are “honey tokens” 1720 or deceptive data. Honey tokens 1720 may be placed in a network to resemble real data. Types of honey tokens 1720 include databases 1722, file systems 1724, email 1726, and other data 1728, such as files that contain or appear to contain images, social security numbers, health records, intellectual property or trade secrets, or other potentially confidential and non-public information. In some cases, honey tokens 1720 may be pre-generated. In other cases, honey tokens 1720 may be dynamically generated. In some cases, signatures or beacons may be embedded into honey tokens 1720. Signatures may be used to identify a honey token 1720 after it has been extracted from the network. Beacons may send signals a designated listener, or may announce themselves when activated, or may leave markers as a file is moved across a network.

Additional security mechanisms include honey routers 1730, honey nets 1740, and others 1750. Honey routers 1730 are false routers placed into a network. Honey nets 1740 are false networks or sub-networks (subnets) attached to a network.

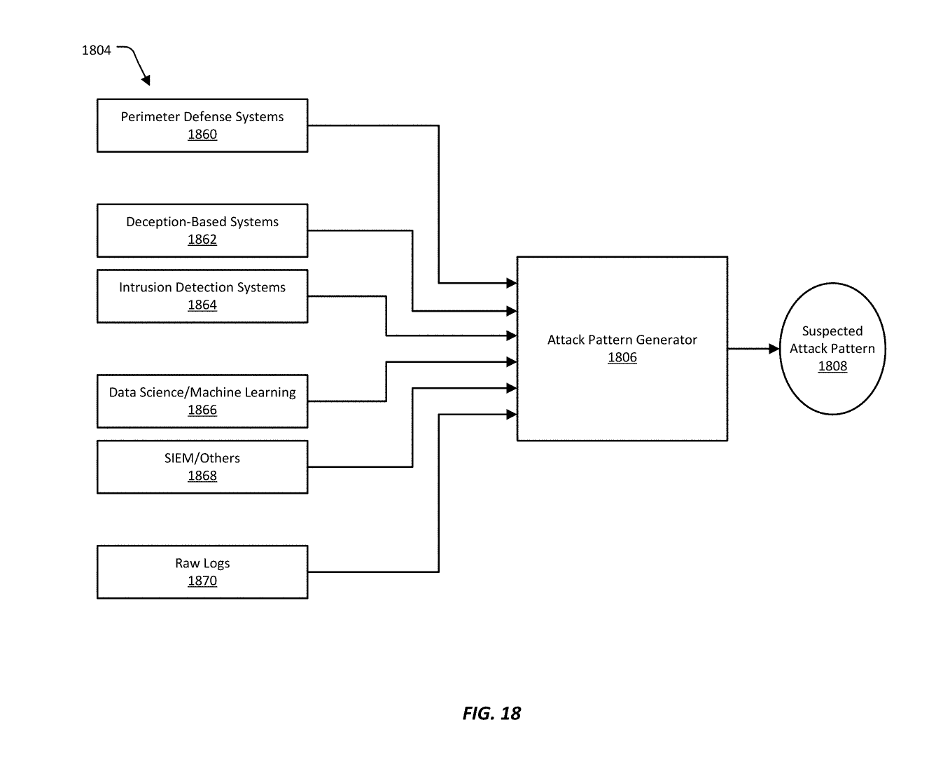

Identifying a pattern of behavior that may be a threat begins by analyzing network data from many points in a network that is being monitored. FIG. 18 illustrates examples of various data sources 1804 that may provide data that is collected by a dynamic threat detection system. These data sources 1804 may include network and client devices that are part of the network, as well as sources outside of the network. The data sources 1804 may also include be hardware or software or combined hardware and software systems configured specifically for monitoring the network, collecting data from the network, and/or analyzing network activity. Examples of systems for monitoring a network include network security tools. The data provided by the data sources 1804 may be collected from many points in an enterprise, hybrid, or cloud network and stored locally or in the cloud. Alternatively or additionally, the data provided by the data sources 1804 may be provided outside of the network. The data may further be updated continuously and/or dynamically.

The data may be provided to an attack pattern generator 1806. The attack pattern generator 1806 may analyze the data, and, upon determining that a network abnormality may be a threat, produce a suspected attack pattern 1808. The suspected attack pattern 1808 may describe the activity that may be an attack.

A first example of data sources 1804 are perimeter defense systems 1860. Perimeter defense systems 1860 include hardware and/or software systems that monitor points of entry into a network. Examples of perimeter defense systems 1860 include firewalls, authentication servers, blocked ports, and port monitors, among others. Perimeter defense systems 1860 may raise an alert when an unauthorized access is detected.

Another example of data sources 1804 are deception-based systems 1862. Deception-based systems 1862 include “honeypots” or similar emulated systems intended to be attractive to a network threat. Some deception-based systems 1862 may be statically configured as part of a network. These deception-based systems 1862 may raise an alert when anyone, or anyone who is not expected (e.g., network administrators may be listed as expected) accesses a deception-based system 1862. Some deception-based systems 1862 may be analytic, and may be configured to analyze activity around them or that affect them. These deception-based systems 1862 may raise alerts when any suspicious activity is seen.

Another example of data sources 1804 are intrusion detection systems 1864. An intrusion detection system 1864 is a device or software application that monitors the network for malicious activities or network policy violations. Some intrusion detection systems 1864 may be configured to watch for activity originating outside of a network. Other intrusion detection systems 1864 may be configured to watch for activity inside of a network; that is, by users authorized to use the network. In some cases, an intrusion detection system 1864 may monitor and analyze data in real time, while in other cases an intrusion detection system 1864 may operate on stored data. Intrusion detection systems 1864 may record observed events and produce reports. They may also raise an alert when they determine that an event may be a threat. In some cases, intrusion detection systems 1864 may be configured to respond to threat and possibly attempt to prevent the threat from succeeding.

Another example of data sources 1804 are data science and machine learning engines 1866. Data science can describe processes for extracting knowledge or insight from large volumes of structure and/or unstructured data. Machine learning may describe software processes configured to learn without being explicitly programmed. Machine learning processes may be designed to teach themselves and change when exposed to new data. Machine learning is related to data mining, in that both search through data to look for patterns. Machine learning differs from data mining in that, instead of extracting data from human comprehension, a machine learning system uses the data to improve its own understanding. Data science and machine learning may be implemented in engines or processes executing on servers in a network. Data science and/or machine learning algorithms may be public or proprietary.

Another example of data sources 1804 are Security Information and Event Management (SIEM) 1868 and similar systems. SIEM describes systems for security information management and security event management. SIEM may be provided as a software product, an appliance, a managed service, or a combination of these systems. Security information management may include long term storage, analysis, and reporting of data logged by a network. Security event management may include real-time monitoring of a network, correlation of events, notifications, and views into the data produced from these activities. SIEM may describe products capable of gathering, analyzing and presenting information from network and security devices; applications for identity and access management; vulnerability management and policy compliance tools; operating system, database and application logs; and external threat data. SIEM products attempt to monitor and help manage user and service privileges, directory services and other system configuration changes; as well as providing log auditing and review and incident response.

An additional example of data sources 1804 are raw logs 1870. Network and client devices typically record and store, to a log file, activity the network devices experience in the normal course of operation. For example, these log files may contain a record of users who have logged into a system and when, commands executed on a system, files accessed on a system, applications executed, errors experienced, traffic patterns, and so on. This data may be stored in text files or binary files, and may be encrypted. Data sources 1804 may further include intelligence derived from analyzing raw logs 1870 (not shown).

Data sources 1804 may still further include security information from active directories outside of the network (not shown). For example, data sources 1804 may include threat feeds received from other compromised networks.

A variety of data sources 1804 may be provided to the deployment generator 1810, so that the deployment generator 1810 may have a comprehensive view of activity in a network. A comprehensive view, and a large amount of data, may best enable the deployment generator 1810 to develop an effective deployment strategy 1816.

In various implementations, attack pattern generator can use data science techniques to analyze network data, such as the data from the various data sources discussed above. FIG. 19 illustrates an example of an attack pattern generator 1906 that uses data science techniques to analyze network data 1904 and determine patterns of network behavior in the network data 1904. The attack pattern generator 1906 may employ one or more data science engines to analyze network data 1904. In some implementations, the attack pattern generator 1906 can also access or receive data from an attack pattern database 1905. The attack pattern generator 1906 may also employ one or more data science techniques to develop an attack pattern 1908 from patterns of network behavior. These data science engines may include a clustering engine 1907a, a statistical analysis engine 1907b, a scoring engine 1907c, a pattern matching engine 1907, and/or a correlation analysis engine 1907e.

The clustering engine 1907a may use clustering techniques to categorize patterns of network behavior according to similarity. For example, when network behavior affects a particular group of network systems and/or deception mechanism, clustering engine 1907a can identify features network systems or deception mechanisms in the group. Features can include, for example, the type of the network system or being emulated by the deception mechanism (e.g., desktop computer laptop computer, tablet computer, etc.), identification information associated with the network system or deception mechanism (e.g., an IP address, a MAC address, a computer name, etc.), a hardware configuration of the network system or being emulated by the deception mechanism (e.g., a number of processors, a amount of memory, a number of storage devices, the type and capabilities of attached peripheral devices, etc.), and/or a software configuration of the network system or being emulated by the deception mechanism (e.g., an operating system type and/or version, operating system patches, installed drivers, types and identities of user applications, etc.). The clustering engine 1907a can further use clustering techniques to identify similar features among the group of affected network systems and/or deception mechanisms. For example, the clustering engine 1907a can determine that each affected network system and/or deception mechanism have the same operating type and version. Similarities such as these can be used as part of developing an attack pattern 1908.

The statistical analysis engine 1907b can compare generate a digital signature based patterns of network behavior that appear to be related to a threat, and can compare this digital signature to digital signatures for known attack patterns. For example, the statistical analysis engine 1907b can generate a digital signature from log file data, files, emails, network packets, processors, and/or possible source addresses associated with a threat. The statistical analysis engine 1907b can be provided with digital signatures for known attack patterns from the attack pattern database 1905. In various implementations, the statistical analysis engine 1907b can find full and partial matches between the generated digital signature and signatures for known attack patterns. The matching known attack patterns can provide data to be used in the attack pattern 1908 being developed by the attack pattern generator 1906.

The scoring engine 1907c can use a scoring model to prioritize patterns of network behavior that could be threats. For example, the scoring model may assign values to the hardware, software, and/or data assets in the network. Using this model, the scoring engine 1907c can weigh network data 1904 against the values of the assets, and determine a likelihood that a threat has affected more valuable assets. As another example, the scoring model may model the cost to the network from a particular threat. This model may be a function of the value of the hardware, software, and/or data assets in the network. In this example, network data 1904 affecting high-value assets may be given higher priority than network data 1904 affecting lower-value assets. The high-priority network data 1904 may be included in the attack pattern 1908.

The predictive analytics engine 1907d can use patterns of network behavior in the network data 1904 to determine the direction of an thrate, and/or the next possible threat type and/or location in the network that may be affected by the next threat. Predictive analytics is a branch of data mining concerned with the prediction of future probabilities and trends. The predictive analytics engine 1907d can use one or more predictor(s), such as the network data 1904, which may be measured and combined into a predictive model to predict future behavior. Once the predictive model is created, the predictive analytics engine 1907d may validate or revise the predictive model as additional data becomes available. For example, if database servers in a subnet (SN1) have been scanned by a user, the previous patterns of the scans by the user may be used by the predictive analytics engine 1907d to determine that database servers in another subnet (SN2) will be accessed next.

The correlation analysis engine 1907e can patterns of network behavior patterns within the network data 1904 and/or to known attack patterns in the attack pattern database 1905. For each comparison of network behavior to another data pattern (e.g., from the network data or from the attack pattern data base 1905), the correlation analysis engine 1907e can assigns a correlation coefficient to each particular comparison. The correlation coefficient is a measure of linear association between the network behavior and the other data pattern. For example, values of the correlation coefficient can be between −1 and +1, inclusive. In this example, a correlation coefficient value of −1 indicates that the two patterns are perfectly related in a negative linear sense (e.g., they are exact opposites), and a correlation coefficient value of +1 indicates that the two patterns are perfectly related in a positive linear sense (e.g., they are exactly the same). A correlation coefficient value of 0 indicates that there is no linear relationship between the two patterns.

The other patterns within the network data 1904 may each be assigned a correlation coefficient and may be sorted by their correlation coefficients. A threshold may be selected (e.g., absolute value of the correlation coefficient is greater than 0.9), such that correlation coefficients that are above the threshold indicate patterns of network behavior that may be associated with a threat, and should be added to the attack pattern 1908.

In various implementations, attack patterns from an attack pattern generator can be provided to a deployment generator, to be used to adjust the deployment of security mechanisms in a network. In various implementations, the deployment generator can use data science techniques to analyze the attack patterns and produce a deployment strategy. FIG. 20 illustrates an example of a deployment generator 2010 that uses data science techniques to determine a selection of security mechanisms to deploy, and placement of the security mechanisms in a network. The deployment generator 2010 may employ one or more data science engines to determine a deployment strategy 2012. The deployment generator 2010 may also employ one or more data science engines to choose between alternate deployment strategies or determine the sequence of security mechanisms to deploy. These data science engines may include a data mining engine 2011a, a machine learning engine 2011b, a scoring engine 2011c, and/or a game theory engine 2011d.

The data mining engine 2011a can use the attack pattern 2008 to predict whether a particular attack source would respond to a particular security mechanism and/or a particular location for a security mechanism. For example, a data mining database may be built of previous or historical network threats, previous or historical interactions with security mechanisms by network threats, and source information (e.g., IP address of the attack source, etc.) for previous threats. The data mining database may be used to predict whether a particular threat or threat class would respond to a particular type and/or location of security mechanism.

The machine learning engine 2011b can determine the vulnerabilities in the network 1904. These vulnerabilities can be used to specify locations to deploy security mechanisms. For example, the machine learning engine 2011b can implement clustering techniques to categorize or group data according to similarity. These clustering techniques can be used to categorize the type of servers being attacked or to model the changes made to the attacked servers, among other things. For example, the biggest attack cluster (i.e., the cluster having the most amount of attack data points) around a particular server may indicate that that server is particularly vulnerable.

The scoring engine 2011c can use the attack pattern 2008 to produce a deployment strategy 2012. For example, the network data may be combined with the previous attack pattern data in the attack pattern database to form a scoring database. The scoring engine 2011c can using the scoring data base to, for example, identify locations on the network to deploy the security mechanisms, the type of security mechanisms to deploy, the number of security mechanisms to deploy, and so on.

In one example, locations on the network 1904 to deploy the security mechanisms may be identified. In this example, each of the various locations on the network, identified in the scoring database, may be assigned a score value between 0 and 1 representing the probability that a threat will affect that location. The score value may be assigned using a predictive model built by data mining. Predictive modeling is a process used in predictive analytics to create a statistical model of future behavior using input data, such as past behavior. Nearly any regression model can be used for prediction purposes. Once the score values are assigned, the locations may then be sorted by the score value, and a threshold may be selected (e.g., highest score value, top ten highest score values, values greater than 0.75, etc.). Security mechanisms may then be deployed at locations within the threshold.

In another example, types of security mechanisms to deploy on the network may be identified. In this example, each of the various types of security mechanisms, identified in the scoring database, may be assigned a score value between 0 and 1 representing the probability that a threat will affect that type of security mechanism. The score value may be assigned using a predictive model built by data mining. The types of security mechanisms may then be sorted by the score value, and a threshold may be selected (e.g., highest score value, top ten highest score values, values greater than 0.75, etc.). The types of security mechanisms within the threshold may then be deployed.

In another example, the number of security mechanisms to deploy on the network may be identified. In this example, various numbers of security mechanisms, identified in the scoring database, may be assigned a score value between 0 and 1 representing the probability of detecting a threat with that number of security mechanisms. The score value may be assigned using a predictive model built by data mining. The numbers of security mechanisms may then be sorted by the score value, and a threshold may be selected (e.g., highest score value). The number of security mechanisms having the highest score value may then be deployed.

The scoring model may be revised periodically based on new or updated data within the scoring database (e.g., new collected data and/or new attack pattern data) and based on the effectiveness of previously implemented deployment strategies. For example, the predictive model assigning score values may be changed, and/or the threshold may be changed.

The game theory engine 2011d can use game theory (or similar techniques) to choose between alternate security mechanisms or alternate deployment strategies, and/or to determine the sequence of security mechanisms to be deployed in a deployment strategy. For example, the game theory engine 2011d can develop a decision tree, with each level representing a move by a threat. For example, based on a threat's response to a deployed security mechanism, the next security mechanism may be determined according to the tree by the game theory engine 2011d, and be deployed in advance of movement by the threat. The newly deployed security mechanism should serve as a lure and diversion to the threat.

The deployment generator 2010 can use the outputs of these engines 2011a-2011d to adjust the deployment strategy 2012 to be implemented.

A deployment engine (not shown) may further employ data science techniques to perform its described functions. For example, the deployment engine may follow the decision tree provided by the game theory engine 2011d of the deployment generator 2010 in determining the sequence of security mechanisms to be deployed.

In an additional or alternative embodiment, the deployment engine (not shown) may implement machine learning techniques. In this embodiment, the deployment generator 2010 may determine multiple deployment strategies for confirming a single attack pattern 2008. The deployment engine may use machine learning techniques to dynamically determine which of the multiple deployment strategies is best for a given action.

As an example, an attack pattern 2008 may consist of attacks on databases. If the suspected attacker accessed a subnet with SQL servers deployed, then a deployment strategy 2012 of SQL server deceptions may be deployed. If the suspected attacker accesses a subnet with more Oracle databases deployed, then a deployment strategy 2012 of deploying Oracle database deceptions may be followed. In a subnet with no databases, a deployment strategy 2012 to deploy both database deception types may be implemented.

Specific details were given in the preceding description to provide a thorough understanding of various implementations of systems and components for network threat detection and analysis. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for network threat detection and analysis.

What is claimed is:

1. A computer-implemented method, comprising:
receiving, by a network security device on a network, network data from the network, wherein security for the network includes a deception mechanism, wherein the network data includes data produced by an interaction with the deception mechanism, and wherein the interaction includes a potential threat to the network;
analyzing the network data using a data science engine of the network device, wherein analyzing includes identifying a pattern of network behavior that describes the potential threat;
generating an attack pattern, wherein the attack pattern includes the identified pattern of network behavior; and
modifying security for the network, wherein modifying includes using the attack pattern to modify the use of one or more deception mechanisms on the network.

2. The method of claim 1, wherein the data science engine is configured to:
categorize the network data using clustering, wherein clustering includes identifying one or more network devices in the network that have similar features.

3. The method of claim 2, wherein a feature includes a type of a network device, identification information for the network device, a hardware configuration of the network device, or a software configuration of the network device.

4. The method of claim 1, wherein the data science engine is configured to:
use statistical analysis to generate an attack signature, wherein statistical analysis includes determining a probability that activity indicated by the network data is related to a known attack pattern.

5. The method of claim 1, wherein the data science engine is configured to:
use a scoring model to determine a priority for the potential threat, wherein a scoring model assigns a score value to the network data, and wherein the score value indicates a probability of the potential threat affecting a particular part of the network.

6. The method of claim 1, wherein the data science engine is configured to:
use the network data and predictive analysis to determine probable future network behavior, wherein the predictive analysis uses one or more known attack patterns to determine the probable future network behavior, and wherein the probable future network behavior is associated with the potential threat.

7. The method of claim 1, wherein the data science engine is configured to:
relate the attack pattern to a known attack pattern;
assign a correlation coefficient to the attack pattern, wherein the correlation coefficient measures an association between the attack pattern and the known attack pattern.

8. The method of claim 1, wherein modifying the security for the network includes:
modifying the deception mechanism using the attack pattern, wherein modifying includes configuring the deception mechanism to conform to the pattern of network behavior.

9. A network device, comprising:
one or more processors; and
a non-transitory computer-readable medium including instructions that, when executed by the one or more processors, cause the one or more processors to perform operations including:
receiving network data from the network, wherein security for the network includes a deception mechanism, wherein the network data includes data produced by an interaction with the deception mechanism, and wherein the interaction includes a potential threat to the network;
analyzing the network data using a data science engine of the network device, wherein analyzing includes identifying a pattern of network behavior that describes the potential threat;
generating an attack pattern, wherein the attack pattern includes the identified pattern of network behavior; and
modifying security for the network, wherein modifying includes using the attack pattern to modify the use of one or more deception mechanisms on the network.

10. The network device of claim 9, wherein the data science engine is configured to:
categorize the network data using clustering, wherein clustering includes identifying one or more network devices in the network that have similar features.

11. The network device of claim 9, wherein the data science engine is configured to:
use statistical analysis to generate an attack signature, wherein statistical analysis includes determining a probability that activity indicated by the network data is related to a known attack pattern.

12. The network device of claim 9, wherein the data science engine is configured to:
use a scoring model to determine a priority for the potential threat, wherein a scoring model assigns a score value to the network data, and wherein the score value indicates a probability of an attack occurring in a particular part of the network.

13. The network device of claim 9, wherein the data science engine is configured to:
use the network data and predictive analysis to determine probable future network behavior, wherein the predictive analysis uses one or more known attack patterns to determine the probable future network behavior, and wherein the probable future network behavior is associated with the potential threat.

14. The network device of claim 9, wherein the data science engine is configured to:
relate the attack pattern to a known attack pattern;
assign a correlation coefficient to the attack pattern, wherein the correlation coefficient measures an association between the attack pattern and the known attack pattern.

15. A computer-program product tangibly embodied in a non-transitory machine-readable storage medium, including instructions that, when executed by one or more processors, cause the one or more processors to:
receive network data from the network, wherein security for the network includes a deception mechanism, wherein the network data includes data produced by an interaction with the deception mechanism, and wherein the interaction includes a potential threat to the network;
analyze the network data using a data science engine of the network device, wherein analyzing includes identifying a pattern of network behavior that describes the potential threat;
generate an attack pattern, wherein the attack pattern includes the identified pattern of network behavior; and
modify security for the network, wherein modifying includes using the attack pattern to modify the use of one or more deception mechanisms on the network.

16. The computer-program product of claim 15, wherein the data science engine is configured to:
categorize the network data using clustering, wherein clustering includes identifying one or more network devices in the network that have similar features.

17. The computer-program product of claim 15, wherein the data science engine is configured to:
using statistical analysis to generate an attack signature, wherein statistical analysis includes determining a probability that activity indicated by the network data is related to a known attack pattern.

18. The computer-program product of claim 15, wherein the data science engine is configured to:
using a scoring model to determine a priority for the potential threat, wherein a scoring model assigns a score value to the network data, and wherein the score value indicates a probability of an attack occurring in a particular part of the network.

19. The computer-program product of claim 15, wherein the data science engine is configured to:
using the network data and predictive analysis to determine probable future network behavior, wherein the predictive analysis uses one or more known attack patterns to determine the probable future network behavior, and wherein the probable future network behavior is associated with the potential threat.

20. The computer-program product of claim 15, wherein the data science engine is configured to:
relate the attack pattern to a known attack pattern;
assign a correlation coefficient to the attack pattern, wherein the correlation coefficient measures an association between the attack pattern and the known attack pattern.
